(19) United States
(12) Patent Application Publication
(10) Pub. No.: US 2017/0116552 A1
(43) Pub. Date: Apr. 27, 2017

(54) System and Method to Measure, Aggregate and Analyze Exact Effort and Time Productivity

(71) Applicant: Sapience Analytics Private Limited, Pune (IN)

(72) Inventors: Shirish Prabhakar Deodhar, Pune, Maharashtra (IN); Swati Shirish Deodhar, Pune, Maharashtra (IN); Madhukar Sharan Bhatia, Pune, Maharashtra (IN)

(21) Appl. No.: 15/398,960

(22) Filed: Jan. 5, 2017

Related U.S. Application Data
(63) Continuation-in-part of application No. 13/975,912, filed on Aug. 26, 2013.
Application No. 13/975,912 is a continuation-in-part of application No. 13/151,889, filed on Jun. 2, 2011, now abandoned.

(30) Foreign Application Priority Data
Jun. 4, 2010 (IN) 1722/MUM/2010

(51) Int. Cl. G06Q 10/06

(52) U.S. Cl. CPC G06Q 10/06316; G06Q 10/063114; G06Q 10/06398

(57) ABSTRACT

A system and method for automatically measuring, aggregating, analysing, predicting exact effort and time productivity, of white collar employees, within an organization and thereafter providing instructions for improving productivity and workload allocation, and optimizing workforce and operational efficiency, without requiring manual intervention or configuration, is described. The system captures all the work effort put on by the users. The system tracks the daily time spent by employees. This is mapped to activities and objectives that are automatically inferred based on the applications and artifacts being used, the source of offline time usage, and the employee's position in the organization and role therein. The captured individual work effort is mapped to the organization's hierarchy and business attributes. As a result, Work Patterns and trends within each sub-unit/operational dimension of the business are identified.

### FIELD OF THE DISCLOSURE

The present disclosure relates to the field of effort and time productivity measurement for improving workforce productivity and optimizing workforce and operational efficiency. Particularly, the present disclosure relates to the field of automated measurement, analysis and improvement of exact effort spent on business related activities and objectives, without requiring manual intervention or configuration.

### DEFINITION OF TERMS USED IN THIS SPECIFICATION

The term ‘Computing System’ (hereafter referred to as ‘CS’) in this specification relates to any computing machine that the user spends time on, and which has some connectivity to the Internet, for instance, desktops, laptops, remote desktops and servers, electronic notebooks, tablets, personal digital assistants (PDAs), and smart phones.

The term ‘Presence Device’ (hereafter referred to as ‘PD’) in this specification relates to any system that identifies the time spent by the user away from any computing device for activities such as calls, travel, lab work, meetings, discussions, and remote visits. Example of PDs are calendaring tools that track scheduled meetings, swipe cards and biometric devices that identify work areas, EPABX and VOW and mobile phones that record time spent by a user on calls, standalone and smartphone based GPS and indoor location and positioning systems that indicate user presence when traveling, cameras and devices that recognize users through optical matching and so on.

The term ‘Presence Device server’ (hereafter referred to as ‘PD server’) in this specification relates to a server that collects information from one or more types of PDs, and are capable of providing consolidated data regarding PDs and their access or usage by various individuals over a network connection and established protocol.

The term ‘artifact’ in this specification relates to folders, documents, files, web links and the like, accessed and used by an employee for performing a particular task on a Computing System (CS).

The term ‘application’ in this specification relates to preloaded applications on the CS, or web based applications hosted on a remote server, or initiated on a remote server from the CS. These applications can be for design, development, engineering, documentation, communication, browsing, emails, electronic chat, games, and any other purpose related to work or for personal use.

The term ‘online time’ in this specification relates to active user time spent on a Computing System (CS), and which is tracked directly on the user's CS or another CS to which the user is remotely connected.

The term ‘offline time’ in this specification relates to time spent away from any Computing System (CS), which is tracked separately through information sourced from calendaring tools, Presence Devices (PDs) and PD servers, or is identified manually by the employee.

The term ‘Activity’ in this specification relates to the nature of work on which time is spent by an employee towards achieving the assigned objectives. The list of activities is determined by the organization based on its business. For instance, Activity can include online ones like design, programming, testing, documentation, communication, and offline ones such as meetings, calls, lab work, travel, and visits.

The term ‘Purpose’ in this specification relates to the specific end objective on which the employee spent time on. This can be the work being done on an assigned project or function of the organization, initiatives (for example, innovation and certifications), non-project but company work, or it could be ‘Private’. All non-work related personal time is assigned to ‘Private’. Details of ‘Private’ time are not normally available to the organization (unless the organization and individuals are agreed that this time during work hours will be visible as well).

Both ‘Activity’ and ‘Purpose’ can be multi-level so that they can cater to the diverse requirements across different parts of the business. Time utilization for an individual employee can get allocated only to Activities and Purposes that are applicable for that individual as per the role and position in the organization.

The term ‘Work Patterns’ in this specification relates to all the different characteristics of the work effort that are covered by this disclosure, including but not limited to, hourly and daily work time, time spent on specific applications, artifacts, Activities, Purposes, Computing Systems, online and offline time, and other derived information such as working in shifts, work week and weekly holidays, vacations taken, time on desk work and travel oriented function, uninterrupted work focus on important activities, breaks taken, completed work units, work-life balance and so on.

The term ‘organization sub-units’ in this specification relates to the entire organization or any part thereof, including business units, projects, teams, locations, and individual employees.

The term ‘per-employee Daily Average Work Pattern’ in this specification relates to a computed value for a particular organization sub-unit across a specified time range (from a start to end date), obtained by aggregating the Work Patterns for each user belonging to the sub-unit for each day, and determining a weighted average after inferring the valid working days for each user during the specified time range.

The term ‘user’ or ‘employee’ in this specification are used interchangeably and relate to an individual who is interacting with the CS and the PDs.

These definitions are in addition to those expressed in the art.

### BACKGROUND AND PRIOR ART

Exact work effort determination by an organization is crucial for establishing the efficiency baseline and then making improvements. The consequent ability to effect productivity improvements and optimize capacity utilization has a direct and significant impact on revenue, profitability and improved customer satisfaction.

Typically, manufacturing industries can easily measure productivity because the output is in terms of tangible parts or products manufactured each day or week. Further, work done by employees in the manufacturing industries is visible and measurable. However, it is very difficult to pin-point exact work effort at companies where employees fall into one or both of these categories: a) working mostly on computers to deliver products and services, and b) regularly travelling within and outside the office for sales, support and marketing. For example, in a typical Information Technology (IT) company, employees do most of their work on computers, and also attend to business meetings and calls. They may also perform some office related work on their laptops and smartphones while at home, on weekends and holidays, and while traveling. In office, employees spend some time on non-work related activities such as lunch and coffee breaks, smoke breaks, social chat, etc. They may also use their computers for private online chat, emails and browsing. Besides office workers, organizations have marketing and sales staff who are on the phone and travel extensively for business, and whose work time is equally difficult to track. Hence, in most white collar jobs, whether desk bound or sales oriented, it is not possible to measure the exact time on actual work put in by employees.

An even bigger challenge is accounting for an employee's work time breakup across various Activities and end objectives (Purposes). The Activities may include online activities like design, programming, testing, documentation, communication, and offline ones such as meetings, calls, lab work, travel, and visits. Further, the Purposes can include objectives such as projects, product releases, functions (for example, recruitment and training) and initiatives (for example, innovation and certifications). Further, the Activity and Purpose lists can be single-level lists or multi-level hierarchical list, the latter allowing a fine-grained analysis of effort.

The lack of visibility into exact effort is exacerbated with recent trends towards flexible working hours, use of multiple and different types of computing systems (such as PC at work and home, smartphones, tablets) by each employee, teams at distributed locations, outsourcing to contractors and vendor teams, and policies that permit work from home. It is even more difficult to measure the work effort of sales and marketing staff who spend much of the work day on business calls, travel to customer locations, and discussions with clients. What is required is the means to capture all the user's work effort which in today's environment may be at any time during the day (24 hours) and week (7 days), on one or more computing systems, when at their desk or in travel and away from the office.

Most managers do not want to micro-manage and track each user's daily work effort. They require objective metrics at team level that enable them to benchmark and suggest improvements to their staff. Manager guidance coupled with employee self-improvement is the preferred approach for greater productivity and optimizing collective effort across the organization hierarchy and every business attributes such as roles, skills, verticals, technologies, cost and profit centers. Since employee privacy is important and may need to meet legal requirements in various countries where the organization operates, it should be possible to collect only work related effort, perhaps limiting visibility for managers only to team data.

Due to the absence of exact effort data, professional organizations focus primarily on measuring the outcome. Managers can only track the status of deliverables and tasks by doing periodic reviews and using standard project management techniques. When the outcome is not at desired level or delivered on time, then various reactive measures are attempted through more executive attention, such as exerting pressure to work harder, improving delivery and management processes, and change in personnel.

Even when deliverables are on time and up to the required quality, it is difficult to assess whether there is room for effort improvement, which can lead to better financial results. For example, a project that is meeting its goals, but with only 60% utilization of available capacity, can continue to do so with 30% less staffing. The profitability can be doubled on this already successful project. In contrast, if a project is not performing well, it would be useful to know whether this is due to poor effort or despite significant effort. The corrective actions required are very different in these two cases.

Typically, organizations depend on supervisors to interact regularly with employees for managing immediate tasks and achieving short term results. However, supervisors of a white collar workforce are constrained because of lack of any factual data about time and nature of the actual work being done on computers, at phone, phones and when traveling. Supervisors rely on end results and their judgment about people. Supervisory inputs about work time are transactional and subjective, and senior management has no factual data about exact workload in projects and business units. Hence, staff allocation is based exclusively on budgets and priorities, and hence not very optimal. Today's economy and competitive landscape demand exact continuing productivity improvements, which are not possible without automated effort visibility.

Today, companies attempt to measure work effort by requiring employees to fill-in timesheets. In an attempt to get breakup of the work effort, employees must enter time spent on different activities and tasks or deliverables. Such user input is very subjective. Since white collar employees do so many different things in office, both on their CS and away from them, they have no way of precisely tracking their total work time, let alone the breakup on different Activities and Purposes. Hence they usually fill in what is expected of them. The timesheets often limit the employee to specifying the statutory work hours (e.g. 8 or 8.5), rather than the actual hours put in. Hence, while lot of data is provided, it is inaccurate and misleading. Business decisions cannot be taken based on such flawed subjective data. Consequently, timesheets usually end up being an exercise for billing purposes, and not with a view to measure and improve work effort and productivity.

The prior art described below envisage automated solutions for limited capturing of work effort. This includes user interactions with the computer and some information regarding user's offline activity in one case. However, they are limited in coverage and suggest improvements in narrow areas, such as a business process or work profile, which need to be configured. They do not describe/offer a comprehensive automated capture of the user's time 24×7, both when working online on one or more different types of computing systems (PC, smartphone, tablet, etc.) and offline on activities ranging from meetings, phone calls, lab work, travel, business visits and so on as obtained from different presence devices (smartphone, GPS, EPABX, swipe cards, biometric devices, cameras, etc.). They do not teach how the activities and objectives of a user can be inferred based on the applications and artifacts being used, the source of offline time usage, and the role and position of the user in the organization. They do not adequately assure the employee of privacy by providing a local user interface on the employee's CS that enables the user to identify and block details of personal time. They do not describe restricting aspects of work time to fit the organization's culture and complying with the privacy laws of the countries that they operate in. Further, they do not teach how the effort of individual users can be aggregated as per the organization hierarchy and business attributes (such as roles, skills, locations, verticals, cost and profit centers), that are automatically retrieved from the organization's existing application data stores, and further analysed to obtain objective per-employee metrics that allow performance comparison across any two or more organization sub-units, whether employee, team, project, business unit or the entire organization.

For example, Patent Application US 2006/0184410, Ramamurthy et al. discloses a system that can observe every user action on every user application on a CS. It automatically captures and stores how a user is interacting in real-time with business applications, including screen shots and actual data that is being provided to these applications, and how a user is using a keyboard and other input devices. It collects information from third-party servers for obtaining and storing an actual audio/video of what a user said or did typically within the context of the business process. The automated capture of user actions is designed to replace time-and-motion stopwatch based observations that cannot keep up with online work by users. This patent application discloses mapping what the user is doing against a process definition to identify a process. However, US20060184410 does not teach a comprehensive capture of the user's time in online and offline activities, and automatically mapping the same to ‘Activities’ and ‘Purposes’ that are generic and independent of a specific business process. For example, it does not disclose the automatic derivation of Purposes (projects or functions) assigned to the user based on his or her position in the organization hierarchy. Moreover, the system described by Ramamurthy does not disclose mapping of the user's time to ‘Activity’ and ‘Purpose’ directly on the basis of online applications and artifacts being used, and the nature of offline activity, and also taking into account the user's position and role. Ramamurthy et al discloses how to obtain details of all user interactions only with a view to optimize either (1) a known business process or (2) or a to-be business process. It does not teach how to capture the user's effort at all times, whether in office and outside, online or offline, while working on a diversity of CS (PC, tablet, smartphone, shared PC with a common login etc.) and offline as obtained from various Presence Devices such as electronic phone logs, swipe cards, smartphone with GPS, and so on. Ramamurthy et al does not provide methods and systems to protect employee privacy since the effort being captured is for a limited purpose of business process optimization, rather than all the effort in the office and outside. Ramamurthy et al. does not disclose aggregation and rollup of user data as per the organization hierarchy and attributes, as collected automatically from the organization's existing application data stores.

Patent Application US 2010/0324964, Callanan et al. discloses tracking of a user's time spent on an assigned Work Profile to determine work hours and overtime on a project. Tracking is initiated after the user has logged into an instant messaging system. The work profile indicates the project, applications and work files assigned to the user. The system envisaged by Callanan stops tracking time if the application being used is not listed in work profile and the user does want it to be added to the profile. Callanan et al also teaches that offline work related contextual information is gathered from the calendar and other applications. This patent application cites an ‘activity monitor’ whose function is only to indicate that the user is ‘active’ on the computer. Callanan does not teach how to automatically map the user's time to ‘Activities’ of interest to the organization (example, online ones like design, programming, testing, documentation, communication, and offline ones such as meetings, calls, lab work, travel, and visits), deduced automatically based on applications and files and links used, and the PDs whose identity indicates how the offline time is spent. Callanan requires explicit definition of a ‘Work Profile’ for each user, and does not automatically derive the Purposes (projects or functions) assigned to the user based on his or her position in the organization hierarchy. It does not teach how to capture the user's effort at all times, whether in office and outside, online or offline, while working on a diversity of CS (PC, tablet, smartphone, shared PC with a common login etc.). Callanan et al only refers to offline time in the context of identifying a meeting from the calendaring application on the user's computer. However, it does not teach detecting the user's complete offline time on phone calls, lab and conference rooms, travel, and remote visits, from various Presence Devices such as electronic phone logs, swipe cards, smartphone with GPS, and so on. Further, the system described by Callanan does not disclose mapping of the user's time to ‘Activity’ and ‘Purpose’ directly on the basis of online applications and artifacts being used, and the nature of offline activity, and also taking into account the user's position and role in the organization. Further, Callanan does not teach aggregation and rollup of user data as per the organization hierarchy and attributes, as collected automatically from existing data stores in the organization. Callanan et al also do not offer methods and systems for protecting employee privacy, including the capability to block some or all of the individual effort while still measuring and displaying aggregate effort.

Patent Application US20050183143, Anderholm describes automatic capture of time by monitoring system/user/device activity. The system envisaged by Anderholm track user's time on various applications on the user's computer, and events from other devices, processes the data, and aggregates the captured data for multiple users. The aggregated data is further compiled into a plurality of reports which could be accessed by a plurality of users based on their organization hierarchy. This patent application discloses aggregating data in terms of events, users, computer types, department types and organization hierarchy to name a few. However, Anderholm does not describe a 24×7 capture of user's time utilization, whether in office or at home or while traveling. In particular, Anderholm does not disclose capture of any offline time by interfacing to calendaring tools and presence devices. It does not automatically derive the Purposes (projects or functions) assigned to the user based on his or her position in the organization hierarchy. Further, application artifacts such as files, folders, web links are not captured, and hence there is no automated mapping of user time to ‘Activity’ and ‘Purpose’ that requires inferences of a user's intentions based on applications and files, folders and links being used, how and where the offline time is spent, and the user's organization attributes such as role and position. Anderholm discloses aggregation of users' time based on organization hierarchy, but does not teach how the hierarchy and other business attributes can be obtained automatically from existing organization application data stores. Further, Anderholm does not offer methods and systems for protecting employee privacy, including the capability to block some or all of the individual effort while still measuring and displaying aggregate effort.

Finally, there are some prior art tools that capture time spent on the CS on various online applications, and categorize them into productive and non-productive work. They are broadly referred to as employee monitoring tools. They are designed for an individual user to track the time utilization, or a small business where the management wants to track what each person is doing or needs to bill or pay for work on an hourly basis. Like Anderholm, these tools do not track effort 24×7, both online on different kinds of CS, and offline for meetings, calls, lab work, travel, remote visits and so on. They do not automatically infer the Activities and Purposes for which the time was spent, based on applications and artifacts for online time, nature of offline time, and the user's role, position and other attributes relevant to the organization. Like Callanan, they are not able to provide organization level analytics and metrics that can drive comparison and optimization of effort in organization sub-units across the enterprise.

None of the existing solutions are able to account for work being done by the same user on multiple Purposes, or when they use a combination of computing systems such as a PC, smartphone, tablet, or when a shared CS is accessed by multiple users through a common login, or if the user works on a remote CS that belongs to a different organization. While a few tools track meetings scheduled through a calendar, they do not track offline time utilization on calls, lab work, travel, remote visits, by sourcing them from various Presence Devices (PDs) such as IP phones, EPABX, mobile phones, smartphones, GPS, swipe cards, biometric devices, and cameras. They do not specify automated collection of organization hierarchy and business attributes, without which the intelligent mapping of user time to Activities and Purposes is not possible. They do not disclose the computation of any per-person Work Patterns and productivity metrics that allow for objective comparison between one or more organization sub-units of any size, from one employee to the entire organization. Deriving a per-person metric requires being able to detect and handle complexities such as multiple-level hierarchy, matrix organization structures, employees working in more than one project and across business units, multiple managers, shift timings and variable work weeks. Hence, they do not provide online automated analysis of effort data across various business dimensions such as geography, verticals, employee skill sets, and salaries and so on.

Apart from the ability to stop tracking of user's time either manually or outside of the business process being covered, none of the existing tools describe methods to protect individual privacy as per the requirements of each organization and to comply with privacy policies in different countries. Ideally, a user interface should be available on the employee's CS that enables the user to verify, and if required mark the time spent on personal activities, which are then no longer available to the organization. Visibility into only work related individual data may be restricted to only some senior managers. Some organizations may opt for an anonymous mode, wherein only team level work effort is visible. It may be necessary to track work effort only up to a certain level in the organization. Finally, some organizations may wish to restrict visibility into work effort to only certain high level aspects (for example, excluding details of applications and artifacts), and only as average time on daily or weekly or monthly basis.

Therefore, there is a felt need for a completely automated system that can precisely capture all the work effort which in today's environment may be at any time during the day (24 hours) and week (7 days), and map it to the Activities and Purposes that are automatically inferred. The captured work effort from each employee must be aggregated and analysed as per the organization's hierarchy and business attributes that are automatically collected from existing organization application data stores. The system must deliver actionable and objective metrics that can help optimize enterprise effort in every aspect of the business. It must also provide required protection for individual privacy, and restrict visibility of work effort as per the requirements of the organization and privacy laws of the countries it operates in.

Further, there is a felt need for a completely automated system for predicting exact effort and time productivity of at least one user within a company and thereafter providing instructions for improving productivity and workload allocation, and optimizing workforce and operational efficiency.

Finally, senior management should have access to a global platform where they can compare their own organization's productivity and work effort in relation with other peer organizations.

### OBJECTS

It is an object of the present disclosure is to provide an intelligent and highly automated system to measure, record, analyse, report and improve the work effort put into various Activities and Purposes for an organization by individuals, teams and organization sub-units assessed as per the organization hierarchy and related business attributes.

A related object of the present disclosure is to provide a system that automatically determines each employee's effort throughout the day (24 hours), for all days, whether performed online on one or more Computing Systems (CS), and offline such as for meetings, lab work, calls, outside travel, and remote visits. This effort is mapped to Activities and Purposes relevant for the organization and which are derived automatically for each user based on his or her organization role.

A related object of the present disclosure is to provide a system that automatically tracks the exact time spent by the employee on one or more personal CS, any CS shared with other users through a common login, and remote servers (even if the servers do not belong to the organization), by determining the user's time on the currently active application and associated artifacts such as files, folders, websites and other artifacts related to the applications.

Another related object of the present disclosure is to provide a system that automatically detects whenever the user is away from any CS, and mark this time as offline time on the CS.

One more object of the present disclosure is to provide a system that merges the user's online and offline time information sourced separately from one or more CS, and PDs and PD servers, for a consolidated view of the user's time utilization on applications and related artifacts and offline on meetings, calls, lab work, travel, remote visits and so on.

It is a further object of the present disclosure to provide a system that intelligently deduces and maps each online and offline time slot to the most appropriate Activity and Purpose from a hierarchy of possible Activities and Purposes assigned to the employee from a master list for the organization, based on applications and artifacts in case of online time slots, and for offline slots from information obtained from calendaring systems and various PDs (Presence Devices) and PD servers that indicate if the user was busy in meetings, calls, lab work, travel, remote visits, and so on.

Yet another object of the present disclosure is to provide a system that infers the Work Patterns of the user such as leaves taken, work done on holidays, desk job done mostly online on one or more CS, supervisory work involving online and offline work, travel oriented work mostly offline and away from office, shift timings, variable work week, uninterrupted work focus on important activities, number of distractions per work day, work units completed and so on.

Another object of the present disclosure is to make available a system that provides the user with a local user interface on the employee's CS, which is intended for private display of user's time utilization, both personal and work related.

Yet another object of the present disclosure is to make available a system that provides for user side gamification and encourages improved work habits by setting challenges related to work focus and minimizing distractions, awarding performance points, badges for consistent performance, and progressive performance levels.

One more object of the present disclosure is to make available a system that provides for exact effort and time productivity measurement at organization level without any manual definition or configuration of employee groups or attributes.

The present disclosure envisages a system adapted to configure a master list of Activities and Purposes, derived from the organization hierarchy (which represents projects and functions) and business attributes (which determine the relevant Activities for a particular type of organization and its sub-units), and the master list may be multi-level and adapted for each organization sub-unit and user.

The present disclosure also envisages a system adapted to configure default rules for mapping online and offline time slots to Activities and Purposes, and adapt the mapping rules for organization sub-units based on their business attributes, and further adapt them for each user based on his or her position in the sub-unit hierarchy and the user's role therein.

A further object of the present disclosure is to provide a data exchange framework for shared database and programmatic interface with third party applications for project management, performance tracking, HR systems, quality, project accounting, resource management and the like.

Yet another object of the present invention is to provide a system that derives analysis of the user's work day pattern up to the present time.

A related object of the present disclosure is to provide a system that collects the daily effort of each individual employee, consolidates and rolls it up as per the organization hierarchy defined at the server, and provides analytics, reports, goal compliance, alerts and rewards notifications responsive to the exact effort data across Purposes, Activities, applications, artifacts, organization hierarchy and attributes.

Yet another object of the present disclosure is to provide a system that derives a per-employee Daily Average of Work Pattern, as part of the built-in analytics, specifically to allow for meaningful comparison between two or more organization sub-units, irrespective of the nature of business and role.

A related object of the present disclosure is to provide a system that computes the per-employee Daily Average of Work Pattern for a requested organization sub-unit for the specified time range.

One more object of the disclosure is to provide a system that performs predictions and provides instructions for improving work effectiveness and work life balance aspects for the user.

Yet another object of the present disclosure is to provide a system that performs predictions and provides instructions for improving productivity and efficiency aspects for the organization sub-unit.

One more object of the present disclosure is to provide a system that creates an n-dimensional effort data cube and includes an analytics engine to provide for generation of custom reports by defining the parameters to be viewed and compared against, filters for selecting a subset, in which the parameters comprise any and every data item sourced, including online and offline time, applications, Activities, Purposes, artifacts, organization sub-units, organization attributes, along with ability for statistical analysis based on totals, averages, maximum and minimum values, standard deviations and others.

A further object of the present disclosure is to provide a system which automatically generates instructions for improving productivity of organization sub-units and individual employees.

Yet another object of the present disclosure is to provide a system that optimizes the workload allocation, refines staffing assignments and identifying hiring or retrenchment requirements.

A further object of the present disclosure is to reduce attrition by predicting employees at risk so that the organization can take corrective measures.

A further object of the present disclosure is to provide a system that enables higher productivity, increased output, and improved capacity utilization, by setting goals for greater yet reasonable effort, and more focused time on key Activities and Purposes, by highlighting the gap between current and desired performance, as well as the performance of the Top 20% at the level of organization sub-units and individual employees.

It is another object of the present disclosure is to provide a system that determines under and over utilization of effort capacity at any level of the organization hierarchy or along business attributes, and thereby optimizes staffing for maximum organization efficiency and employee work-life balance.

One more object of the present disclosure is to provide a system that deduces recent positive and negative deviations in Work Patterns, and generates an exception report with suggested actions that can be taken to drive improvement.

One more object of the present disclosure is to provide a system that protects the user privacy by not allowing any visibility into user's personal time details, optionally providing the user with a user private time selector to disable employee's time tracking for specified duration, optionally blocking access to work related details such as applications and artifacts, and optionally reducing the resolution of user's work data to daily, weekly, or monthly averages instead of real-time information to make it seem less intrusive.

A further object of the present disclosure is to provide administrative capabilities to the organization to limit individual level work data visibility only to a few selected staff members, and disabling individual work data view for senior staff (above a certain designation).

One more object of the present disclosure is to provide a system that complies with privacy laws of the organization or specific countries where they operate in by providing an ‘anonymous’ mode in which individual data visibility is completely blocked, and only team level trends and reports are possible.

Yet another object of the present disclosure is to provide a system that includes a ‘self-improvement’ mode in which no user data is uploaded to the server and productivity improvements are achieved at employee level through personal goal setting and self-awareness based on the Work Patterns provided on the local CS.

One other object of the present disclosure is to make available a system that provides each user with a web user interface, in addition to the local user interface, to enable access over any internet browser to long term work related trends, reports, alerts, goals, and administrative functions on the server, for the individual's own data as well as for the teams and organization units reporting to the user.

A further object of the present disclosure is to provide a social platform that showcases the top performers and award winners at individual and organization sub-unit level, motivates gains through a recognition-and-rewards system based on goals achieved, performance points, badges, levels, and allows users to socialize personal and team achievements.

An object of the present disclosure is to create a global Work Pattern knowledge platform in which organizations across various industries, verticals, countries, and scale, can participate by contributing their high level Work Pattern trends and analytics with assured anonymity, and in return get feedback on how they rate relative to peer organizations selected based on the criteria of interest.

### SUMMARY

The present disclosure captures all employee work, whenever and wherever it is performed, including online using multiple devices such as computers, tablets and smartphones, and offline through business calls, meetings, remote visits to meet customers and suppliers. Further, the present disclosure automatically discovers the organization structure and business attributes from the existing organization databases, and computes and analyses the collective work effort across relevant business dimensions. The analysis is further extended to a global view across participating organizations.

The present disclosure envisages a computer implemented system for automatically measuring, aggregating, analysing and predicting the exact effort and time productivity, of at least one user having access to at least one Computing System (CS) agent, within an organization and thereafter providing instructions for improving productivity and workload allocation, and optimizing workforce and operational efficiency. The system, in accordance with the present disclosure comprises:
at least one server;
the at least one CS agent associated with the at least one user accessing the server, the CS agent adapted to automatically measure and generate consolidated and exact online and offline effort data throughout the day (24 hours), for all days, wherein the CS agent is selected from the group consisting of a computer desktop, laptop, electronic notebook, personal digital assistant, tablet, and smartphone, and wherein the CS agent has access to:
   a master list for the user containing his or her Purposes and Activities, role and business attributes, and an optional assignment of work units for one or more Purposes, the master list automatically preconfigured at an organization level server based on the user's role and other work related attributes, and
   a rules and pattern mapping engine containing organization mapping rules and current user specific mapping rules for mapping online applications and offline slots to a default Purpose and Activity;
a user identifier adapted to identify the user by his or her unique login ID available with the CS agent, the user identifier further configured to prompt the user for an ID in case a neutral login ID is being used by more than one user;
a time tracker having access to the CS agent and adapted to track the user's online time on a currently active user application and associated artifact from a multiplicity of open applications on the CS agent, and record the name of the active application and artifact name(s) and duration of usage, the time tracker further adapted to mark the user's offline time slots by determining each period of inactivity time during which no movement of physical input device(s) of the CS agent is detected for more than a predetermined period of time, wherein:
   the associated artifact is selected from the group consisting of a file, a folder, and a web site, and
   the physical input device(s) are selected from the group consisting of keyboards, keypads, touchpads, and mouse;
a comparator adapted to compare scheduled engagements, meetings, calls, lab work, travel time and remote visits of the user as obtained from the user's calendar on the CS agent and from local Presence Devices (PDs), with the duration of the offline time slots for determining the user's offline time utilization, wherein the local Presence Devices include smartphones with GPS that are connectable to or part of the CS agent;
a logger adapted to maintain a consolidated and sequential log of the user's online and offline time slots,
a time analyser adapted to map the log of the slots to an appropriate Purpose, Activity, and optionally a work unit based on the mapping rules, and further adapted to generate and upload an effort map of the user on the server, wherein:
   the Purpose is selected from the group consisting of assigned projects and functions;
   the appropriate Activity, for the selected Purpose, is selected from the group consisting of design, programming, testing, documentation, communication, browsing, meetings, calls, lab work, travel, and visits, and
   the work unit, for the selected Purpose, is selected from the group consisting of assigned transactions, tasks and deliverables;
a CS agent interface, resident in the server, configured to collect effort data from every CS agent for the user, wherein the effort data is in the form of an CS effort map, the CS effort map configured to list in a chronological order, the online and offline time for the user;
a PD interface, resident in the server, configured to determine the offline PD effort map for the user by obtaining information about user's time on business calls, meetings, visits to labs and other intra-office locations, business travels, and time spent at customer/vendor locations, by interfacing with all remote Presence Devices and PD servers;
an effort map unit, resident in the server, configured to merge the CS effort map and the offline PD effort map for every user, and generate a chronologically accurate and complete final user effort map, the final user effort map uploaded back to every user's CS agent;
a user Work Pattern analyser adapted to periodically receive the final user effort map, the user Work Pattern analyser further adapted to:
   compute a plurality of Work Pattern items, using the final user effort map, wherein the plurality of Work Pattern items are selected from the group consisting of a work time, an online work time, an offline work time, time spent on each Purpose, Activity, application and work unit for the user, a core activity time, a collaboration work time, work habits, a total travel time, a fitness time, a CS usage time, smart-phone addiction, physical time in a workplace, private time in a workplace, work time at home, a work effectiveness index, and a work life balance index,
   generate wellness instruction prompts for the user,
   automatically tag each day, in the final user effort map, as a workday, a weekend day, a public holiday or a vacation,
   automatically detect the user's location as home, office and other, and
   automatically tag each day, in the final user effort map, as a work from office day, a work from home day or a work from other location day; and
a user predictor and instructor module adapted to periodically receive the plurality of Work Pattern items, the user predictor and instructor module further adapted to:
   select appropriate Work Pattern items, from the plurality of Work Pattern items, for tracking the user's performance based on the user's role in an organization hierarchy,
   provide a feedback to the user on highlights related to work effort, work output and the work life balance index,
   suggest areas of improvements for the user,
   set goals for the user based on the plurality of Work Pattern items,
   provide encouragement for the user with points and badges,
   generate a progress report based on the goals, the points and the badges won, and
   predict the improvements in the work effort, the work output, the work effectiveness index and the work life balance index for the user;
a local user interface adapted to receive inputs from the user Work Pattern analyser and the user predictor and instructor module, the local user interface further adapted to:
   display privately and exclusively to the user, the Work Pattern trends for a predetermined period and the wellness instruction prompts,
   indicate the areas of improvements and the goals,
   display the progress report based on the goals, the points and the badges won, and
   review and edit Activity, Purpose, and work unit mappings;
a user private time selector adapted to disable a user's time tracker for specified time ranges, wherein the time ranges includes the time slots, the time slots in the time ranges are marked as unaccounted and private time;
a privacy filter, resident in the CS agent, the privacy filter cooperating with the rules and pattern mapping engine and adapted to:
   mark all effort that is not identified as being on work related activities by the server and the user's mapping rules as personal time,
   enable the user to explicitly change any time that was marked as personal to work,
   enable the user to explicitly change any time that was marked as work by the server or the user's mapping rules to personal,
   enable the user to select, or enable the CS agent to set directly, from one or more of the following privacy filter settings, when the CS agent is enabled to upload the user's effort data:
      deactivate uploading of user's personal time details to the server,
      deactivate uploading of some aspects of the user's work related information including applications and associated artifacts, to the server, and
      reduce the granularity of the user's work related information that is uploaded to the server to a daily, weekly, or monthly average of the Work Patterns, and
   deactivate uploading of all the user's information to the server, when the CS agent is not enabled to upload the user's effort, both work and personal, to the server, thereby enabling the CS agent to function in a self-improvement mode for the user and further enable the CS agent to select from one of the following data sharing options:
      allow the user to voluntarily disclose identity and some or all aspects of the user's Work Patterns to the server in return for being able to collaborate with peers or the entire organization for benchmarking and cross-learning from each other, and
      allow the user to voluntarily disclose some or all aspects of the user's Work Patterns to the server, wherein the CS agent is adapted to obfuscate the user's identity, in return for being able to benchmark user's own performance with that of the peers or the entire organization as provided by the server;
   and
the at least one server comprises:
   an organization sync agent configured to collect and maintain the list of current valid users and the organization hierarchy that maps each user to one or more organization sub-units, the organization sync agent further configured to collect and maintain the business attributes qualifying each user and organization sub-unit from organization application data stores, wherein:
      the business attributes for the user are selected from the group consisting of role, skills, salary, position, and location, and
      the business attributes for the organization sub-unit are selected from the group consisting of domain, vertical, cost and profit center, priority;
   an organization settings and rules engine adapted to configure a master list of Purposes and Activities, derived from the organization hierarchy, wherein the organization hierarchy represents projects and functions, and the master list may be multi-level and adapted for each organization sub-unit and user, the organization settings and rules engine further adapted to configure default rules for mapping online and offline time slots to Purposes and Activities, the organization settings and rules engine further configured to adapt the mapping rules for organization sub-units based on their business attributes and further adapted for each user based on his or her position in the sub-unit hierarchy and the user's business attributes,
   an organization effort aggregation and analytics engine configured to consolidate and roll up individual online and offline effort data as per the organization hierarchy, the organization effort aggregation and analytics engine further configured to compute a per-employee Daily Average Work Pattern for each sub-unit, the organization effort aggregation and analytics engine still further configured to generate an n-dimensional effort data cube mapping individual and collective efforts of respective users as per the organization hierarchy,
   an organization Work Pattern analyser configured to periodically receive the per-employee Daily Average Work Pattern for each sub-unit, the organization Work Pattern analyser further configured to:
      compute a plurality of sub-unit Work Pattern items for each sub-unit, wherein the plurality of sub-unit Work Pattern items are selected from the group consisting of a sub-unit effort, sub-unit habits, a sub-unit effort distribution across Purposes, Activities, applications and work units, a sub-unit work life balance index, a sub-unit capacity utilization, and a sub-unit work effectiveness index,
   an organization predictor and instructor module configured to receive the plurality of sub-unit Work Pattern items, the organization predictor and instructor module further configured to:
      select appropriate sub-unit Work Pattern items, from the plurality of sub-unit Work Pattern items, for tracking each sub-unit's performance based on the nature of each of the sub-unit,
      provide a feedback to a manager on highlights related to a sub-unit work effort, a sub-unit work output, a sub-unit workload assignment and a sub-unit staff allocation for each of the sub-unit,
      suggest areas of improvements for each of the sub-unit;
      track progress of each of the sub-unit,
      set goals for improving the sub-unit work effectiveness index and sub-unit productivity for each of the sub-unit;
      suggest recommendations about the best practices for each of the sub-unit,
      predict the improvements in the sub-unit work effort, the sub-unit work output, the sub-unit work effectiveness index and the sub-unit work life balance index for each of the sub-unit,
      predict delays in project timelines, effort and cost overruns, inability to meet an output target, and an impact possible with improvements, and
      generate intelligent reports for improving operational effectiveness and workforce optimization in each of the sub-unit;
   a recognition and rewards module configured to assign performance points to users and sub-units based on individual and aggregate effort, and completed work units, and
   a web user interface configured to facilitate views at each level of the organization hierarchy across Work pattern items, the web user interface further configured to selectively filter and drill down to generate and compare discrete effort data for any Work Pattern item across any business attribute, wherein:
      the Work Pattern items are selected from the group consisting of effort, habits, effort distribution across Purposes, Activities, applications and work units, work life balance index, capacity utilization, and work effectiveness index, and
      the business attributes are selected from the group consisting of role, skills, salary, position, and location for the user, and from the group consisting of domain, vertical, cost and profit center, and priority for the organization sub-unit; and
   a blocker, resident in the server, the blocker cooperating with the CS agent and adapted to:
      control third party access to individual level data by restricting access to the individual level data based on the organization hierarchy and as per assigned access rights,
      block individual data visibility of certain users based on their role or seniority in the organization,
      block individual data visibility entirely, and
      block organization sub-unit visibility if a user count computed for the organization sub-unit is below a predetermined user count.

In accordance with the present disclosure, the web user interface is configured to:
communicate with an internet browser and display through the internet browser the organization trends, reports, alerts, goals and administrative functions depending upon the user's position and role in the organization hierarchy; and
provide access to the organization effort aggregation and analytics engine for generation of user defined custom reports from the n-dimensional effort data cube.

In accordance with the present disclosure, the organization effort aggregation and analytics engine is further configured to deduce a best working pattern, and top performers at individual and organization sub-unit level, the organization effort aggregation and analytics engine further configured to determine unusual Work Patterns and the recent positive and negative deviations in the Work Patterns for an organization sub-unit, the organization effort aggregation and analytics engine further configured to generate a report including specific actions that can be undertaken to improve the efforts of the users.

In accordance with the present disclosure, the rules and pattern mapping engine is adapted to generate the default mapping rules for mapping the online and offline time slots to Purposes and Activities, including pattern matching to deduce best fit rules, the rules and pattern mapping engine further configured to adapt the rules for users in organization sub-units based on the business attributes and further adapted based on each user's position in the sub-unit hierarchy and the user's role therein.

In accordance with the present disclosure, the CS agent includes a user interface local to the CS agent, and configured to provide the respective users with private access to their corresponding entire work related and personal online and offline effort data.

In accordance with the present disclosure, the blocker is further configured to actuate an ‘anonymous mode’ wherein the visibility of individual effort data is completely blocked for the entire organization or for sub-units in certain geographies, and trends and reports are available only up to team level provided a team has a certain minimum number of employees.

In accordance with the present disclosure, the privacy filter is further configured to actuate a ‘self-improvement mode’ wherein:
no effort data is uploaded by default to the server;
productivity improvements are achieved through employee self-awareness by tracking user's own Work Patterns as provided on the local Computing System agent and by comparing against the goals set by the managers and the organization;
Work Patterns are uploaded anonymously to the server, in return for being able to view the comparative trends across the users who voluntarily shared their respective effort data, and thereby rate one's own relative performance; and
user's profile is defined and comparisons are made with peers having a similar profile and who voluntarily but anonymously shared their respective effort data, wherein the user's profile is selected from the group consisting of role, seniority, location and skills.

In accordance with one embodiment of the present disclosure, the system further includes:
a global pattern knowledge platform configured to enable the participating organizations to share their high-level Work Pattern analytics and trends based on employee and sub-organization categories;
a profile definition module configured to enable the participating organizations to define profiles corresponding to at least their respective sizes, industry and vertical;
and
a report generation module configured to prepare reports rating the organization's performance and standing relative to peer organizations in accordance with the selected profile criteria.

In accordance with the present disclosure, the time tracker is further configured to ignore any simulated input device or spurious movement through robotic control of the physical devices.

In accordance with one embodiment of the present disclosure, the user Work Pattern analyser employs an automated and adaptive learning for:
deciding improvement goals for the user; and
determining the user's work effectiveness index and work life balance index.

In accordance with one embodiment of the present disclosure, the user Work Pattern analyser employs a fuzzy logic to determine user vacations, weekends and holidays, shift timings, work from home and office and other locations, and unaccounted time in office.

In accordance with one embodiment of the present disclosure, the user predictor and instructor module uses correlation between the Work Pattern items and the work output to:
provide feedback to the user about the Work Pattern items that impact work output; and
make recommendations to improve performance.

In accordance with one embodiment of the present disclosure, the organization predictor and instructor module employs an automated and adaptive learning for:
deciding improvement goals for each sub-unit; and
determining the sub-unit's work effectiveness index and the sub-unit's work life balance index.

In accordance with another embodiment of the present invention, the organization predictor and instructor module employs correlation between the sub-unit Work Pattern items and the sub-unit work output to:
provide feedback to managers about the sub-unit Work Pattern items that impact sub-unit work output; and
make recommendations to improve the sub-units performance.

The present disclosure also envisages a method for automatically measuring, aggregating, analysing and predicting the exact effort and time productivity, of at least one user accessing at least one server via at least one Computing System (CS) agent, within an organization and thereafter providing instructions for improving productivity and workload allocation, and optimizing workforce and operational efficiency.

### BRIEF DESCRIPTION OF THE ACCOMPANYING DRAWING

Other aspects of the disclosure will become apparent by consideration of the accompanying figures and their descriptions stated below, which is merely illustrative of a preferred embodiment of the disclosure and does not limit in any way the nature and scope of the disclosure.

FIG. 1, FIG. 1A, FIG. 1B, FIG. 1C, FIG. 1D, FIG. 1E and FIG. 1F represent a flowchart of steps for automatically measuring, aggregating, analysing and predicting the exact effort and time productivity, of at least one user accessing at least one server via at least one Computing System (CS) agent, within an organization and thereafter providing instructions for improving productivity and workload allocation, and optimizing workforce and operational efficiency;

FIG. 2 is a schematic of the system to measure, aggregate, analyse, predict and improve the exact effort and time productivity of employees at an organization in accordance with the present disclosure, comprising of at least one CS agent cooperating with at least one server;

FIG. 3 is a schematic of the CS agent to automatically measure the employee's online and offline time utilization and map to Activity and Purpose, along with a local user interface to review and improve user's own effort and Work Patterns;

FIG. 4 is a schematic of the server to collect user time utilization data from all available CS agents, automatically collect organization hierarchy and business attributes, and aggregate and analyse the exact effort and time productivity of employees, teams and organization sub-units, to deliver actionable metrics for productivity improvements;

FIG. 5 is an illustration of a global knowledge platform configured for collecting Work Pattern trends across industries, verticals, countries, roles and timelines. This is based on Work Pattern data collected from contributing organizations in return for being able to perform relative comparisons and ranking with peer organizations; and

FIG. 6 is an illustration of how automatic configuration of the master list of Activities and Purposes for an organization, and the user-wise list of valid Activities and Purposes and mapping rules, is achieved based on the organization hierarchy and business attributes obtained from the organization's existing application data stores.

### DETAILED DESCRIPTION

The system and method for automated measurement, recording, analysing and improving work effort of employees, teams, and organization sub-units, will now be described with reference to the accompanying drawing which does not limit the scope and ambit of the present disclosure. The description provided is purely by way of example and illustration.

In view of the drawbacks associated with the prior art systems, there was felt a need for a completely automated system that can precisely capture all the work effort which in today's environment may be at any time during the day (24 hours) and week (7 days), in office and outside the office, by using a multiplicity of different computing systems such as office computer, laptop, smartphone, and while offline on meetings, lab work, business calls, outside travel and remote meetings. Work and personal time has to be differentiated, and work time must be further mapped to business related Activities and Purposes that are automatically inferred. There was also felt a need for the captured work effort from each employee, to be aggregated and analysed as per the organization's hierarchy and business attributes that should be automatically collected from the organization's existing application data stores. There was felt a need for a system that could deliver actionable and objective metrics that can help optimize enterprise effort in every aspect of the business. The system should also provide required protection for individual privacy, and restrict visibility of work effort as per the requirements of the organization and privacy laws of the countries it operates in. The senior management of an organization should have access to a global platform where they can compare their own organization's productivity and work effort in relation to with other peer organizations.

A computer implemented system designed to answer the aforementioned needs should have the following capabilities:
collector to measure and improve the exact work effort at individual level throughout the day by:
   tracking the online time spent by employees on one or more Computing System (CS) including desktop, laptop, any CS that is shared by multiple users through a common login, and remote servers;
   tracking the offline time spent away from the CS in work related meetings, phone calls, lab and other work areas in the office, travel and meetings at remote locations;
   differentiating work and non-work related time, with the non-work time details not made available to the organization;
   mapping the individual's work time intelligently to Activities and Purposes based on the online applications and artifacts used, the source of the offline time (type of PD), and the individual's role and the organization sub-unit that the employee belongs to;
   automating the entire capture of work time, both online and offline, and mapping to Activities and Purposes, and eliminating all user input or limiting it to the barest minimum;
   inferring the Work Patterns of the user such as the leaves taken, work done on holidays, desk job done mostly online on one or more CS, supervisory work involving online and offline work, travel oriented work mostly offline and away from office, shift timings, variable work week, uninterrupted work focus on important activities, number of breaks taken, work units completed and so on;
   providing the employee with a local user interface to privately view the time utilization on personal and work activities, and ensure adequate work effort by benchmarking against goals (set by the individual, manager, or at organization level);
   computing productivity parameters such as sustained focus on core activities and limiting distractions (e.g. breaks, calls, emails) and work units completed to enable self-improvement and optimize work-life balance; and
   promoting good work habits through a recognition-and-rewards system based on performance points earned for goals achieved and consistency, progressive performance levels, and badges.
collector and analyser to measure exact enterprise effort, provide accurate comparative benchmarks, and optimize business efficiency, as follows:
   collect the time utilization data from each CS for all the employees, with breakup across the Activities and Purposes of interest, at a central server;
   automatically collect the organization hierarchy (grouping of individual employees into teams, projects, divisions in one or more hierarchies based, for example, on functions, services lines, and locations) from the organization's existing application data stores;
   automatically source the attributes that qualify employees' role (such as level, location, skills, salary), projects and functions and organization sub-units (for example, revenue and R&D and cost centers, verticals, technologies) from various existing application data stores;
   configure a master list of Activities and Purposes, derived from the organization hierarchy (which represents projects and functions) and business attributes (which determine the relevant Activities for a particular type of organization and its sub-units), and the master list may be multi-level and adapted for each organization sub-unit and user;
   configure default rules for mapping online and offline time slots to Activities and Purposes, the rules adapted for organization sub-units based on their business attributes and further adapted for each user based on his or her position in the sub-unit hierarchy and the user's role therein;
   aggregate and map individual effort as per the organization hierarchies and attributes;
   derive the per-employee Daily Average Work Pattern for any organization sub-unit, specifically to allow for meaningful comparison between two or more organization sub-units (ranging from the entire company, business units to individuals), across any time range, and irrespective of the nature of business and role;
   compute the per-employee Daily Average Work Pattern for any specified sub-unit and duration of interest, for which it becomes necessary to infer and account for the various complexities such as employees working on multiple CS, in more than one project, employees with different roles, shift timings, variable work weeks, holidays and vacations, work done while on holidays and vacation days, geographically distributed teams with different work weeks and holidays, variable nature of work in different organization sub-units, complex organization hierarchies including matrix structures etc.
   create an n-dimensional effort data cube and analytics engine to allow generation of custom reports by defining the parameters to be viewed and compared against, filters for selecting a subset, in which the parameters comprise any and every data item sourced, including online and offline time, applications, Activities, Purposes, artifacts, organization sub-units, organization attributes, along with ability for statistical analysis based on totals, averages, maximum and minimum values, standard deviations etc.
   provide analytics, reports, goal compliance, alerts and rewards notifications responsive to the exact effort data across Purposes, Activities, applications, artifacts, organization attributes, supported by the further ability to selectively filter and drill down to generate and review discrete effort data at level of sub-unit and individual employees to meet the corporate commitments;
   allow access to analysed data as per the organization hierarchy and permitted access rights to various roles;
   provide a platform to showcase the best Work Patterns at the level of any desired sub-unit, notify top performers in terms of performance points and badges earned, and publish awards;
   deduce recent positive and negative deviations in Work Patterns for any organization sub-unit, and generate a report on specific actions that can be taken to drive improvement; and
   create an open database and data exchange capability to interconnect with other organization applications related to project management, performance tracking, HR systems for vacations and appraisals, project accounting, budgeting and so on.
Individual privacy protection by providing administrative controls that allow each organization to strike the desired balance between work effort visibility and respect for privacy, for meeting organization requirements and for complying with privacy laws, through the following three options:
   user private time
      guarantee that details of time spent on personal work outside of office is not available to the organization;
      provide a local user interface on each CS for the employee so that details of personal and work time are available for private viewing, and only selected elements of the work data become available to the organization for consolidation on a central server;
      block details of time on personal work while in office as well, except when explicitly requested by the organization in which case the employee is made aware of it;
      optionally, provide users with a user private time selector during which employee's time tracking is disabled for specified duration, and the entire time is marked as Unaccounted and Private;
      individual users will always have full visibility to their work and personal time data on their local CS
   Details of work time visible to the organization
      block work time on any of the following: applications, artifacts (files, folders, websites);
      select frequency: default is real-time, but can be changed to daily, weekly or monthly average of Work Patterns to make it less intrusive;
      option for ‘self-improvement mode’ in which user data is never uploaded to the server, and employees are expected to self-improve using their data on the local CS
Limiting visibility of employee level work data
   limit visibility of individual work data as per the reporting hierarchy, and as per the access rights for various roles;
   option to allow individual level data visibility only to select managers for their direct reports;
   option for blocking individual data visibility for certain employees, for example those at higher position in the organization;
   option for ‘anonymous’ mode wherein visibility of individual data and also small teams fewer than ten employees (or as required) is not available to anyone in the organization.
A global Work Pattern knowledge platform in which organizations across various industries, verticals, countries, and scale, can share their high level Work Pattern trends and analytics with assured anonymity, and in return compare their rating with peer organizations.

The system envisaged by the present disclosure captures all the work effort which in today's environment which may be at any time throughout the day (24 hours). These include office workers spending most of their work time on computers, and marketing and sales staff making extensive business calls and travelling to customer locations. Systems and methods have been described to track the daily time spent by employees, irrespective of whether the time is spent on one or more computing devices, or away from any computing system while in meetings, discussions, calls, lab work, outside travel, and remote visits. This is mapped to activities and objectives that are automatically inferred based on the applications and artifacts being used, the source of offline time usage, and the employee's position in the organization and role therein. The captured individual work effort is mapped to the organization's hierarchy and business attributes. This organization data is automatically collected from existing organization application data stores, and does not require any manual definition or configuration. As a result, it becomes possible to identify the Work Patterns and trends within each sub-unit and operational dimension of the business, and hence providing a powerful platform for enterprise wide effort and capacity optimization. The system envisaged by the present disclosure delivers actionable and objective metrics that can drive accountability across management layers for the work effort of the teams they are responsible for, and ensure productivity improvements and optimal staffing to accomplish the desired results in every aspect of the business.

The present disclosure discloses a variety of methods and systems to meet the needs of employee privacy, organization culture, and the different privacy laws of countries where the organization may operate. This includes not allowing access to individual personal time details, a local user interface that enables the user to confirm this, and providing individual work data visibility to the organization only to the extent appropriate, including the option of voluntary sharing of work trends by employees.

Finally, the present disclosure envisages a global Work Pattern knowledge platform, wherein organizations across various industries, verticals, countries, and size, can participate by contributing their high level Work Pattern trends and analytics, and in return get feedback on how they rate relative to peer organizations, with anonymity assured for all participants.

A key aspect of the present disclosure is an intelligent system that automatically determines each employee's effort throughout the day (24 hours) for all days, when performed online on one or more computing systems, and offline on business meetings, lab work, business calls, outside travel, and remote meetings. The employee's effort is mapped to Activities and Purposes that are also automatically inferred based on the applications and artifacts being used online, the source of offline time usage, and the employee's role and position in the organization.

A second aspect of the present disclosure includes a system to aggregate each employee's effort as per the organization's hierarchy and business attributes that are automatically collected from existing organization application data stores, and analyse them to deliver actionable and objective metrics, such as a per-employee Daily Average Work Pattern, that can drive accountability across management layers for the work effort of the teams they are responsible for, and ensure productivity improvements and optimal staffing to accomplish the desired results in every aspect of the business.

According to a third aspect of the present disclosure, methods are described that allow the organization to set administrative policies for protection of individual privacy consistent with its own requirements and for complying with privacy laws in the countries that they operate in. The policies regulate collection of only work effort excluding details of personal time, restricting visibility of individual work data, and limiting the frequency and details of work effort that is collected.

A fourth and final aspect of the disclosure describes a global Work Pattern knowledge platform in which participating organizations share their collective Work Pattern analytics and trends in anonymous mode, and in turn they can perform relative comparisons and ranking with peer organizations across industries, verticals, countries, roles and timelines.

Aspects of the present disclosure will become apparent by consideration of the accompanying drawing and their descriptions stated below, which is merely illustrative of a preferred embodiment of the disclosure and does not limit in any way the nature and scope of the disclosure.

The present disclosure teaches a system for measurement, aggregation, analytics and improvement of exact organization effort and time productivity. In accordance with one aspect of the present disclosure, the system is based on a client-server architecture where each one of the employee's CS is loaded with a client application which automatically tracks time utilization, intelligently maps it to Activities and Purposes based on default rules that may be optionally remapped by the employee, and communicates the effort data (time-Activity-Purpose) to a central server for further storage, aggregation and analysis. The server can be hosted within the organization on a single physical server machine or on multiple machines to accordingly distribute the workload. Alternatively, the server can be provisioned for more than one organization as part of a Software as a Service (SaaS) solution by hosting it within a cloud computing infrastructure. On the same or a different SaaS server, a global Work Pattern knowledge platform is provided on which participating organizations share their collective Work Pattern analytics and trends in anonymous mode, and in turn they can perform relative comparisons and ranking with peer organizations across industries, verticals, countries, roles and timelines.

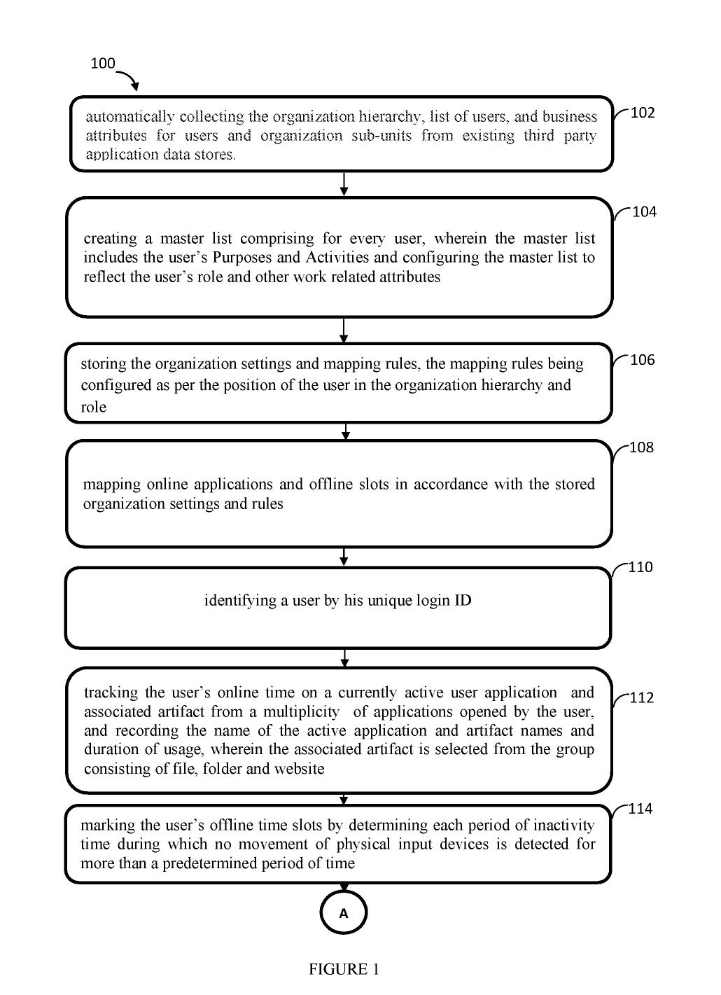

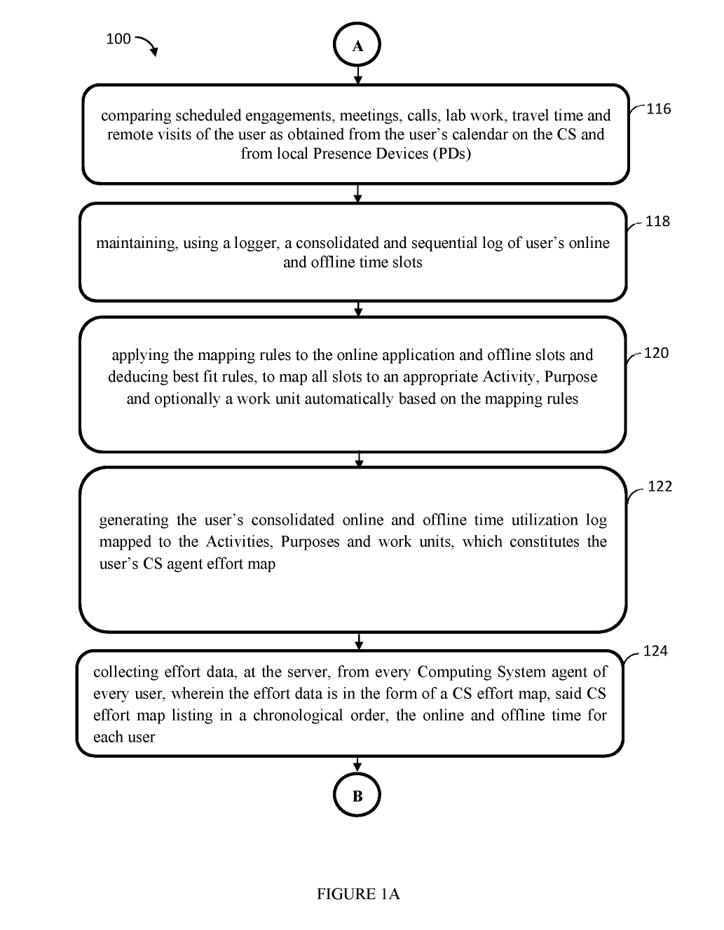

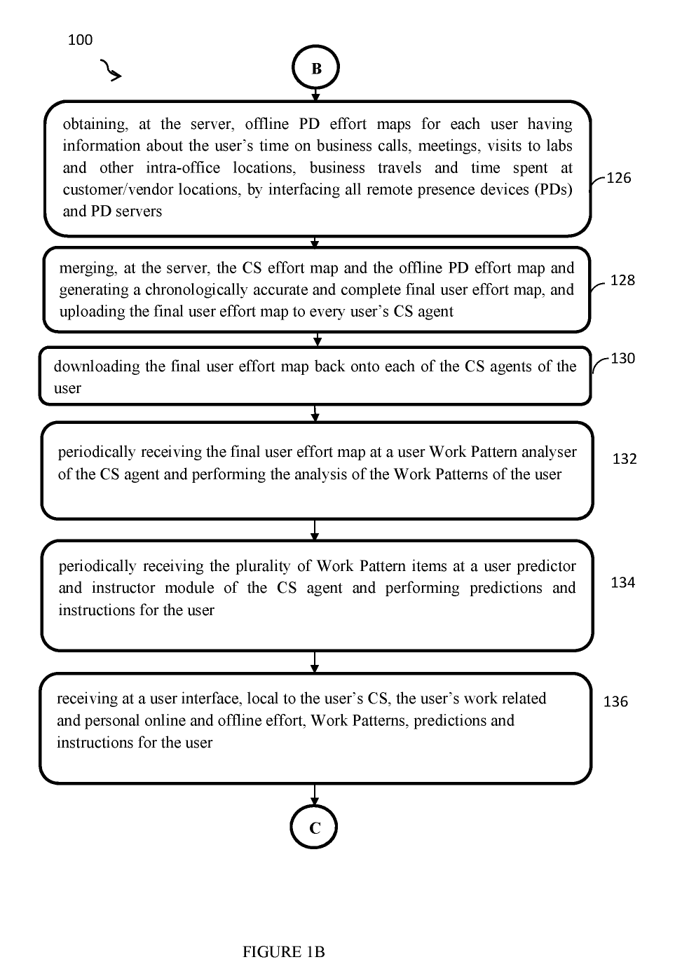

Referring to the accompanying drawing, FIG. 1, FIG. 1A, FIG. 1B, FIG. 1C, FIG. 1D, FIG. 1E and FIG. 1F illustrate a flow chart 100 depicting a method for automatically measuring, aggregating, analysing and predicting the exact effort and time productivity, of at least one user accessing at least one server via at least one Computing System (CS) agent, within an organization and thereafter providing instructions for improving productivity and workload allocation, and optimizing workforce and operational efficiency, as per the following steps:
At step 102 the method includes automatically collecting the organization hierarchy, list of users, and business attributes for users and organization sub-units from existing third party application data stores.
At step 104 the method includes creating a master list comprising for every user, wherein the master list includes the user's Purposes and Activities and configuring the master list to reflect the user's role and other work related attributes.
At step 106 the method includes storing the organization settings and mapping rules, the mapping rules being configured as per the position of the user in the organization hierarchy and role.
At step 108 the method includes mapping online applications and offline slots in accordance with the stored organization settings and rules.
At step 110 the method includes identifying a user by his unique login ID.
At step 112 the method includes tracking the user's online time on a currently active user application and associated artifact from a multiplicity of applications opened by the user, and recording the name of the active application and artifact names and duration of usage, wherein the associated artifact is selected from the group consisting of file, folder and web site.
At step 114 the method includes marking the user's offline time slots by determining each period of inactivity time during which no movement of physical input devices is detected for more than a predetermined period of time, wherein the physical input devices are selected from the group consisting of keyboard, keypad, touchpad and mouse.
At step 116 the method includes comparing scheduled engagements, meetings, calls, lab work, travel time and remote visits of the user as obtained from the user's calendar on the CS and from local Presence Devices (PDs), wherein the local Presence Devices include smartphones with GPS, that are connectable to or a part of the CS agent, with the duration of the offline time slots for determining the user's offline time utilization.
At step 118 the method includes maintaining, using a logger, a consolidated and sequential log of user's online and offline time slots.
At step 120 the method includes applying the mapping rules to the online application and offline slots and deducing best fit rules, to map all slots to an appropriate Activity, Purpose and optionally a work unit automatically based on the mapping rules.
At step 122 the method includes generating the user's consolidated online and offline time utilization log mapped to the Activities, Purposes and work units, which constitutes the user's CS agent effort map.
At step 124 the method includes collecting effort data, at the server, from every Computing System agent of every user, wherein the effort data is in the form of a CS effort map, the CS effort map listing in a chronological order, the online and offline time for each user.
At step 126 the method includes obtaining, at the server, offline PD effort maps for each user having information about the user's time on business calls, meetings, visits to labs and other intra-office locations, business travels and time spent at customer/vendor locations, by interfacing all remote Presence Devices (PDs).
At step 128 the method includes merging, at the server, the CS effort map and the offline PD effort map and generating a chronologically accurate and complete final user effort map, and uploading the final user effort map to every user's CS agent.
At step 130 the method includes downloading the final user effort map back onto each of the CS agents of the user.
At step 132 the method includes periodically receiving the final user effort map at a user Work Pattern analyser of the CS agent and performing the analysis of the Work Patterns of the user;
At step 134 the method includes periodically receiving the plurality of Work Pattern items at a user predictor and instructor module of the CS agent and performing predictions and instructions for the user.
At step 136 the method includes receiving at a local user interface, local to the user's CS, the user's work related and personal online and offline effort, Work Patterns, predictions and instructions for the user.
At step 138 the method includes displaying privately and exclusively to the user the Work Pattern trends, instructions and the progress report for a predetermined period.
At step 140 the method includes disabling the user's time tracker for specified time ranges, wherein the time ranges includes the time slots, the time slots in the time ranges are marked as unaccounted and private time.
At step 142 the method includes marking all effort that is not identified as being on work related activities by the server and the user's mapping rules as personal time.
At step 144 the method includes enabling the user to explicitly change any time that was marked as personal to work.
At step 146 the method includes enabling the user to explicitly change any time that was marked as work by the server or user's mapping rules to personal.
At step 148 the method includes enabling the user to select, or enabling the CS agent to set directly, from one or more privacy filter settings, when the CS agent is enabled to upload the user's effort data, and further blanking any or all the data as per the privacy filter settings before uploading the CS agent effort map to the server.
At step 150 the method includes deactivating upload of all the user's information to the server, when the CS agent is not enabled to upload the user's effort, both work and personal, to the server, thereby enabling the CS agent to function in self-improvement mode for the user and further enabling the CS agent or user to select from one of the voluntary data sharing options in which case the volunteered data in the CS agent effort map will be uploaded to the server.
At step 152 the method includes collecting and maintaining, at the server, a list of current valid users and the organization hierarchy that maps every user to one or more organization sub-units, and collecting and maintaining the business attributes qualifying each user and organization sub-unit.
At step 154 the method includes consolidating and rolling up, at the server, individual online and offline effort data as per the organization hierarchy, and computing a per-employee Daily Average Work Pattern for every sub-unit.
At step 156 the method includes generating, at the server, an n-dimensional effort data cube mapping individual and collective efforts of respective users as per the organization hierarchy.
At step 158 the method includes periodically receiving the per-employee Daily Average Work Pattern for each sub-unit at an organization Work Pattern analyser of the at least one server and performing the analysis of the per-employee Daily Average Work Pattern for each sub-unit.
At step 160 the method includes computing a plurality of sub-unit Work Pattern items for each sub-unit, wherein the plurality of sub-unit Work Pattern items are selected from the group consisting of a sub-unit effort, sub-unit habits, a sub-unit effort distribution across Purposes, Activities, applications and work units, a sub-unit work life balance index, a sub-unit work effectiveness index, and a sub-unit capacity utilization.
At step 162 the method includes periodically receiving the plurality of sub-unit Work Pattern items at an organization predictor and instructor module of the at least one server and performing predictions and instructions for each sub-unit.
At step 164 the method includes assigning, at the server, performance points to users based on the individual and aggregate effort and completed work units.
At step 166 the method includes facilitating, over the web user interface, the display of trends related to work effort, Work Patterns, predictions and instructions relating to sub-units at each level of the organization hierarchy subject to view access rights of the user and data blocker settings.
At step 168 the method includes enabling the user, over the web user interface, to selectively filter and drill down, at the server, for generating and comparing discrete effort data for any Work Pattern item across any business attribute.
At step 170 the method includes enabling the user, over the web user interface, to define and generate custom analytical reports of interest from the n-dimensional effort data cube.

In an embodiment, the step of performing the analysis of the Work Patterns of the user includes following sub-steps:
computing a plurality of Work Pattern items, using the final user effort map, wherein the plurality of Work Pattern items are selected from the group consisting of a work time, an online work time, an offline work time, a time spent on each Purpose, Activity, application and work unit for the user, a core activity time, a collaboration work time, work habits, a total travel time, a fitness time, a PD usage time, a smartphone addiction, a physical time in a workplace, a private time in a workplace, a work time at home, a work effectiveness index and a work life balance index;
generating wellness instruction prompts for the user;
tagging each day, in the final user effort map, as a workday, a weekend day, a public holiday or a vacation;
automatically detecting the user's location as home, office and other; and
tagging each day, in the final user effort map, as a work from office day, a work from home day or a work from other location day.

In an embodiment, the step of performing predictions and instructions for the user includes following sub-steps:
selecting the appropriate Work Pattern items, from the plurality of Work Pattern items, for tracking the user's performance based on the user's role in an organization hierarchy;
providing a feedback to the user on highlights related to a work effort, a work output, and the work life balance index;
suggesting areas of improvements;
setting the goals for the user based on the plurality of Work Pattern items;
providing encouragement for the user with points and badges;
generating a progress report based on the goals, the points and badges won; and
predicting the improvements in the work effort, the work output, the work effectiveness index and the work life balance index;

In an embodiment, the step of enabling the user to select, or enabling the CS agent to set directly, from one or more of the following privacy filter settings includes following sub-steps:
deactivating uploading of user's personal time details to the server;
deactivating uploading of some aspects of the user's work related information including applications and associated artifacts to the server; and
reducing the granularity of the user's work related information that is uploaded to the server to a daily, weekly, or monthly average of the Work Patterns;

In an embodiment, the step of enabling the CS agent to select from one of the following data sharing options includes following sub-steps:
allowing the user to voluntarily disclose identity and some or all aspects of the user's Work Patterns to the server in return for being able to collaborate with peers or the entire organization for benchmarking and cross-learning from each other; and
allowing the user to voluntarily disclose some or all aspects of the user's Work Patterns to the server, wherein the CS agent is adapted to obfuscate the user's identity, in return for being able to benchmark user's own performance with that of peers or the entire organization as provided by the server.

The step of performing predictions and instructions for each sub-unit includes following sub-steps:
selecting the appropriate sub-unit Work Pattern items, from the plurality of sub-unit Work Pattern items, for tracking each sub-unit's performance based on the nature of each sub-unit;
providing a feedback to a manager on highlights related to a sub-unit work effort, a sub-unit work output, a sub-unit workload assignment and a sub-unit staff allocation for each sub-unit;
suggesting areas of improvements;
tracking progress;
setting goals for improving the sub-unit work effectiveness index and a sub-unit productivity;
suggesting recommendations about the best practices;
predicting the improvements in the sub-unit work effort, the sub-unit work output, the sub-unit work effectiveness index and the sub-unit work life balance index;
predicting delays in project timelines, effort and cost overruns, inability to meet an output target, and the impact possible with improvements and
generating intelligent reports for improving operational effectiveness and a talent management.

The step of consolidating and rolling up individual online and offline effort data further includes the following steps:
deducing the best working pattern, top performers at individual and organization sub-unit level;
determining unusual Work Patterns and the recent positive and negative deviations in Work Patterns for an organization sub-unit; and
generating a report including specific actions that can be undertaken to improve the efforts of the users.

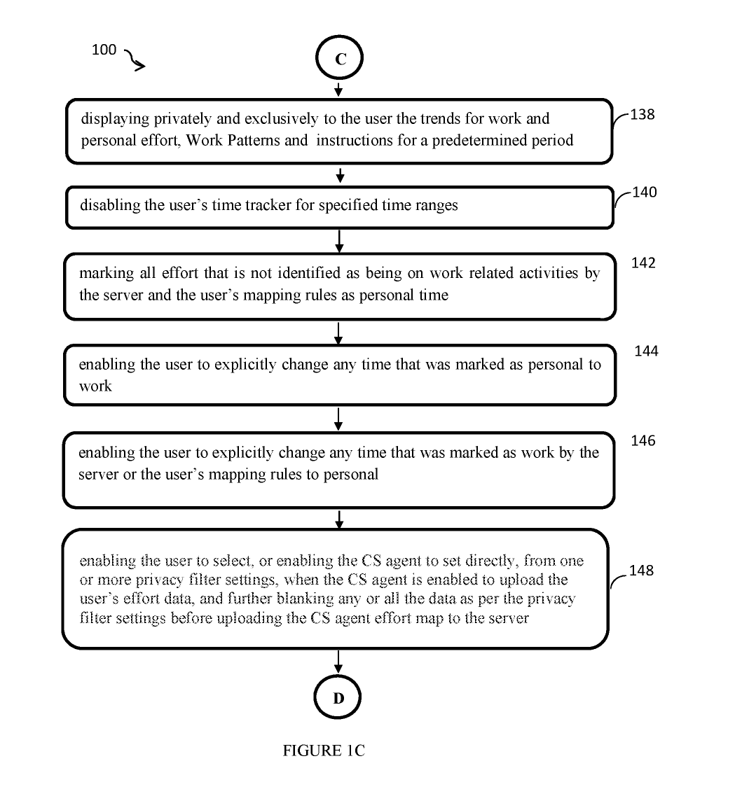

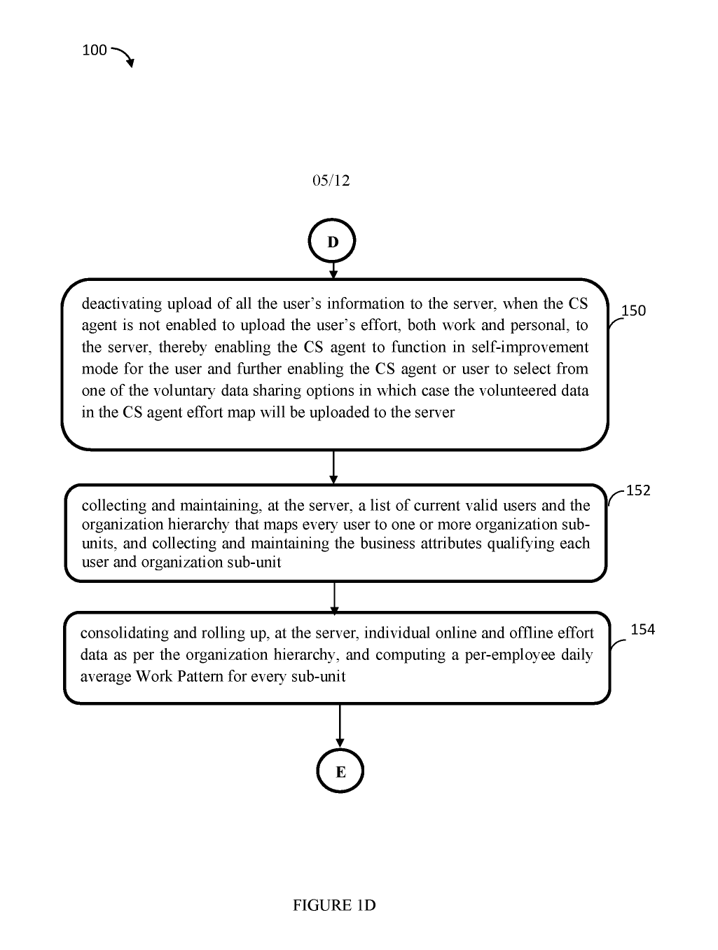

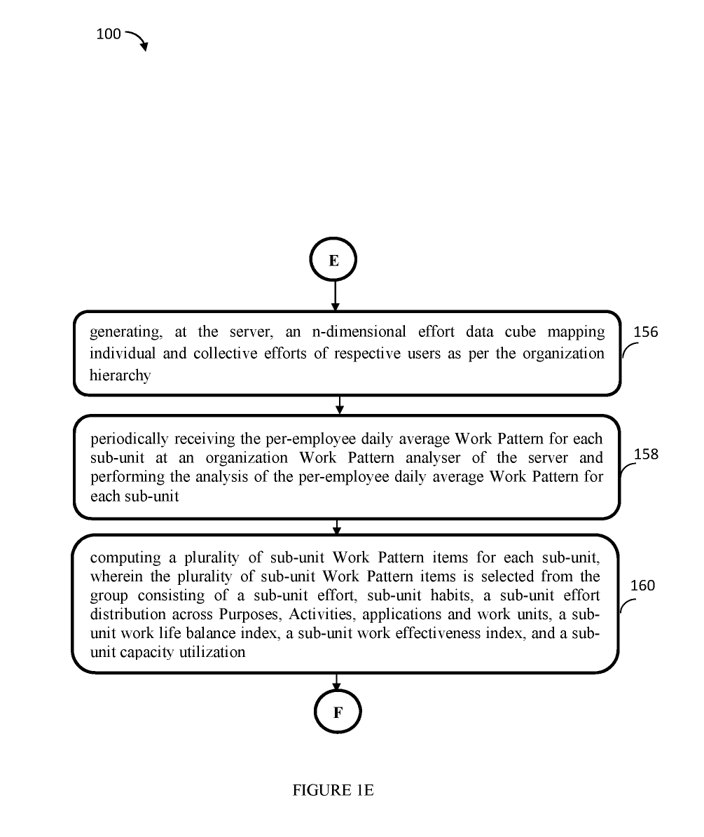

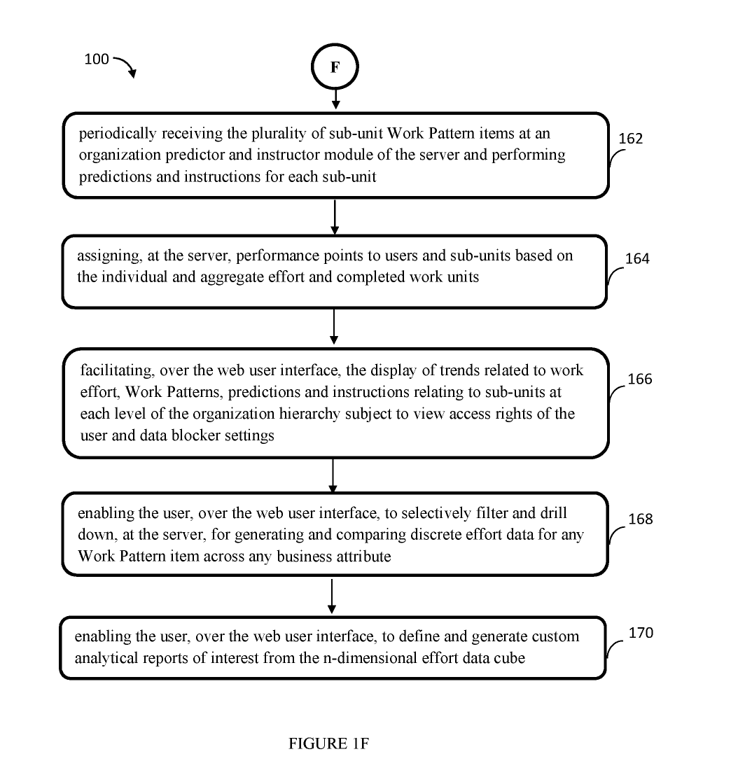

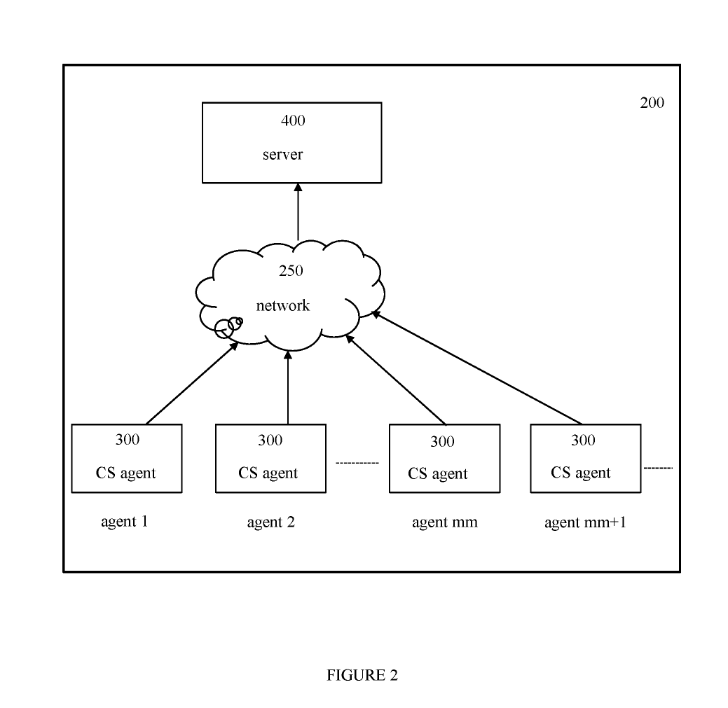

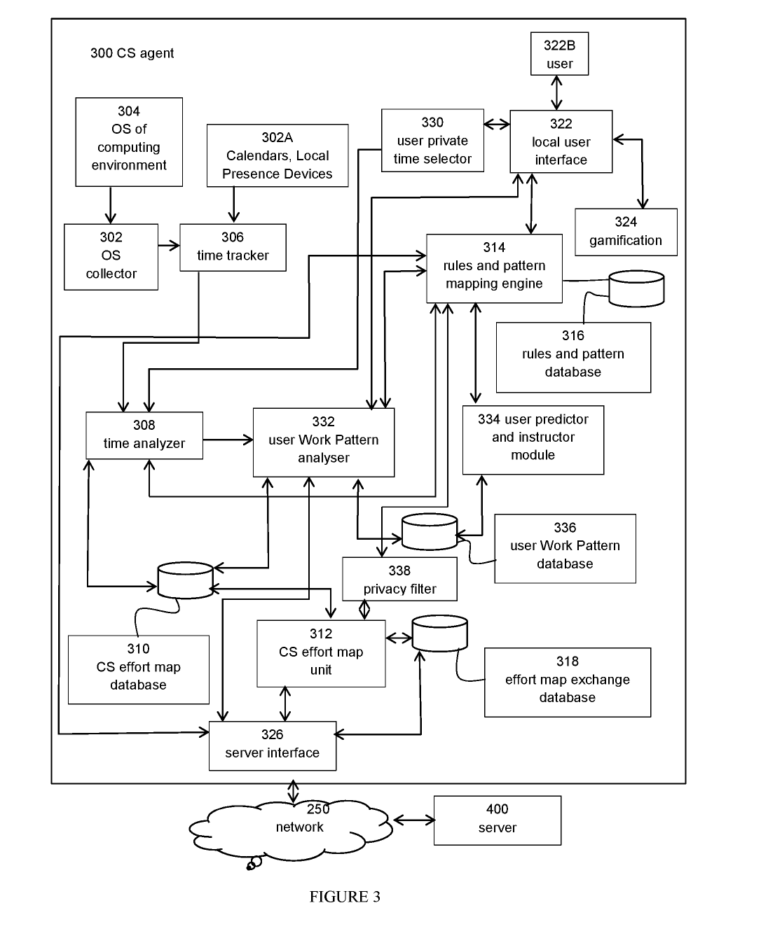

A system for implementing the steps noted in FIG. 1 is now described. Referring to the accompanying drawing, FIG. 2 is a schematic of the system to measure, aggregate, analyse, predict and improve an organization's collective work effort and individual time productivity. The system includes at least one CS agent per employee, cooperating with at least one server communicating over the network 250. The CS agent is adapted to generate exact effort data for a user and the server providing the exact effort data and analytics for an organization. FIG. 3 is a schematic of the CS agent 300 and its components, as described further below:

An operating System (OS) collector 302: The OS collector 302 runs in the background of the user's CS agent 300 and collects events related to the user's interaction with the CS and status of current active application window and artifacts related to the application, by interfacing with the CS's Operating System 304. It also picks up data from local calendaring applications and local PDs 302A interfacing with the CS, regarding time spent away from the CS on meetings, calls, travel and the like.

A time tracker 306: The time tracker 306 receives the collected data from the OS Collector 302 and aggregates the data chronologically into time slots pertaining to online time on applications and artifacts on the Computing System of the user (322B) CS and offline time on scheduled meetings, calls and travel as obtained from local calendaring applications and PDs.

A time analyser 308: The time analyser 308 takes the output of the time tracker 306 and maps the time slots to Activity and Purpose (along with any user annotations) based on inputs from the rules and pattern mapping engine 314. The resulting output is stored in the CS effort map database 310. For example:
time spent on email applications such as Outlook and Lotus Notes (both desktop) and gmail (web application), and chat programs, can be marked to the ‘communication’ Activity;
In an IT organization, time spent on the Visual Studio engineering application will be marked to ‘Programming’ Activity for an employee who is a programmer, and ‘Test/QA’ Activity for a tester;
time on calls made to known customer numbers, as obtained from PDs such as mobiles and EPABX logs, can be marked to an Activity called ‘Calls’ and Purpose being the user's current project or function; and
time spent on travel and remote visits that are identified as a customer location using Google Maps, can be marked as ‘Sales Visits’ for personnel in the sales team.

A CS effort map unit 312: The CS effort map unit 312 uploads the CS effort map to the server 400, where a server effort map unit 408 consolidates the effort maps that are obtained from all the CS where user has spent time, and also the offline effort spent by the user as obtained from PDs and PD servers 408A that connect to the server 400. The merged user effort map is then downloaded back to each CS and stored in an effort map exchange database 318.

A rules and pattern mapping engine 314: The rules and pattern mapping engine 314 maintains the list of Activities and Purposes, and the mapping rules as applicable to the user depending on the user's position and role in the organization. These mapping rules are obtained from the organization settings and rules engine 416 and maintained in the rules and pattern database 316. The user may edit any default mapping rule, provided it is marked as being editable, and may also add new mapping rules that relate to certain unique usage patterns for applications and artifacts. New user mappings are communicated back to the server side organization settings and rules engine 416. The rules and pattern mapping engine 314 makes the data available to the time analyser 308 for mapping the user's time utilization. The rules and pattern mapping engine 314 may include organization mapping rules and current user specific mapping rules for mapping online applications and offline slots to a default Purpose and Activity.

A user private time selector 330: The user private time selector 330 optionally enables the user to disable time tracking for a specified duration. The entire time is marked as Unaccounted and Private. The user private time selector may optionally be enabled only outside of regular working hours.

A local user interface 322: local user interface 322 lets the user to review time utilization and mapping to Activity and Purpose in the effort map exchange database 318 for the current and recent days (typically last 7-30 days), edit mappings (if enabled) and add new mappings if required. The local user interface 322 also enables the employee to track and improve work effort. The user can view minute by minute details of the captured and mapped time for past few days, and higher level analysis such as trends and reports of time utilization on work across Purposes and Activities, Work Patterns such as work focus through uninterrupted time on important activities, distractions, breaks taken and work units completed. The user can edit Activity-Purpose mappings, and utilize the trends to ensure adequate and right quality of effort, benchmark current performance against goals, improve productivity and optimize work-life balance.

A gamification module 324: The gamification module 324 is designed to encourage the user to improve work habits by setting challenges related to work focus and minimizing distractions, awarding performance points, badges for consistent performance, and progressive performance levels.

A server interface 326: The server interface 326 provides for communication between the CS agent 300 and the server 400. The server interface 326 enables download of valid Purposes and Activities, default mapping rules, goals and alerts, and user effort map from the server 400. The CS effort map, new user mapping rules and unmapped applications and websites are also uploaded to the server 400 through this interface.

A user identifier (not shown in figures): The user identifier cooperates with the CS to identify a user by his/her unique login ID available with the CS. The user identifier is further configured to prompt the user for the ID in case a neutral login is being used by more than one user.

A comparator (not shown in figures): The comparator cooperates with the time tracker 306 to receive the marked offline slots for a user. The comparator further compares the scheduled engagements, meetings, calls, lab work, travel time and remote visits of the user, which are obtained from the user's calendar on the CS and from local Presence Devices (PDs) such as smartphone with GPS, that are connectable to or a part of the CS, with the duration corresponding to the offline slots marked for the user.

A logger (not shown in figures): The logger cooperates with the time tracker 306 and is configured to maintain a consolidated and sequential log of user's online and offline slots.

A privacy filter 338: The privacy filter 338 is present in the CS Agent 300. The privacy filter is adapted to mark all effort that is not identified as being on work related activities by the server and user's mapping rules as personal time. The privacy filter 338 is further adapted to enable each user to explicitly change any time that was marked as personal to work. The privacy filter 338 is still further adapted to enable each user to explicitly change any time that was marked as work by the server 400 or user's mapping rules to personal. The privacy filter 338 is still further adapted to block upload of user's personal time details to the server. The privacy filter 338 is still further adapted to block upload of some aspects of the user's work related information including applications and associated artifacts to the server 400. The privacy filter 338 is still further adapted to reduce the granularity of the user's work related information that is uploaded to the server 400 to a daily, weekly, or monthly average of the Work Patterns. Furthermore, the privacy filter 338 is adapted to block all access to the user's effort, both work and personal, while permitting each user to voluntarily disclose some or all aspects of his or her Work Patterns to the server.

The CS agent 300 and the server 400 communicate over the network 250 which can be the internet or the local area network of the organization.

According to the first aspect, the OS collector 302 is configured to run in background of user's CS while collecting events related to the user's interaction with the CS, identity of the current active application window, and artifacts related to the application. Further, according to the first aspect, the OS collector 302 is interfaced with an operating system that is selected from a group consisting of a desktop operating system, a laptop operating system, a mobile phone operating system, and an electronic notebook (tablet) operating system. The OS collector 302 continuously samples and stores the employee's current active application running on the CS and its associated artifacts such as files, folders and web-links. If multiple applications are open, the OS collector automatically tracks only the user's active window. Further, if the user is inactive, that is, there is no movement of any physical input device such as keyboard, mouse or touch screen, for a pre-determined time, typically 5 minutes, the time thereafter is marked as ‘away from PC’ time (also referred to as ‘offline’) until the user returns to the CS. Any programmatically simulated input device movement, as is the case with test automation software, will be ignored by the CS agent.

A pseudo-code depicting the functionality of the OS collector 302, in accordance with an embodiment of the present disclosure, is now described. In the following pseudo-code, the work unit tracking is enabled if the organization provides the work unit data at a user level.
The OS collector 302 tracks events related to the user's interaction with the CS agent 300 at a predetermined sampling rate. The predetermined sampling rate is set by the server 400. Typically, the predetermined sampling rate is 15 seconds;
The OS collector 302 appends a new row to the log consisting of sequential rows with the user's time related data and updates a current OS collector row pointer. The data in each row consists of several fields filled in by the OS collector 302 as listed below (which is further updated by the time tracker):
   a timestamp identifying the time and the date for the current sample row;
   a CS agent ID;
   a CS agent type (e.g. desktop, laptop, smartphone); and
   a user ID;
If the OS collector 302 confirms the event related to the user's interaction with the physical input device of the CS agent, then a ‘user active’ flag is set to ‘yes’, else the ‘user active’ flag is set to ‘no’;
The OS collector 302 continuously samples and stores the user's current active application running on the CS agent 300 and its associated artifacts such as files, folders and web-links. If multiple applications are open, the OS collector 302 automatically tracks only the user's active window. For the user's active window on a user screen, the OS collector 302 obtains and fills in the application name and an artifact name (file or folder or website) being used in the corresponding fields of the row. If CS agent 300 includes a GPS unit, then OS collector 302 fills the current user location coordinates;
If a work unit tracking feature is enabled, then the OS collector 302 enters the user's current work unit name in the log;
Done.

Table 1 summarizes an example of the log automatically generated by the OS collector 302. The OS collector 302 collects the events related to the user's interaction with the CS agent 300 from morning till lunch time (1 pm). For the sake of simplicity it is assumed that the user works on one activity for 10 minutes at a time and this is represented as one row in the log, even though the actual tracking may be at high sampling rate (typically every 15 seconds).

TABLE 1

| | | | | CS agent | |
|---|---|---|---|---|---|
| | applica- | | user | type | |
| time range | tion | artifact | active? | and ID | WiFi |
| 9:00 am to | Excel | UserFile1.xls | | PC 1 | Office 1 |
| 9:10 am | | | | | |
| 9:10 am to | Internet | cnn.com | | PC 1 | Office 1 |
| 9:20 am | Explorer | | | | |
| 9:20 am to | Internet | microsoft.com | | PC 1 | Office 1 |
| 9:30 am | Explorer | | | | |
| 9:30 am to | Excel | UserFile2.xls | | PC 1 | Office 1 |
| 9:40 am | | | | | |
| 9:40 am to | | | No | | |
| 9:50 am | | | | | |
| 9:50 am to | | | No | | |
| 10:00 am | | | | | |
| 10:00 am to | | | No | | |
| 10:10 am | | | | | |
| 10:10 am to | | | No | | |
| 10:20 am | | | | | |
| 10:20 am to | | | No | | |
| 10:30 am | | | | | |
| 10:30 am to | | | No | | |
| 10:40 am | | | | | |
| 10:40 am to | Visual | Customer4.prj | | PC 1 | Office 1 |
| 10:50 am | Studio | | | | |
| 10:50 am to | QTP | TestScrpt5 | | PC 1 | Office 1 |
| 11:00 am | | | | | |
| 11:00 am to | Word | Design1.doc | | PC 1 | Office 1 |
| 11:10 am | | | | | |
| 11:10 am to | Word | Design1.doc | | PC 1 | Office 1 |
| 11:20 am | | | | | |
| 11:20 am to | | | No | | |
| 11:30 am | | | | | |
| 11:30 am to | Word | Design1.doc | | PC 1 | Office 1 |
| 11:40 am | | | | | |
| 11:40 am to | | | No | PC 1 | Office 1 |
| 12:00 pm | | | | | |
| 12:00 pm to | Word | Design1.doc | | PC 1 | Office 1 |
| 12:10 pm | | | | | |
| 12:10 pm to | | | No | | |
| 12:20 pm | | | | | |
| 12:20 pm to | | | No | | |
| 12:30 pm | | | | | |
| 12:30 pm to | | | No | | |
| 12:40 pm | | | | | |
| 12:40 pm to | | | No | | |
| 12:50 pm | | | | | |
| 12:50 pm to | Word | Design1.doc | | PC 1 | Office 1 |
| 1:00 pm | | | | | |

The time tracker 306 receives the collected data from the OS collector 302 and arranges the sampled data chronologically. The time tracker 306 analyses and aggregates online time to provide a table about total time on each unique application and each artifact for a calendar day. The time tracker 306 prepares a similar table of contiguous offline time slots for the day. The time tracker 306 can be further configured to interface with the CS's Operating System 304 to collect the employee's offline work schedule from calendaring applications such as Microsoft Outlook, Lotus Notes, and Google Calendar. The time tracker 306 may obtain additional inputs from PDs that interface with the CS regarding other offline work (example, a smartphone CS that also identifies time on calls, travel and remote visits). The offline time overlapping with the calendar and PD inputs are then annotated with details such as appointment title, call contacts, travel and visit location.

Table 2 summarizes an example of data picked up from local calendaring applications on the user PC.

TABLE 2

| time range | application | artifact | user active | PD type ID |
|---|---|---|---|---|
| 7:30 am to | Google | Call parents | Meeting | calendar 2 |
| 7:40 am | Calendar | | | |
| 10:00 am to | Outlook | Support Visit | Meeting | calendar 1 |
| 10:30 am | Calendar | | | |
| 11:00 am to | Outlook | Team Review | Meeting | calendar 1 |
| 11:30 am | Calendar | | | |

A pseudo-code depicting the functionality of the time tracker 306, in accordance with an embodiment of the present disclosure, is now described.
The time tracker 306 obtains the current OS collector pointer;
The time tracker 306 receives the log automatically generated by the OS collector 302;
The time tracker 306 maintains a time tracked row pointer;
For each row between the time tracked row pointer and the current OS collector row pointer, the time tracker 306:
   checks the ‘user active’ flag in the new rows added to the log by the OS collector 302;
   identifies consecutive rows that add up to 5 minutes or more with the ‘user active’ flag status as ‘no’, indicating that the user was offline from the CS agent 300;
   marks the identified consecutive rows as ‘offline’ and clears the application names and artefact names;
when done, the time tracked row pointer is equal to the current OS collector pointer it obtained;
   the time tracker 306 polls OS collector 302 for local PD data if supported by the CS.
   in case of calendar applications, it gets meeting names, planned start and end times of new meetings and earlier meetings that have been changed since the last sample;
   in case of PD tracking locations:
      it obtains user location information as WIFI name, network name or GPS coordinates, and maps it to a specific location name if available;
      it detects start and end time of travel between start and destination locations, only for the locations with a minimum stay time of 15 minutes;
   in case PD tracking phone calls:
      start and end times of calls;
      outgoing and/or incoming call numbers and contact names if available;
   in case PD tracking user fitness:
      start and end times of fitness activity;
      nature of fitness activity and other details such as distance travelled, calories burnt;
time tracker 306 reviews each PD in sequential order of priority;
   for each entry in the PD, it identifies the rows in the log that are marked as offline and have blank application names;
   for all such identified rows that fall within the start and end times of the local Presence Device entry, the application names are filled in to identify the PD (such as calendar name, call detector, travel tracker, fitness tracker) and the artefact details (meeting title, phone number, contact names, location coordinates, location name, fitness type); and
done.

The time tracker 306 transmits the log to the logger. The logger maintains a consolidated and sequential log of the user's online and offline time slots.

The time analyser 308 takes the output of the time tracker 306 and maps the time slots to Activity, Purpose and optionally a work unit automatically based on mapping rules for the user provide by the rules and pattern mapping engine 314. Activity relates to the nature of work such as Engineering, Documentation, Communication, Meetings, Calls, Travel, and so on, and is typically related to the online application being used or the nature of the offline work. Purpose is the objective of the work, and will either be a project or function that the user is assigned to, non-project corporate work, or personal time. The resulting output of the time analyser 308 is stored in the CS effort map database 310. The Purpose is selected from the group consisting of assigned projects and functions. The Activity, for the selected Purpose, is selected from the group consisting of design, programming, testing, documentation, communication, browsing, meetings, calls, lab work, travel and visits. The work unit, for the selected Purpose, is selected from the group consisting of assigned transactions, tasks and deliverables.

In accordance with the first aspect, the time analyser 308 on the CS agent of the present disclosure uses intelligent rules to map time spent by the employees to Activities and Purposes. The rules are derived from the rules and pattern mapping engine 314. The resulting output is stored in the CS effort map database 310.

The rules and pattern mapping engine 314 obtains user specific list of Activities and Purposes, and the application and offline mapping rules from the server side organization settings and rules engine 416.

A pseudo-code depicting the functionality of the time analyser 308, in accordance with an embodiment of the present disclosure, is now described.
time analyser 308 receives the consolidated and sequential log from the logger;
time analyser 308 maintains its previous time tracked row pointer, and obtains the current time tracked row pointer of the time tracker;
time analyser 308 picks up all the new rows in the log between the two pointers and moves them to the CS agent effort map that it maintains for analysis;
time analyser 308 updates the previous and most recent CS agent effort map row pointers as per the row it just copied;
time analyser 308 processes the new rows in the rows of the CS agent effort map as follows:
   if the application in the new row is a browser, then if a website link matches a web application name as per a table received from the server, then the application name is changed from that of the browser name to the web application name;
   for each row, the Activity and Purpose is filled in using a mapping rule for the application;
   if no mapping rule is available for the application in an online row, then the Purpose and Activity are both marked as private; and
   if no mapping is available for an offline row, then the Activity is marked as unaccounted and Purpose is blank;
   calls a user Work Pattern analyser 332;
done.

Table 3 summarizes an example of the CS agent effort map on the CS by combining the log from Table 1 and the data picked up by local calendaring applications on the PD of the user as noted in Table 2.

TABLE 3

| time | | | | | work | | |
|---|---|---|---|---|---|---|---|
| range | application | artifact | Activity | Purpose | unit | offline | id |
| 12:00 am to | | | Unaccounted | | | Y | |
| 7:30 am | | | | | | | |
| 7:30 am to | Google | Call | Meeting | Private | | Y | PC1 |
| 7:40 am | Calendar | parents | | | | | |
| 7:40 am to | | | Unaccounted | | | Y | |
| 9:00 am | | | | | | | |
| 9:00 am to | Excel | UserFile1.xls | Documentation | Project 1 | Task | | PC1 |
| 9:10 am | | | | | 1A | | |
| 9:10 am to | Internet | cnn.com | Browsing | Private 1 | | | PC1 |
| 9:20 am | Explorer | | | | | | |
| 9:20 am to | Internet | microsoft.com | Browsing | Project 1 | Task | | PC1 |
| 9:30 am | Explorer | | | | 1A | | |
| 9:30 am to | Excel | UserFile2.xls | Documentation | Project 1 | Task | | PC1 |
| 9:40 am | | | | | 1A | | |
| 9:40 am to | | | Unaccounted | | | Y | |
| 9:50 am | | | | | | | |
| 9:50 am to | | | Unaccounted | | | Y | |
| 10:00 am | | | | | | | |
| 10:00 am to | Outlook | Support | Meeting | Project 1 | Task | Y | PC1 |
| 10:10 am | Calendar | Visit | | | 1B | | |
| 10:10 am to | Outlook | Support | Meeting | Project 1 | Task | Y | PC1 |
| 10:20 am | Calendar | Visit | | | 1B | | |
| 10:20 am to | Outlook | Support | Meeting | Project 1 | Task | Y | PC1 |
| 10:30 am | Calendar | Visit | | | 1B | | |
| 10:30 am to | | | Unaccounted | | | Y | |
| 10:40 am | | | | | | | |
| 10:40 am to | Visual | Proj2.prj | Coding | Project 2 | Task | | PC1 |
| 10:50 am | Studio | | | | 2P | | |
| 10:50 am to | QTP | TestScrpt5 | Testing | Project 2 | Task | | PC1 |
| 11:00 am | | | | | 2P | | |
| 11:00 am to | Word | Design1.doc | Documentation | Project 1 | Task | | PC1 |
| 11:10 am | | | | | 1A | | |
| 11:10 am to | Word | Design1.doc | Documentation | Project 1 | Task | | PC1 |
| 11:20 am | | | | | 1A | | |
| 11:20 am to | Outlook | Team | Meeting | Project 1 | Task | Y | PC1 |
| 11:30 am | Calendar | Review | | | 1A | | |
| 11:30 am to | Word | Design1.doc | Documentation | Project 1 | Task | | PC1 |
| 11:40 am | | | | | 1A | | |
| 11:40 am to | | | Unaccounted | | | Y | |
| 12:00 pm | | | | | | | |
| 12:00 pm to | Word | Design1.doc | Documentation | Project 1 | Task | | PC1 |
| 12:10 pm | | | | | 1A | | |
| 12:10 pm to | | | Unaccounted | | | Y | |
| 12:20 pm | | | | | | | |
| 12:20 pm to | | | Unaccounted | | | Y | |
| 12:30 pm | | | | | | | |
| 12:30 pm to | | | Unaccounted | | | Y | |
| 12:40 pm | | | | | | | |
| 12:40 pm to | | | Unaccounted | | | Y | |
| 12:50 pm | | | | | | | |
| 12:50 pm to | Word | Design1.doc | Documentation | Project 1 | Task | | PC1 |
| 1:00 pm | | | | | 1A | | |

It can be inferred from Table 3 that:
business applications like Excel and Visual Studio are automatically mapped to the appropriate Activity, Purpose and work unit, since both are work related applications as identified either by organization rules or set by the user;
time spent on the website microsoft.com is marked to ‘Browsing’ for the user's current Purpose (Project 1) since it is a work related site as identified either by an organization rule or one set by the user;
time away from the CS agent is shown as ‘Unaccounted’;
first meeting at 7:30 am is from Google Calendar which is marked as a Private meeting. Since the user was offline from 7:40 am onwards, the time slot from 7:40 am onwards is assumed to have been used for the scheduled meeting; and
during the 11:00 am to 11:20 am time slot, the user was active on the CS agent though there was an offline meeting scheduled from 11:00 to 11:30 am in the calendar. The first two slots continue to be marked to the online activity of the user on the CS agent, since it is definite that the user was online. The scheduled meeting is only intent to attend. The user may have continued to work on the CS agent since the meeting started late, or may have used the CS agent during the meeting to discuss certain material from the Word document. However, the 11:20 am to 11:30 am time slot in which the user was offline is marked to the calendar meeting.

In today's 24×7 work environment, there can be several variations from a single user and single CS theme. For example, a single user may work on different CS concurrently (home and work PCs, smartphones, tablets), multiple users may share the same CS, and several users may share a server possibly with a common login ID. The system envisaged by the present disclosure supports multi-user and multi-CS modes of operation. CS agents log each user's data on shared systems, provided each user logs in to the CS with one or more valid IDs in the user's record on the server. The typical IDs are the employee's sign-on ID (one or more, such as for the workgroup, company's network domain, and customer's network domain), employee identification number, phone extension, mobile number, email ID, and so on. If multiple users log into a shared CS using a common ID, the CS agent prompts for proper identification of the new user for correct allocation of the user's time utilization.

Each user therefore may have more than one effort map corresponding to the different CS and offline PD effort data. The CS effort map is uploaded to the server 400 by the CS effort map unit 312 using the server interface 326. At the server, the server effort map unit 408 prepares a final user effort map for each user by merging all CS effort maps having the user's time data. The merging also includes the offline PD effort map relating to calls, visits to specific office areas such as labs, work related travel and meetings, and so on, as obtained from various PDs and PD servers. The engagements, meeting requests, appointments, and call and location records of the user are compared with the occurrence and duration of the offline time, whereupon the detected duration of the offline time is correctly updated. The final user effort map is downloaded back to the CS agent 300. Thus, an accurate and comprehensive view of the user's online and offline effort is obtained at each CS and stored into the effort map exchange database 318.

It is only by way of example and illustration that the above description mentions that each user's offline time is determined based on calendaring information on the CS and presence information from PDs and PD servers connected to the server. In some embodiments, the calendaring information for some or all users may be obtained at the server by connecting to the organization's calendar servers. Similarly, in embodiments, a CS such as smartphone and tablet may itself have or obtain data about user time on calls, travel and remote meetings.

A pseudo-code, on CS agent side, for providing synchronization (sync) between the server and the CS agent, in accordance with an embodiment of the present disclosure, is now described.
CS agent 300 communicates with the server for getting initial and updated settings and to exchange effort maps. CS agent 300 prepares its own effort map based on user's interaction with the CS agent 300, uploads the same to the server, and receives back a merged user effort map for viewing on the CS agent 300;
after installation, CS agent 300 initiates a first sync with the server through the server interface:
   the server 400 sends mandatory list consisting of user Purposes, Activities, rules that map Application names to default Activity and Purpose, privacy filter settings, user name and ID, processing rates (CS agent user time sampling, time track, refresh, CS agent and server sync), maximum days data stored by CS agent 300, wellness prompt durations;
   the server 400 also sends optional list such as web URL to web application name table, user attributes (example role, skills, per day salary), work week related data (weekend days, expected work hours per day, list of holidays, list of core Activities, vacation threshold, variable work week flag);
   if work unit tracking is enabled for a Purpose, then a list of Purpose planned start and end dates, and/or units with planned start and end dates (these are usually termed as tasks), or goal for number of work units per day (these are referred to as tickets or transactions to be fulfilled by the user each day), possibly grouped into categories, and optionally weights that represent relative complexity of each work unit or category;
   the server interface forwards this to the rules and pattern mapping engine 314 for copying into the rules and pattern database 316;
   if the CS agent 300 is not set up for ‘self-improvement’ mode and user has not opted for ‘voluntary sharing’, then
      the server 400 sends the user effort map that may be available with it in case it has such information for the user from other CS agent and PD effort maps;
      the server 400 interface copies the user effort map into an effort map exchange database 318;
   for each CS agent and server sync (subsequent syncs are at the rate specified by the server)
      the CS effort map unit 312 sends a sync request to the server through the server interface;
      the server downloads any new user Purposes, Activities, mapping rules, configuration settings, user attributes related to the user and CS to the CS agent 300 via the server interface;
      the rules and pattern mapping engine 314 merges the new mapping rules into the existing table consisting of the server side rules and user defined rules for mapping application names and PD types to Activity and Purpose for the user as follows:
         new rule for an unmapped application is added to the mapping tables;
         new rule marked as mandatory by the server will override an existing user rule for that application, and also cannot be modified by the user through a CS agent user interface;
         new rule not marked as mandatory will be ignored if there is an existing user rule;
      the CS agent 300 updates internal configuration based on new settings and attributes;
      CS effort map unit 312 retrieves the new rows and any rows changed due to user inputs since the previous sync with the server from the CS effort map database 310;
      if any user data sharing has been enabled, initiate upload to the server 400
         via the server interface, the above rows of the CS effort map are uploaded to the server 400;
         if the user is associated with any other CS agents and PDs, then the CS effort map unit 312 receives from the server via the server interface, any new rows in the consolidated user effort map up to the previous sync with this CS agent 300, and puts them into the effort map exchange database 318;
         CS effort map unit 312 copies these new user effort map rows into the rows corresponding to the same time range in the CS effort map database 310;
         if primary CS and the user Work Pattern analyser 332 function is enabled, then
         (if the user has multiple CS agents, one of them will be noted as a primary CS agent. This is typically of type PC and the one where the user spends the most time. The user Work Pattern analysis can be done either on the primary CS agent, or on the server. If enabled on the primary CS agent, then it must upload the user Work Pattern database to the server for further team level analysis)
         the user Work Pattern analyser 332 uploads the updates to the user Work Pattern database 336 to the server 400 via the server interface (this is required only once a day after the previous day's analysis is completed and for any previous unsent days);
         else, the user Work Pattern analyser 332 gets the analysed updates downloaded from the server 400 into the user Work Pattern database 336 for display to the user (the analysed data may be restricted to what is appropriate for the CS type, for example, on smartphones, only call, mobile app and travel data and trends are relevant);
done.

A pseudo-code depicting server side processing during the synchronization (sync) with the CS agent 300, in accordance with an embodiment of the present disclosure, is now described.
on receiving CS agent sync request,
   the server effort map unit checks the user ID, accesses the user effort map, which is a merged view of all the CS agent and the server PD effort maps for that user,
   retrieves and sends the rows up to the previous sync with the CS agent;
   (note that CS agent sends all its new rows to the server since the last sync with the server, while server returns only with the merged rows till the previous sync. This is to avoid the CS agent having to wait till the server complete the merging for the new rows that it just uploaded. CS agent now has an up to date user effort map up to the time of the previous sync, and its own new rows. The CS agent continues to track user activity on the CS and add new rows to the CS effort map).

A pseudo-code depicting the server side merging of multiple CS agent effort maps and PD effort maps to generate a final user effort map, in accordance with an embodiment of the present disclosure, is now described.
server 400 keeps receiving CS agent effort maps and PD effort maps for all the users on a regular basis;
for each CS agent, at the CS agent and server sync rate,
   the server effort map unit obtains the latest rows and any earlier updated rows (in case of user updated rows on that CS agent) since the previous sync from the requesting CS agent using its CS agent interface;
   server 400 copies these rows into its copy of CS agent effort map in a server effort map database and updates the previous end row (in case any earlier updated rows were sent again) and current end row pointers;
   if there is no new data, there is no change in previous and current end row pointers;
for each PD, at the PD sample rate (this is typically at every 4 hours)
   server effort map unit uses the PD interface to obtain the latest information for the user's offline time;
   server checks for any new offline information since the last sync and updates its copy of PD effort map for the user in the server effort map database, and updates the current end row pointer;
   if there is no new data, there is no change in current end row pointer;
once a day for each user at a time (typically at end of day in server time zone)
   server first checks the primary CS agent effort map (primary CS agent is typically of the type PC, if user has multiple PCs then where user spends most of the time is the primary CS agent);
   if there is no new data (previous and current end row pointers are same), then it exits for that user;
   if there is new data (current end row pointer>previous end row pointer), then it copies the data from the row after the previous end pointer until the current end pointer into the user effort map for current user in the server effort map database and updates the previous end row pointer to be the same as the current end row pointer;
   if the user has no other CS agent, then move to next step of checking for the user PD data, else for each other CS agent effort map copy in the server effort map database, in order of priority set by the server according to the functional capability of the CS agent;
      if there no new data (previous and current end row pointers are same), then it exits to next CS agent;
      if there is new data, then for each row after the previous end row pointer till the current end row pointer, then
         it verifies if the corresponding row in the user effort map is marked as offline;
         if no, it moves to the next row;
         if yes, it copies the new row into to the corresponding row in the user effort map and resets the offline tag for that row;
      after processing all rows between previous and current end pointers, it updates the previous end row pointer to be the same as the current end row pointer;
   if the user is not associated with any PD, server side, then exit, else, for each PD effort map for the user in the server effort map database, in order of priority set by the server according to the functional capability of the PD:
      if there no new data (previous and current end row pointers are same), then it exits to next PD;
      if there is new data, then for each row after the previous end row pointer till the current end row pointer:
         verifies if the corresponding row in the user effort map has its Activity column marked as ‘Unaccounted’;
         if no, it moves to the next row;
         if yes, it copies the new row into to the corresponding row in the user effort map, resets the offline tag for that row;
      after processing all rows between previous and current end pointers, it updates the previous end row pointer to be the same as the current end row pointer;
done.

Extending the example of the user whose CS agent effort map for the PC was disclosed in Table 3, consider that the user also has a second CS agent on a smartphone.

Table 4 summarizes an example of an effort map (from morning till 1 pm) indicating user time on smartphone applications. The smartphone also has PD functionality with ability to detect calls made and locations.

TABLE 4

| time range | application | artifact | Activity | Purpose | offline | ID | location |
|---|---|---|---|---|---|---|---|
| 12:00 am to | | | Unaccounted | | Y | | Home |
| 7:30 am | | | | | | | |
| 7:30 am to | Call | My Mom | Call | Private | Y | SP1 | Home |
| 7:40 am | Detector | | | | | | |
| 7:40 am to | Call | My Mom | Call | Private | Y | SP1 | Home |
| 7:50 am | Detector | | | | | | |
| 7:50 am to | Call | Fred | Call | Private | Y | SP1 | Home |
| 8:00 am | Detector | | | | | | |
| 8:00 am to | Phone email | | Communication | Project 1 | | SP1 | Home |
| 8:10 am | | | | | | | |
| 8:10 am to | | | Unaccounted | | Y | | Home |
| 8:20 am | | | | | | | |
| 8:20 am to | Travel | Home | Travel | Private | Y | SP1 | X1-Y1 |
| 8:30 am | Detector | | | | | | |
| 8:30 am to | Travel | | Travel | Private | Y | SP1 | X2-Y2 |
| 8:40 am | Detector | | | | | | |
| 8:40 am to | Travel | | Travel | Private | Y | SP1 | X3-Y3 |
| 8:50 am | Detector | | | | | | |
| 8:50 am to | Travel | Office 1 | Travel | Private | Y | SP1 | Office 1 |
| 9:00 am | Detector | | | | | | |
| 9:00 am to | | | Unaccounted | Project 1 | Y | SP1 | Office 1 |
| 9:10 am | | | | | | | |
| 9:10 am to | Whatsapp | | Communication | Project 1 | | SP1 | Office 1 |
| 9:20 am | | | | | | | |
| 9:20 am to | | | Unaccounted | | Y | | Office 1 |
| 9:30 am | | | | | | | |
| 9:30 am to | | | Unaccounted | | Y | | Office 1 |
| 9:40 am | | | | | | | |
| 9:40 am to | Travel | Locn L | Travel | Project 1 | Y | SP1 | X4-Y4 |
| 9:50 am | Detector | | | | | | |
| 9:50 am to | Call | Arnold | Call | Project 1 | Y | SP1 | Locn L |
| 10:00 am | Detector | IBM | | | | | |
| 10:00 am to | | | Unaccounted | | Y | | Locn L |
| 10:10 am | | | | | | | |
| 10:10 am to | | | Unaccounted | | Y | | Locn L |
| 10:20 am | | | | | | | |
| 10:20 am to | Skype | Contact C | Communication | Project 1 | | SP1 | Locn L |
| 10:30 am | | | | | | | |
| 10:30 am to | Travel | Office 1 | Travel | Project 2 | Y | SP1 | X5-Y5 |
| 10:40 am | Detector | | | | | | |
| 10:40 am to | Call | My | Call | Private | Y | SP1 | Office 1 |
| 10:50 am | Detector | Home | | | | | |
| 10:50 am to | | | Unaccounted | | Y | | Office 1 |
| 12:20 pm | | | | | | | |
| 12:10 pm to | | | Unaccounted | | Y | | Office 1 |
| 12:20 pm | | | | | | | |
| 12:20 pm to | Travel | | Travel | Private | Y | SP1 | X6-Y6 |
| 12:30 pm | Detector | | | | | | |
| 12:30 pm to | Travel | | Travel | Private | Y | SP1 | X7-Y7 |
| 12:40 pm | Detector | | | | | | |
| 12:40 pm to | Travel | | Travel | Private | Y | | Office 1 |
| 12:50 pm | Detector | | | | | | |
| 12:50 pm to | | | Unaccounted | | Y | | Office 1 |
| 1:00 pm | | | | | | | |

It can be inferred from the above table that:
the smartphone CS agent detects online activity on the smartphone applications;
business applications like Email and Skype are marked to Project1 (work);
the call detector of the PD identifies start and end time of the calls along with caller details and confirms as a business or a personal contact;
calls are considered as offline;
calls are tagged to the current work related Purpose (Project 1 and Project 2) if the contact is identified as a business contact, otherwise, it defaults to Private (like the call to My Mom, Fred, and My Home);
the smartphone detects the office or home location based on GPS and the pattern of presence at the location. If the user regularly spends large number of hours at the same location during weekdays, then a presumption is made that the user is at an office location (e.g. Office 1 above). This is verified at the server if a significant number of users of the organization are at the same location over many days. This is validated at regular intervals. A user's Home too is presumed by long non-work hours at the same location over several days and can be verified by asking the user;
when the user is at other fixed locations, the location is identified by its coordinates (latitude, longitude) (X, Y), the user can tag it for future reference (e.g. Locn L);
when the smartphone is not being used and the user is not traveling, the location is identified, but the time is tagged as offline and Activity is marked to Unaccounted and Purpose is blank;
a travel detector function on the smartphone detects travel time and distance between two points. A minimum stay of 20 minutes is required to consider as end of travel between the two end locations (to avoid mistaking traffic and other short halts as an end location). In the above example, travel from home to office 1, and later to Locn L and back to office 1 are detected because of minimum stay at both end points.
travel is considered as an offline activity;
when the user reaches the end destination as determined by the minimum stay time, it (and the previous travel time) is tagged to a work related Purpose or as ‘Private’;
travel is assumed to be work related if the start and end destinations are different office locations or tagged as work start or end points;
commute from home to office 1 in the morning and later travel for lunch is marked as Private since they don't meet the criteria for start and end points; and
travel out for lunch from 12:20 pm to 12:50 pm is not marked to any end point, since the stay at the restaurant was not for the minimum time.

Table 5 summarizes an example of the final user effort map automatically generated by merging the online and offline effort maps from two CS agents (note:—Table 3 with PC as the first CS agent and Table 4 with smartphone as the second CS agent) for the period from morning till 1 pm.

TABLE 5

| | | | | | work | | | |
|---|---|---|---|---|---|---|---|---|
| time range | application | artifact | Activity | Purpose | unit | offline | ID | Locn |
| 12:00 am to | | | Unaccounted | | | Y | | Home |
| 7:30 am | | | | | | | | |
| 7:30 am to | Call | My Mom | Call | Private | | Y | SP1 | Home |
| 7:40 am | Detector | | | | | | | |
| 7:40 am to | Call | My Mom | Call | Private | | Y | SP1 | Home |
| 7:50 am | Detector | | | | | | | |
| 7:50 am to | Call | Fred | Call | Private | | Y | SP1 | Home |
| 8:00 am | Detector | | | | | | | |
| 8:00 am to | Phone | | Communication | Project 1 | General | | SP1 | Home |
| 8:10 am | email | | | | | | | |
| 8:10 am to | | | Unaccounted | | | Y | | Home |
| 8:20 am | | | | | | | | |
| 8:20 am to | Travel | Home | Travel | Private | | Y | SP1 | X1-Y1 |
| 8:30 am | Detector | | | | | | | |
| 8:30 am to | Travel | | Travel | Private | | Y | SP1 | X2-Y2 |
| 8:40 am | Detector | | | | | | | |
| 8:40 am to | Travel | | Travel | Private | | Y | SP1 | X3-Y3 |
| 8:50 am | Detector | | | | | | | |
| 8:50 am to | Travel | Office 1 | Travel | Private | | Y | SP1 | Office 1 |
| 9:00 am | Detector | | | | | | | |
| 9:00 am to | Excel | UserFile1.xls | Documentation | Project 1 | Task 1A | | PC1 | Office 1 |
| 9:10 am | | | | | | | | |
| 9:10 am to | Internet | cnn.com | Browsing | Private | | | PC1 | Office 1 |
| 9:20 am | Explorer | | | | | | | |
| 9:20 am to | Internet | microsoft.com | Browsing | Project 1 | Task 1A | | PC1 | Office 1 |
| 9:30 am | Explorer | | | | | | | |
| 9:30 am to | Excel | UserFile2.xls | Documentation | Project 1 | Task 1A | | PC1 | Office 1 |
| 9:40 am | | | | | | | | |
| 9:40 am to | Travel | Locn L | Travel | Project 1 | Task 1B | Y | SP1 | X5-Y5 |
| 9:50 am | Detector | | | | | | | |
| 9:50 am to | Call | Arnold - | Call | Project 1 | Task 1B | Y | SP1 | Locn L |
| 10:00 am | Detector | IBM | | | | | | |
| 10:00 am to | Outlook | Support | Meeting | Project 1 | Task 1B | Y | PC1 | Locn L |
| 10:10 am | Calendar | Visit | | | | | | |
| 10:10 am to | Outlook | Support | Meeting | Project 1 | Task 1B | Y | PC1 | Locn L |
| 10:20 am | Calendar | Visit | | | | | | |
| 10:20 am to | Skype | Contact C | Communication | Project 1 | Task 1B | | SP1 | Locn L |
| 10:30 am | | | | | | | | |
| 10:30 am to | Travel | Office 1 | Travel | Project 2 | Task 1B | Y | SP1 | X6-Y6 |
| 10:40 am | Detector | | | | | | | |
| 10:40 am to | Visual | Proj2.prj | Coding | Project 2 | Task 2P | | PC1 | Office 1 |
| 10:50 am | Studio | | | | | | | |
| 10:50 am to | QTP | TestScrpt5 | Testing | Project 2 | Task 2P | | PC1 | Office 1 |
| 11:00 am | | | | | | | | |
| 11:00 am to | Word | Design1.doc | Documentation | Project 1 | Task 1A | | PC1 | Office 1 |
| 11:10 am | | | | | | | | |
| 11:10 am to | Word | Design1.doc | Documentation | Project 1 | Task 1A | | PC1 | Office 1 |
| 11:20 am | | | | | | | | |
| 11:20 am to | Outlook | Team | Meeting | Project 1 | Task 1A | Y | PC1 | Office 1 |
| 11:30 am | Calendar | Review | | | | | | |
| 11:30 am to | Word | Design1.doc | Documentation | Project 1 | Task 1A | | PC1 | Office 1 |
| 11:40 am | | | | | | | | |
| 11:40 am to | | | Unaccounted | | | Y | | |
| 12:00 pm | | | | | | | | |
| 12:00 pm to | Word | Design1.doc | Documentation | Project 1 | Task 1A | | PC1 | Office 1 |
| 12:10 pm | | | | | | | | |
| 12:10 pm to | | | Unaccounted | | | Y | | |
| 12:20 pm | | | | | | | | |
| 12:20 pm to | Travel | | Travel | Private | | Y | SP1 | X6-Y6 |
| 12:30 pm | Detector | | | | | | | |
| 12:30 pm to | Travel | | Travel | Private | | Y | SP1 | X7-Y7 |
| 12:40 pm | Detector | | | | | | | |
| 12:40 pm to | Travel | | Travel | Private | | Y | SP1 | Office 1 |
| 12:50 pm | Detector | | | | | | | |
| 12:50 pm to | Word | Design1.doc | Documentation | Project 1 | Task 1A | | PC1 | Office 1 |
| 1:00 pm | | | | | | | | |

It can be inferred from the above table that:
at the server, the CS agent effort map and smartphone effort map for the user are merged to generate a final user effort map;
the morning meeting at 7:30 am for 10 minutes marked as ‘Call Mom’ is replaced by the actual call details from the smartphone showing 20 minutes for that call. Yet another personal call to Fred was made, followed by email on the smartphone, and commute to the office. The activity “travel” for lunch, which is detected by the smartphone, is also added into the merged map and shown as Private time;
on the PC, the user time from 9:40 to 9:50 am was unaccounted but the smartphone detected travel to location L. Hence, original unaccounted row is replaced by this new input. Similar travel activity was detected at 10:30 to 10:40 am when the user returned back to the office 1. The meeting at 10:00 am took place at a different location, which is why there is travel time before and after the meeting as detected by the smartphone;
on the PC, the user time from 10:00 to 10:30 am was assigned to a scheduled meeting marked in a local calendar. However, from 10:20 to 10:30 am, the smartphone was used for a skype call. Since this online activity is more definitive by way of user's interaction with a CS agent than a meeting which is presumed to have taken place, the smartphone input replaced the original row;
while merging, the call to home made at 10:40 am was ignored in favour of the user activity on the visual studio application on the PC, to give priority to work related activity;
the overlap mapping priorities as noted above can be different based on the business preference.

A user Work Pattern analyser 332 cooperates with the rules and pattern mapping engine 314, the time analyser 308, the CS effort map database 310, the server interface 326, and a user Work Pattern database 336. The user Work Pattern analyser 332 receives the final user effort map. The user Work Pattern analyser 332 computes a plurality of Work Pattern items. The user Work Pattern analyser 332 generates wellness prompts on the local user interface for the user. The user Work Pattern analyser 332 automatically tags each day, in the final user effort map, as a workday, weekend day, a public holiday or a vacation. The user Work Pattern analyser 332 automatically detects the user's location as home, office and other. The user Work Pattern analyser 332 automatically tags each day, in the final user effort map, as a work from office day, a work from home day or a work from other location day.

The plurality of Work Pattern items are selected from the group comprising a work time, an online work time, an offline work time, a time spent on each Purpose, Activity, application and work unit for the user, a core activity time, a collaboration work time, work habits, a total travel time, a fitness time, a PD usage time, a smartphone addiction, a physical time in a workplace, a private time in a workplace, a work time at home, a work effectiveness index, and a work life balance index.

The user Work Pattern analyser 332 performs the analysis of the Work Patterns of the user on daily, weekly and monthly basis. The analysis on daily basis is described first.

A pseudo-code for identifying whether the user's previous day is still in progress for the analysis of the Work Patterns, in accordance with an embodiment of the present disclosure, is now described.
user Work Pattern analyser 332 does an analysis of the user's time utilization since the start of the day up to the present time based on the final user effort map;
each day's Work Pattern is stored in a daily table in the user Work Pattern database 336;
each user's Work Pattern for each day is stored in one row of the daily table in the user Work Pattern database 336;
   daily table rows are created for the user from the date user is created and until the user is deleted;
   daily table row consists of the date, user ID, and fields for each Work Pattern item;
computation of the sample Work Pattern items to be stored in the daily table of the user Work Pattern database 336 is shown below:
   the user Work Pattern analyser 332 analyses all the rows in the CS agent effort map until the most recent row pointer to determine the user's Work Patterns;
      assess the user's Work Pattern towards midnight to infer whether the user's work day spans two calendar days. This can happen if the use has a midnight shift or is having a long day and is working past midnight;
         if the day being analysed has yesterday's date, then
         if user shows online Activity at 12:00 am and for few rows before or after (user is still busy across midnight in a shift or as extended work, so advance the day only when work stops);
         if unaccounted time (no online or offline Activity) is detected for at least 4 hours after 12:00 am, then
         mark day end (for yesterday)=last online or offline Activity after 12:00 am;
         change day being analysed to today's date;
         set start time for analysing today's Work Pattern as the end of the four hour ‘Unaccounted’ time period;
         else
         proceed to next step for analysis of the continuing previous day's Work Pattern;
         else
         mark day end (for yesterday)=last online or offline Activity before 11:59 pm;
         change day being analysed to today's date;
         set start time for analysing today's Work Patterns as 12:00 am;

A pseudo-code for identifying the start time and end time (until now) for the day's Work Pattern analysis, in accordance with an embodiment of the present disclosure, is now described.
online=offline flag is false;
online work=offline flag is false and Purpose is not Private;
offline work=offline flag is true and Purpose is not Private;
day start time=time of the first online or offline work activity from start time for analysing today's Work Patterns;
day end time (so far)=time of the last online or offline work activity until most recent CS agent effort map row pointer is reached;

A pseudo-code for analysing the plurality of Work Pattern items (between day start time and until now), in accordance with an embodiment of the present disclosure, is now described.
I. A pseudo-code for analysing the work time, the online work time, the offline work time, the core Activity time and the collaboration work time, in accordance with an embodiment of the present disclosure, is now described.

work time=(count of rows with online or offline time marked to Purpose other than Private)*(CS agent user sampling rate);

online work time=(count of rows with online time marked to Purpose other than Private)*(CS agent user sampling rate);

offline work time=(count of rows with offline time marked to Purpose other than Private)*(CS agent user sampling rate);

core Activity time=(count of rows with online or offline time marked to Purpose other than Private for each Activity that belongs to a core Activity table for the user)*(CS agent user sampling rate);

collaboration work time=(count of rows marked to Purpose other than Private and with online time on communication or offline time on meeting and call);
II. A pseudo code for wellness prompts if the user is online for too long or has worked too many hours, in accordance with an embodiment of the present disclosure, is now described.
   if online work time>90 minutes, then suggest the user to take a short break via the local user interface 322;
   if work time>10 hours, then suggest the user to wind up soon and come back refreshed the next day;
III. A pseudo code for analysis of time spent on each Purpose, Activity, application and work unit, in accordance with an embodiment of the present disclosure, is now described.

work time on each Purpose=(count of rows with online or offline time for each Purpose)*(CS agent user sampling rate);

for each Purpose, work time on each Purpose=(count of rows with online or offline time for each Purpose)*(CS agent user sampling rate);
if work unit tracking is enabled (work output related parameters if work unit tracking is enabled), then for each work unit in the Purpose,

work unit time=(count of rows with online or offline time for that work unit)*(CS agent user sampling rate);
work unit completion status is tracked based on the user inputs or as sourced by the server from external applications tracking the user's output.

work units done=(count of all work units with completion status as done);
work units may be associated with a weight to represent the relative complexity. If no weights are given, all work units are assumed to have a weight of one;
   if work unit weight is not available for a work unit, then
   work unit weight=1;
   output.volume=(Σ(work unit weight) over all work units confirmed by the user as completed);
work units may have a start date, an end date and estimated effort associated with them;
the schedule variance between planned and actual completion date, and effort variance between and actual effort for all completed work units is a useful index of the user's output performance. While computing this, the relative weight of each work unit must be considered;

output.schedule variance=VAR[(today's date−planned end date of work unit)*(work unit weight)/(output.volume)over all work units confirmed by user as completed];

output.effort variance=VAR[(work unit time−planned time)*(work unit weight)/(output.volume)over all work units confirmed by user as completed];
for each Activity, work time on each Activity=(count of rows with online or offline time for that Activity)*(CS agent user sampling rate);
For each application, work time on each application=(count of rows with online or offline time for that application)*(CS agent user sampling rate);
IV. Besides time on work, it is important to analyse the user's work habits. The work habits of the user on daily, weekly and monthly basis are used to build a work effectiveness index and a work life balance index. The work effectiveness index is primarily derived from the user's ability to stay focused on core activities while at work. The work life balance is measured based on a total work time, a commute time, a time at home, and a work done at home. A pseudo-code depicting work habits analysis on each day for the user, in accordance with an embodiment of the present disclosure, is now described.
   breaks taken=(count of times the user switched from online to offline and offline to online);
   switches to email/chat=(count of times the user switched to the communication activity);
   core activity time span list with each entry consisting of,
      (count of consecutive rows with online time on Purpose other than private and activity belonging to core activity)*(CS agent user sampling rate);
   focus time=(core activity time span) for all entries in the list;
   For each hour during the day, if the focus time exceeds 40 minutes, then increment golden hour count;
   For all the taken breaks, count the offline Activities that caused the breaks and list the count in a table of reason for breaks taken;
   Following each focus time stretch, count the non-core Activity that caused end of the focus time and list them in a table of reason for loss of focus;
V. A pseudo-code depicting work habits derived from the PD effort map on each day for the user, in accordance with an embodiment of the present disclosure, is now described (per CS agent analysis to uncover any CS specific behaviour of interest, such as checking of smartphones, calls made from home versus office, commute time between home and office, total travel time)

smartphone usage time=(count of rows with online time on any Activity or offline time on call activity)*(CS agent user sampling rate);

unlocks=(count of rows with online time for maximum four consecutive rows followed by a row with Activity marked to unaccounted);

call time from home=(count of rows with offline time detected on calls while location is home)*(CS agent user sampling rate);

call time from office=(count of rows with offline time detected on calls while location is office)*(CS agent user sampling rate);

commute time=(count of rows with offline time detected as travel Activity and the start location is office or home and end location is either home or office respectively)*(CS agent user sampling rate);

travel time=(count of rows with offline time detected as travel activity and the start destination is office or home and end destination is either home or office respectively)*(CS agent user sampling rate);

fitness time=(count of rows with application marked as fitness tracker)*(CS agent user sampling rate);
VI. A pseudo-code depicting the detection of a physical time in office, a work time in office, a private time in office and a work time at home, in accordance with an embodiment of the present disclosure, is now described.

physical time in office=(count of rows with the location marked as office)*(CS agent user sampling rate);

work time in office=(count of rows with the location marked as office, and Purpose other than Private)*(CS agent user sampling rate);

private time in office=(count of rows with the location marked as office, and Purpose as Private)*(CS agent user sampling rate);

work time at home=(count of rows with the location marked as home, and Purpose other than Private)*(CS agent user sampling rate);

Table 6 summarizes the Work Patterns detected by the user Work Pattern analyser 332 for current day until 1 pm based on the final user effort map as disclosed in Table 5.

TABLE 6
work summary till 1 PM

| work time | 180 minutes of which, | |
|---|---|---|
| | online work time | 120 minutes |
| | offline work time | 60 minutes |

Purpose breakup

| | |
|---|---|
| Project 1 time | 150 minutes |
| Project 2 time | 30 minutes |
| Private | 110 minutes |

Time on core activity and collaboration

core Activity time (Coding + Testing + Documentation) (as per organization settings) [symbol]
90 out of 180 minutes (50%)
collaboration work time (Communication + Meeting + Call) [symbol]
60 out of 180 minutes (33%)
Activity breakup for work (180 minutes total)

| | |
|---|---|
| documentation | 70 minutes |
| browsing | 10 minutes |
| travel | 20 minutes |
| call | 10 minutes |
| meeting | 30 minutes |
| communication | 20 minutes |
| coding | 10 minutes |
| testing | 10 minutes |

Activity breakup for Private (110 minutes total)

| | |
|---|---|
| Browsing | 10 minutes |
| Travel | 70 minutes |
| Call | 30 minutes |

Application breakup for work (180 minutes total)

| | |
|---|---|
| Excel | 20 minutes |
| Word | 50 minutes |
| Internet Explorer | 10 minutes |
| Travel Detector | 20 minutes |
| Call Detector | 10 minutes |
| Outlook Calendar | 30 minutes |
| Skype | 10 minutes |
| Visual Studio | 10 minutes |
| QTP | 10 minutes |
| Phone email | 10 minutes |

artifacts (files/websites) for work

| | |
|---|---|
| UserFile1.xls | 10 minutes |
| UserFile2.xls | 10 minutes |
| Microsoft.com | 10 minutes |
| TestScript5 | 10 minutes |
| Design1.doc | 50 minutes |
| Proj2.prj | 10 minutes |

artifacts related to communication for work

| | |
|---|---|
| Android -IBM | 10 minutes |
| Contact C | 10 minutes |

Travel for work

| | |
|---|---|
| to Locn L | 10 minutes |
| To office 1 | 10 minutes |

location of work (office, home, other)

| | |
|---|---|
| office | 110 minutes |
| home | 10 minutes |
| other | 60 minutes |

work in office, home

| | |
|---|---|
| time at office | 110 minutes |
| personal work in office | 10 minutes (9%) |
| work time at home | 10 minutes (out of 180 |
| | minutes of work-6%) |
| work time at other | 60 minutes |
| work at other | 60 minutes |
| day tagged as | ‘Work from Office’ |

User work Habits

| | |
|---|---|
| breaks taken (moving from online to offline | 6 |
| work) | |
| switch to emails/chat | 1 |
| focus time (working on PC for minimum 20 | 60 minutes (20 + 40 |
| minutes without being interrupted by breaks, | minutes stretches) |
| email, browsing etc) | |
| golden hour (hour with minimum 40 minutes | 0 |
| of focus) | |
| smartphone addiction | Total usage :- 60 minutes |
| | Unlocks :- 18 |
| commute time (between home and office) | 40 minutes |

user output related

| | |
|---|---|
| Task 1A | 90 minutes |
| Task 1B | 60 minutes |
| Task 2P | 20 minutes |
| general | 10 minutes |
| work units (tasks) active today | 3 |
| work units done | 1 (assume task 1A of project |
| | was completed today) |
| For project 1, output.schedule variance | 2 days (example, task 1A |
| | delayed by 2 days past planned date) |
| For project 1, output.effort variance | 9 hours (example, task 1A |
| | took 9 hours more than planned) |
| For project 1, output.volume | 100 (example, function point |
| | units for task 1A) |

A pseudo-code depicting the tagging operation, for each day (as a workday, holiday, vacation), performed by the user Work Pattern analyser 332, in accordance with an embodiment of the present disclosure, is now described. Once the user Work Pattern analyser 332 detects that yesterday is over, then it determines whether the day was a work day, weekend day, public holiday, or vacation, and whether it was work from office or home. If the information about the user's weekend days is not available, then intelligent inferencing based on Work Patterns is used to determine the weekend days. It may be that the user may not have a fixed weekend, as for example for support staff and independent contractors, in which case a ‘variable work week’ flag is introduced. Vacations and holidays too can be inferred based on the user's Work Patterns if that information is unavailable. In another embodiment, the user Work Pattern analyser 332 may employ a fuzzy logic to determine user vacations, weekends and holidays, shift timing, work from home and office and other locations, and unaccounted time in office.
if user has defined weekend days and holidays, then the ‘variable work week’ flag is set to false, and any server input is ignored;
if user has set the ‘variable work week’ to true, then any server input is ignored;
if no user or server provided weekend and holiday data is available, then
   check if daily work time is below a vacation threshold for 1 or 2 days in a week, and verify this over next few weeks;
   if yes for the same 1 or 2 days for several weeks, then
      set those days as weekend days;
      get the user location from the location of the PD on the CS agent and get list of the public holidays at the location from the server;
      set ‘variable work week’ to false;
   else (assume the user has variable work week, which may happen for 24×7 support staff and contractors),
      set ‘variable work week’ to true;
if ‘variable work week’ is false, then in the daily table of the user Work Pattern database:
   if today corresponds to a weekend day or the date is that of a public holiday, then:
      set the holiday tag as true and vacation as false;
   else set the holiday and vacation tags as false;
   if holiday tag is false, then obtain the vacation threshold as below:
      if the user is identified as being in an office location, the vacation threshold is set to 1 hour of online and offline work (to ensure that a visit to the office for a quick discussion on a holiday is not treated as work day);
      if the user was not in the office, then the vacation threshold is set to 3 hours of online and offline work time for the day;
   Adaptive learning technique can be used to refine the vacation threshold for the user. The threshold can be raised or lowered by 0.5 hour if the current vacation threshold is resulting in the number of working days per week becoming lower or higher respectively than the server or user specified work week of 5 or 6 days;
      if the work time<vacation threshold, then set holiday and vacation flags to true;
if ‘variable work week’ is true, then the days with the highest work time that are also more than the vacation threshold, not exceeding the maximum workdays per week, are marked as workdays and the rest as holidays.

A pseudo-code to find out the user's home and workplace (office) location using an alternate method, in accordance with an embodiment of the present disclosure, is now described. The user Work Pattern analyser 332 finds out the user's home and office locations using different methods based on the capability of the CS agent. This is done in the first week of usage, and repeated thereafter if it is detected that the user's home or office has changed, as explained below:
if first week of use or if the user's begins to spend time at new locations, the CS Work Pattern analyser assesses the Work Patterns to infer the user's office and home locations as follows:
   the user Work Pattern analyser 332 confirms if the CS agent is able to provide location co-ordinates, or the name of the WIFI or network being used on the CS by the user;
   if the user's daily hours low work time and/or weekends consistently show presence at a specific location, or use of the same WIFI or the network name, then a mapping between the specific location, WIFI, or network and ‘Home’ is first presumed, and then validated over few days in the first week;
   if days identified as user's workdays consistently show presence at a specific location, or the same WIFI or network name, and if this is different from the one tagged as ‘Home’, then a mapping between the location, WIFI, or network and ‘Office’ is first presumed, and then validated over few days in the first week, and periodically thereafter;
   all other irregular locations, WIFI usages are mapped as ‘Other’ location;

The user Work Pattern analyser 332 maps each day as work from office, work from home, or work from other. A one hour presence may be sufficient to confirm that the user was at office, while a workday from home confirmation requires sufficient work effort to distinguish it from work done during a holiday or vacation.
if time in office exceeds 60 minutes, then
   set status to ‘work from office’ for that day,
else,
   if more than 50% of the work time is at home, then set status to ‘work from home;
   else set status to ‘work from other’;
done.

In accordance with an embodiment of the present disclosure, the user Work Pattern analyser 332 is configured to perform the analysis of the Work Patterns of the user for one week. The user Work Pattern analyser 332 determines the Work Pattern of the user for one week (or any other time range of interest, such as month, quarter and year). In a self-improvement mode, the analysis of the Work Patterns for the user has to be performed on the CS agent since no data is sent to the server. However, in other modes, there are two options. The first option is to perform the analysis of the Work Patterns at the CS agent. In case the user has more than one CS agents, then the analysis of the Work Patterns may be performed at a primary CS agent. The second option is to perform the analysis of the Work Patterns exclusively at the server using the user effort maps.

The Work Pattern analysis for the user on weekly basis, in accordance with an embodiment of the present disclosure, is now described. The analysed results are stored in a weekly table of the user Work Pattern database 336. Depending on the maximum days data stored on the CS agent, the Work Pattern on monthly, quarterly, annual basis can also be similarly derived and stored in tables to allow for quick retrieval and trending of longer term trends. If it is not self-improvement mode, then the server stores Work Patterns for all users in weekly, monthly, quarterly and annual tables for as long as required.
during the first CS agent and server sync,
   if the server specified maximum days data stored at CS agent exceeds a few weeks, then a weekly table is created in the user Work Pattern database (one row per week);
   if server specified maximum days data stored at CS agent exceeds a few months, then a monthly table is create in the user Work Pattern database (one row per month);

The user's weekly Work Patterns may be classified into five major groups:

I. high level user effort;

II. user effort distribution across purposes, activities, applications, and work units;

III. work habits;

IV. work-life balance index; and

V. user utilization for comparisons within an organization.

At the start of each week, for each user, the user Work Pattern analyser 332 adds a row in the weekly table in the user Work Pattern database to store the previous week's Work Patterns being computed. Each row consists of a week number, a user ID, and fields associated with each of the plurality of Work Pattern items. By using the data from the daily table for the seven days of the previous week, the user Work Pattern analyser 332 analyses the Work Patterns.

I. high level user effort:—At a high level, from a work perspective, what matters is whether the user put in reasonable efforts on the right kind of activities, and if the output was reasonable. The user may spend time on different work related Purposes. Any non-work related personal time is tagged to a Purpose called ‘Private’. Therefore, it is important to track a work time, its breakup for online and offline work and percentage of time on core activity as high level user Work Pattern items. For computing the user's daily average of work time, the work done over all the seven days is considered as being done on the working days of that week. This ensures that holiday work is given credit when computing the daily average. However, the private time is relevant at high level only for workdays.
A pseudo-code for computing workdays for the week, the daily average work time, a daily average online work time, a daily average offline work time, a daily average core activity time and a daily average collaboration work time for the user over seven days, in accordance with an embodiment of the present disclosure, is now described.

workdays for the week=(count of the days not marked to holiday over all seven days);

daily average work time=(Σ(work time) over all the seven days)/(workdays for the week);

daily average online work time=(Σ(online work time)over all the seven days)/(workdays for the week);

daily average offline work time=(Σ(offline work time)over all the seven days)/(workdays for the week);

daily average core activity time=(Σ(core activity time)over all the seven days)/(workdays for the week);

percentage of core activity time=(daily average core activity time)/(daily average work time);

daily average collaboration work time=(Σ(collaboration work time)over all the seven days)/(workdays for the week);

percentage of collaboration work time=(daily average collaboration work time)/(daily average work time);
If the work unit tracking is enabled, or if the work output is available from any external application, then it is possible to derive various aspects of the work output, such as a volume, an effort and a schedule variance. These are important performance benchmarks and correlating them with the plurality of Work Pattern items provides useful recommendations to the user. If the work unit tracking is not enabled, then the user is prompted to provide a rating for the week. A pseudo-code for calculating various aspects of the work output, in accordance with an embodiment of the present disclosure, is now described.
   if work unit tracking is enabled, then for each Purpose,

output.volume for seven days=(Σ(output.volume)per day for seven days for the Purpose);

output.schedule variance=VAR[(output.schedule variance)*(output.volume per day)/(output.volume for seven days)over all the seven days];

output.effort variance=VAR[(output.effort variance)*(output.volume per day)/(output.volume for seven days)over all seven days];
else
   prompt the user to estimate the user's own productivity in the previous week;
   output. volume=user input on a scale of 1-10 for the Purpose (as an example);

II. The user effort distribution across work purposes, activities, applications and more:—A pseudo-code for computing daily average of time on each Purpose, Activity, application and work unit, in accordance with an embodiment of the present disclosure, is now described.

for each Purpose, daily average work time on each purpose=(Σ(work time on the Purpose) over all the seven days)/(workdays for the week);
for each work unit in the Purpose:

daily average work time on each work unit=(Σ(work time on the work unit) over all the seven days)/(workdays for the week);
for each Activity:

daily average work time on each Activity=(Σ(work time on the Activity) over all the seven days)/(workdays for the week);
for each application:

daily average work time on each application=(Σ(work time on the application) over all the seven days)/(workdays for the week);

III. work habits:—For the computation of work habits, only workdays need to be taken into account, since the work on holidays is usually minimal and does not reflect habits at work. A pseudo-code for the computation of work habits, in accordance with an embodiment of the present disclosure, is now described.

daily average breaks=(Σ(breaks taken) over all the workdays/(workdays for the week);

daily average switches to email/chat=(Σ(switches to email/chat) over all the workdays)/(workdays for the week);

daily average focus Time that week=(Σ(focus time)over all the workdays)/(workdays for the week);

golden hour count that week=(Σ(golden hour count) over all the workdays);

reasons for breaks taken=list of offline Activities that caused the breaks and add up their counts for all the workdays for that week;

reasons for loss of focus=list of non-core Activities that caused the end of the focus and add up their counts for all the workdays for the week;

IV. work-life balance:—The work-life balance may be improved by analysing physical time in the office, unaccounted time in the office, private time in the office, variance in the work time from day to day, work time on weekends and outside office hours, work from home days, and fitness time. A pseudo-code for the computation of the work life balance, in accordance with an embodiment of the present disclosure, is now described.
holidays for the week=count of rows in the daily table that are marked as holiday over all the seven days;
staffed days for the week=count of rows in the daily table overall the seven days;
there will be fewer rows in the weeks for any user who may have joined or left the organization mid-week;
workdays marked as work from home=(count of rows in the daily table not marked as holiday and marked as work from home);
workdays marked as work from office=(count of rows in the daily Table not marked as holiday and marked as work from office);
check whether the user is regular in the amount of work put in each day:
   variance in daily work time=VAR (daily work time on all the workdays);
determine the extent of ‘work from home’ and if it is equally productive:—

percentage of ‘work from home’ days=(workdays marked as ‘work from home’)/(workdays for the week);

‘work from home’ effectiveness=(daily average of work time on workdays marked as ‘work from home’)/(daily average of the work time on the workdays marked as work from office);
determine if too much time is being spent in the office, or a high percentage of time is spent on the personal work while in the office, and percentage of time spent that cannot be accounted by any CS agent or PD:—

daily average physical time in the office=(Σ(physical time in the office) over all the workdays)/(workdays for the week);

percentage of private time in the office=((Σ(private time in the office) over all the workdays)*100/((Σ(private time in the office) over all the workdays)+(Σ(work time in the office) over all the workdays));

Unaccounted time in the office=(Σ(physical time in the office) over all the workdays)−(Σ(work time in the office) over all the workdays)−(Σ(private time in the office over all the workdays);

percentage of Unaccounted time in the office=((Unaccounted Time in the office)*100)/(physical time in the office);
determine the amount of work being done on the holidays and at home after a regular workday:—

percentage of work done on the holidays=((Σwork time on all the holidays)*100)/(Σwork time over all the seven days);

percentage of the work done at home on workdays marked as the work from office=((Σwork time at home on workdays marked to office)*100)/(Σwork time on the workdays marked to office);
compute a smartphone addiction on workdays:—

smartphone time on a workday=(Σ(smartphone(PD)time)over all the workdays)/(Workdays for the week);

daily unlocks on a workday=(Σ(unlocks) over all the workdays)/(workdays for the week);
compute smartphone addiction on holidays:—

smartphone time on the holiday=(Σ(smartphone time)over all the holidays)/(holidays for the week);

unlocks on the holiday=(Σ(unlocks) over all the holidays)/(holidays for the week);

daily average of call time from home on workdays=(Σ(call time from home) over all the workdays)/(workdays for the week);

daily average of the call time from home on holidays=(Σ(call time from home) over all the holidays)/(holidays for the week);

daily average of call time from office on the workdays=(Σ(Call time from the office) over all the workdays)/(workdays for the week);

daily Average of Call time from Office on Holidays=(Σ(Call time from Office) over all Holidays)/(Holidays that week);

daily average of the commute time on the workdays=(Σ(commute time)over all the workdays)/(workdays of the week);

daily average of a travel time on the workdays=(Σ(travel time)over all the workdays)/(workdays for the week);

daily average of the travel time on the holidays=(Σ(travel time)over all the holidays)/(holidays for the week);

daily average of a fitness time on workdays=(Σ(travel time)over all the workdays)/(workdays for the week);

daily average of the fitness time on the holidays=(Σ(travel time)over all the holidays)/(holidays for the week);

V. user utilization for comparisons between the users within an organization:—The computation of the user utilization includes computation of a delivered capacity, an available capacity, a staffed capacity and capacity utilization. A pseudo-code for the computation of the user utilization, in accordance with an embodiment of the present disclosure, is now described.
access the percentage of expected hours that the user contributed; This metric can be used to quickly find out users who are very busy and who can take on more work;

delivered capacity as a percentage of available capacity=(work time)over all the seven days)/(staffed workdays put in by the user*expected work hours per day);
check the impact of vacations and public holidays on available capacity; Holidays are often not planned for when setting deadlines, and can help to explain the delays in completion;

available capacity as a percentage of the staffed capacity=(workdays for the week)/(workdays for the week+holidays for the week);
done.

Table 7 lists sample data of daily work time for a team of 10 users in the week of April 8, which is then used to analyse the users' work patterns on weekly basis as disclosed later in Table 8.

TABLE 7
Table showing Work Time in hours for Team 1 with 10 users for one week

| | User | User | User | User | Use | User | User | User | User | User | Team |
|---|---|---|---|---|---|---|---|---|---|---|---|
| | 1 | 2 | 3 | 4 | 5 | 6 | 7 | 8 | 9 | 10 | 1 |
| Apr 8 | 7.8 | 0.6 | 6.2 | 6.6 | 6.2 | 0 | 8.6 | 8.6 | 6.4 | | |
| (Mon) | | | | | | | | | | | |
| Apr 9 | 8.8 | 7.7 | 6.4 | 5.9 | 8.7 | 8.3 | 8.6 | 8.4 | 0 | | |
| (Tue) | | | | | | | | | | | |
| Apr 10 | 7.7 | 7.5 | 6.3 | 5.7 | 9.7 | 8.3 | 8 | 7.8 | 5.9 | 8.5 | |
| (Wed) | | | | | | | | | | | |
| Apr 11 | 0 | 0 | 2.2 | 0.1 | 5.1 | 8.4 | 3.5 | 1.9 | 5.6 | 7.3 | |
| (Thu) | | | | | | | | | | | |
| Apr 12 | 7.9 | 7.4 | 1.3 | 5.3 | 0 | 1.2 | 0.7 | 1.3 | 0 | 0 | |
| (Fri) | | | | | | | | | | | |
| Apr 13 | 0 | 1.1 | 1.5 | 0 | 0 | 2.2 | 0.7 | 0 | 0 | 0 | |
| (Sat) | | | | | | | | | | | |
| Apr 14 | 0 | 0 | 3.3 | 0 | 6.8 | 7.5 | 4.4 | 3 | 6.2 | 7.5 | |
| (Sun) | | | | | | | | | | | |

In the above Table 7, the following assumptions may be noted:
Users 1-4 in location 1 have Saturday and Sunday as their weekly holidays, while Users 5-10 work in a country that has Fri and Sat as weekly holidays.
Users 1-4, 5-8, and 9-10 are at 3 different locations and have different public holidays. Users 1-4 in location 1 have a public holiday on Apr 11 (Thu). Users 9-10 in location 3 have Apr 9 (Tue) as a public holiday.
In an embodiment, public holidays and weekends can be inferred by analysing that a large majority of users at that location put in less work hours than the vacation threshold (2 hours in this example).
User 10 has joined the team only on Wednesday.
Vacations taken by an individual user are detected if the user has contributed less work time than the vacation threshold. Vacation threshold setting is necessary since the users may spend some time doing work even if on a holiday. Vacation threshold can have a default value and also a refined value for each user by setting it at 50% or less of the user's daily average work hours. In the example shown, users 2 and 6 took vacation on Monday, user 8 on Thursday, and user 3 on Friday.
Some users may have a variable work week, for example if their job profile requires them to work Monday-Friday for a few weeks, then switch to Tuesday-Saturday, then Wednesday-Sunday, and back to Monday-Friday, and so on. In an embodiment, this is deduced from the user's Work Patterns, e.g., by picking the best 5 workdays (assuming policy of two weekend days per week), or less if only 4 days or fewer have sufficient working hours.

Therefore, specifically with reference to the above Table 7, it may be noted that:
the cells at column User 1 and row Apr 11 (Thu), column User 2 and row Apr 11 (Thu), column User 3 and row Apr 11 (Thu), column User 4 and row Apr 11 (Thu), and at column User 9 and row Apr 9 (Tue) are holidays at user's location;
the cells at column User 2 and row Apr 8 (Mon), column User 6 and row Apr 8 (Mon), column User 8 and row Apr 11 (Thu), and column User 3 and row Apr 12 (Fri) indicate when the user was absent but may have worked from home; and
the cells at column User 10 and row Apr 8 (Mon) and column User 10 and row Apr 9 (Tue) indicate when user was not part of Team 1 (yet to join or left the team).
The data in each column (for rows Monday to Sunday) is stored in the daily table of the user Work Pattern database for each user for the specific date.

Table 8 summarizes an example of work patterns analysed on weekly basis for the team of 10 users with daily work time as shown in Table 7.

TABLE 8
Table showing Work Time in hours for Team 1 with 10 users for one week

| | User | User | User | User | User | User | User | User | User | User | Team |
|---|---|---|---|---|---|---|---|---|---|---|---|
| | 1 | 2 | 3 | 4 | 5 | 6 | 7 | 8 | 9 | 10 | 1 |
| Staffed | 5 | 5 | 5 | 5 | 5 | 5 | 5 | 5 | 5 | 3 | 48 |
| Workdays | | | | | | | | | | | |
| this week: # | | | | | | | | | | | |
| weekdays | | | | | | | | | | | |
| unless user has | | | | | | | | | | | |
| joined/left | | | | | | | | | | | |
| midweek | | | | | | | | | | | |
| User's | 4 | 3 | 3 | 4 | 5 | 4 | 5 | 4 | 4 | 3 | 39 |
| Workdays | | | | | | | | | | | |
| this week: | | | | | | | | | | | |
| lower than | | | | | | | | | | | |
| staffed | | | | | | | | | | | |
| workdays due | | | | | | | | | | | |
| to public | | | | | | | | | | | |
| holidays and | | | | | | | | | | | |
| vacations | | | | | | | | | | | |
| User's | 3 | 4 | 4 | 3 | 2 | 3 | 2 | 3 | 3 | 2 | 29 |
| holidays this | | | | | | | | | | | |
| week: consists | | | | | | | | | | | |
| of weekends, | | | | | | | | | | | |
| public | | | | | | | | | | | |
| holidays and | | | | | | | | | | | |
| vacations | | | | | | | | | | | |
| Workdays | 32.2 | 22.6 | 18.9 | 23.5 | 36.5 | 32.5 | 33.1 | 27.8 | 24.1 | 23.3 | 274.5 |
| only Total | | | | | | | | | | | |
| Work Time | | | | | | | | | | | |
| that week: | | | | | | | | | | | |
| excludes work | | | | | | | | | | | |
| done on | | | | | | | | | | | |
| weekends, | | | | | | | | | | | |
| pubic holidays, | | | | | | | | | | | |
| vacations | | | | | | | | | | | |
| Workdays | 8.1 | 7.5 | 6.3 | 5.9 | 7.3 | 8.1 | 6.6 | 7.0 | 6.0 | 7.8 | 7.0 |
| only Average | | | | | | | | | | | |
| Work Time: | | | | | | | | | | | |
| average daily | | | | | | | | | | | |
| work hours on | | | | | | | | | | | |
| working days | | | | | | | | | | | |
| 7-Day Total | 32.2 | 24.3 | 27.2 | 23.6 | 36.5 | 35.9 | 34.5 | 31 | 24.1 | 23.3 | 292.6 |
| Work Time | | | | | | | | | | | |
| that week: | | | | | | | | | | | |
| total of all | | | | | | | | | | | |
| daily work | | | | | | | | | | | |
| hours | | | | | | | | | | | |
| including on | | | | | | | | | | | |
| weekends, | | | | | | | | | | | |
| public | | | | | | | | | | | |
| holidays, | | | | | | | | | | | |
| vacations | | | | | | | | | | | |
| Daily Average | 8.1 | 8.1 | 9.1 | 5.9 | 7.3 | 9.0 | 6.9 | 7.8 | 6.0 | 7.8 | 7.5 |
| Work Time | | | | | | | | | | | |
| for the week: | | | | | | | | | | | |
| average daily | | | | | | | | | | | |
| work hours | | | | | | | | | | | |
| after including | | | | | | | | | | | |
| work time on | | | | | | | | | | | |
| all 7 days | | | | | | | | | | | |
| % Work done | 0% | 8% | 44% | 0% | 0% | 10% | 4% | 12% | 0% | 0% | 6.2% |
| on Holidays: | | | | | | | | | | | |
| high % means | | | | | | | | | | | |
| too much work | | | | | | | | | | | |
| being done on | | | | | | | | | | | |
| weekends, | | | | | | | | | | | |
| public | | | | | | | | | | | |
| holidays, | | | | | | | | | | | |
| vacations | | | | | | | | | | | |
| Variance in | 0.4 | 0.1 | 0.1 | 0.4 | 1.5 | 0.3 | 2.1 | 1.9 | 0.3 | 0.5 | |
| Daily Work | | | | | | | | | | | |
| Time: high | | | | | | | | | | | |
| variance | | | | | | | | | | | |
| means too | | | | | | | | | | | |
| much work on | | | | | | | | | | | |
| some days and | | | | | | | | | | | |
| too less on | | | | | | | | | | | |
| others | | | | | | | | | | | |
| Delivered | 101% | 101% | 113% | 74% | 91% | 112% | 86% | 97% | 75% | 97% | 94% |
| Capacity as | | | | | | | | | | | |
| % of | | | | | | | | | | | |
| Available | | | | | | | | | | | |
| Capacity: | | | | | | | | | | | |
| shows how | | | | | | | | | | | |
| busy the user | | | | | | | | | | | |
| is, and if they | | | | | | | | | | | |
| can achieve | | | | | | | | | | | |
| more | | | | | | | | | | | |
| Available | 80% | 60% | 60% | 80% | 100% | 80% | 100% | 80% | 80% | 100% | 81% |
| Capacity as % | | | | | | | | | | | |
| of Staffed | | | | | | | | | | | |
| Capacity: | | | | | | | | | | | |
| shows how | | | | | | | | | | | |
| holidays and | | | | | | | | | | | |
| vacations | | | | | | | | | | | |
| impacted | | | | | | | | | | | |
| Capacity | | | | | | | | | | | |

In the above Table 8, the Staffed Workdays, User's Workdays and User's holidays for the week are computed based on the conclusions derived from Table 7.

The data computed in Table 8 is stored in the weekly table of the user Work Pattern database.

A user predictor and instructor module 334 cooperates with the user Work Pattern analyser 332, the rules and pattern mapping engine 314 and the user Work Pattern database 336. The user predictor and instructor module 334 selects appropriate Work Pattern items, from the plurality of Work Pattern items, for tracking the user based the user's role in an organization hierarchy. The user predictor and instructor module 334 provides a feedback to the user on highlights and weak areas related to a work effort, a work output, and the work life balance index. The user predictor and instructor module 334 suggests areas of improvements for the user. The user predictor and instructor module 334 sets the goals for the user based on the plurality of Work Pattern items and work habits. The user predictor and instructor module 334 provides encouragement for the user with points and badges. The user predictor and instructor module 334 generates a progress report based on the goals, the points and badges won. The user predictor and instructor module 334 predicts the improvements in the work output, the work effectiveness index and the work life balance index for the user.

In accordance with one embodiment of the present disclosure, the user predictor and instructor module 334 uses the correlation between the Work Pattern items and the work output to:
provide feedback to the user about the Work Pattern items that impact work output; and
make recommendations to improve performance.

A pseudo-code for selecting the appropriate Work Pattern items from the plurality of Work Pattern items for tracking the user based the user's role in the organization hierarchy, in accordance with an embodiment of the present disclosure, is now described. For the ease of explanation, three typical roles are considered namely a desk worker, a field or sales person, and a manager. However, the above mentioned roles are provided as an example, but are not intended to limit the scope of the embodiment.
after the weekly Work Pattern for the user becomes available for a week or more, then
   review the daily average of the high level work effort parameters to select the right ones to track for the user based on the role;
the user is first asked to confirm the role and get more insights, relating to whether the user is expected to spend more of the work day online, if the work involves significant time on the email and/or meeting and/or call Activities;
if self-improvement mode then, user's expected Work Patterns are set based on similar role and industry benchmark data available from various organizations;
else,
   user role can be identified as an individual contributor, a team lead, a manager or a senior executive based on the number of sub-units and users reporting to the user in the organization hierarchy;
   a benchmark reference for each role can be set by the organization, or it can beset to the initial Work Pattern of the top 20 percentage in the sub-unit of which the user is apart and/or initial Work Pattern of the users that have the same role attribute;
if user is an office worker required to do most of the work on a CS agent of type PC, then track the online work time, percentage of core activity time, time on email;
if user is an office worker in a managerial role, then track the work time, percentage of the collaboration work time, time on work related meeting and call activities;
if the user is a sales person then track time on the work time, percentage of collaboration work time, and time on work related call and travel activities;
if the organization provides work unit related information at the user level then, track the work output parameters: output.volume, output. schedule variance and output. effort variance for each Purpose;

A pseudo-code for providing the feedback to the user on highlights and weak areas related to the work effort, the output achieved, the attention to important work, the user time effectiveness index and the work life balance index, in accordance with an embodiment of the present disclosure, is now described.
primarily assume that the user is a desk worker and an individual contributor or a first level team leader;
at the start of each week, month and quarter, review the key Daily Average Work Pattern items to be tracked for the user;
in the first week, provide a rating for key parameters as below:—(The numbers below are for discussion purposes. As noted earlier, the benchmark “reasonable” values are based on industry data for self-improvement mode, or set as per the baseline trends of the top 20% of users in the sub-unit or similar role):—
   work time—too high if >10 hours, high if 8-10 hours, good if between 6.5 to 8 hours, low if 5-6.5 hours, and too low if <5 hours;
   online work time—too high if >9 hours, high if 7-9 hours, good if between 5.5 to 7 hours, low if 4 to 5.5 hours, and too low if <4 hours;
   percentage of core activity time—too high if >90%, high if 70-90%, good if 50-70%, low if 25-50%, and too low if <25%;
   percentage of collaboration work time—too high if >90%, high if 70-90%, good if 40-70%, low if 25-40%, and too low if <25%;
   if not self-improvement mode, then indicate the user's performance relative to the top 20 percentage in the same sub-unit or role for each of the above;
select 2-4 of the most appropriate parameters from the above list, provide a sub-score to each parameter, and add up for an overall user time effectiveness score/index on a scale of 0-10. The user can track a single number more easily than multiple parameters.
   user time effectiveness index (0-10)=sub-score 1+sub-score 2+sub-score 3, where,
      sub-score 1:—4 points for good rating in work time (6.5 to 8 hours), reducing proportionately to 0 points from 8 to 10 hours or from 6.5 to 5 hours, and 0 points for >10 hours and <5 hours;
      sub-score 2:—3 points for good rating in online work time (5.5 to 7 hours), reducing proportionately to 0 points from 7 to 9 hours or from 5.5 to 4 hours, and 0 points for >9 hours and <4 hours;
      sub-score 3:—3 points for good rating in percentage of core activity time (50-70%), reducing proportionately to 0 points from 70% to 90% or from 50% to 25%, and 0 points for >90% and <25%;
   work output parameters (output.volume, output.schedule variance,output.effort variance) if available, are best viewed as independent parameters, the independent parameters improves as the user time effectiveness score improves;

A pseudo-code for suggesting areas of improvements for the user, setting the goals for the user based on the plurality of Work Pattern items and work habits, providing encouragement for the user with points and badges, and tracking the progress for an online desk worker, in accordance with an embodiment of the present disclosure, is now described.
in the initial weeks, if the user is a desk worker and online work time is low, then
   set a goal for higher online work time;
   if Unaccounted time in office is high or private time is high, then
      suggest to the user to volunteer for more responsibilities, or spend time to improve one's own job skills;
   else, Unaccounted time is reasonable and private time is low
      if meeting or call or any other non-core activity time is high, then set a goal for lower time on the non-core activity;
      if Unaccounted time in office is high, then set a goal for lower breaks taken;
if the user is a desk worker and percentage of core activity time is low, then
   check and alert the user if time on email and chat applications is high;
   set goals for higher focus time and lower switches to email and chat;
if the online work time and percentage of core Activity time are both good, then
   if the user is not able to complete assigned tasks on time or the work unit volume data is available and the user's volume is low relative to peers, then
      recommend training, mentoring or moving to work more suited to the user's skills;
   else, if the user is doing well on all the work parameters, then recommend to take up more challenging work and also, explore opportunities for improved work-life balance;
      if unaccounted time in office is >1 hour, then user to reduce time spent in the office;
      if the work time on the holidays is >0.5 hour, then reducing to <0.5 hour and complete the work during work days;
      if the work done at home on the workdays marked as work from home is greater than the 0.5 hour, then reduce to less than 0.5 hour and complete the work in office instead;
goals must be set to be incrementally higher than the current user trend to ensure that it is achievable with modest effort;
the user is permitted to review and change the goals that have been recommended;
organization may also set a fixed goal for its employees for certain Work Pattern items as a challenge, which the user may accept;
for each goal that is set, the user is provided with information on best practices that can help the user meet those goals;
goal setting and feedback is provided to the user via the gamification module as follows:
   for each goal that is set, inform the user about how the user's current trend compares with that of peers (average and Top 20%)
   identify the benefits of the proposed improvement to the user's work effectiveness index and the work-life balance index;
   provide a daily notification to the user whether the goal was met and whether the user is on an improvement track or not;
   notification includes a best practice relating to one of the goals set for the user
   for each goal, starting with 0 points at the start of the month, the user is awarded points each month;
   if the user accumulates sufficient points for a goal in the month, the user is awarded a badge for that goal;
   if the goal has been set by the organization, the user's name can be added to the list of badge winners for the month;
   the user gets a weekly and monthly summary of goals set, current weekly or monthly average of the Work Pattern items, change since last week or month, average and top 20 percentage of trends of peers in a similar role;
   if the user's work output parameters are available, then the weekly and monthly summary includes: output.volume, output. schedule variance, output. effort variance, and comparison with last week and month for each Purpose;
adapting the goal based on the user's progress: after a few days and weeks,
   if the user is consistently failing to meet the goal that has been set, the goal can be made simpler or changed to a different goal that is related but easier;
   if the user consistently achieves the goal for few weeks, it can be changed incrementally to the desired optimal value;
   once the user achieves and is able to maintain the desired optimal value, a different Work Pattern item can be selected for improvement;
provide the feedback whenever there is a good correlation between a Work Pattern item being tracked and the output to motivate the user to improve. If there is a strong negative correlation, it is better not to set any goal for that Work Pattern item.
   if the work output parameters like output.volume, output. schedule variance,output.effort variance are available, then for each of the key Work Pattern items correlate the Work Pattern item with each output parameter as below:

output−effort correlation index=Pearson correlation coefficient;
if correlation>0.4 for a majority of the available work output parameters, then notify the user of the benefits of improving the Work Pattern;
if correlation is <0.2 for a majority of the available work output parameters, then do not recommend or set any improvement goal based on that Work Pattern item;

A pseudo-code for predicting the improvements in the work output, the work effectiveness index and the work life balance index for the user, in accordance with an embodiment of the present disclosure, is now described.
if, goal>user's current daily average for the Work Pattern item,

then improvement target ratio=[goal/(current daily average)];

else improvement target ratio=[(current daily average)/goal];
for each output parameter,

predicted output parameter=current output parameter*improvement target ratio*[(output−effort correlation index) for that Work Pattern item and output parameter];
show the maximum predicted work output if the user made up to achieve the preferred range for the Work Pattern item:

if ideal daily average>the user's current daily average for the Work Pattern item, then improvement target ratio=[ideal/(current daily average)];

else, improvement target ratio=[(current daily average)/Ideal];
for each output parameter,

predicted maximum output=current output parameter*improvement target ratio*[(output−effort correlation index) for that Work Pattern item and output parameter]

The CS agent 300 also includes a privacy filter 338. The privacy filter 338 cooperates with the rules and pattern mapping engine 314 and the CS effort map unit 312. In an embodiment, the privacy filter 338 performs following functions:
mark all effort that is not identified as being on work related activities by the server and the user's mapping rules as personal time;
enable the user to explicitly change any time that was marked as personal to work;
enable the user to explicitly change any time that was marked as work by the server or the user's mapping rules to personal;
enable the user to select, or enable the CS agent to set directly, from one or more of the following privacy filter settings, when the CS agent is enabled to upload the user's effort data:
   deactivate uploading of user's personal time details to the server;
   deactivate uploading of some aspects of the user's work related information including applications and associated artifacts, to the server; and
   reduce the granularity of the user's work related information that is uploaded to the server to a daily, weekly, or monthly average of the Work Patterns;
   and
deactivate uploading of all the user's information to the server, when the CS agent is not enabled to upload the user's effort, both work and personal, to the server, thereby enabling the CS agent to function in self-improvement mode for the user and further enable the CS agent to select from one of the following data sharing options:
   allow the user to voluntarily disclose identity and some or all aspects of the user's Work Patterns to the server in return for being able to collaborate with peers or the entire organization for benchmarking and cross-learning from each other; and
   allow the user to voluntarily disclose some or all aspects of the user's Work Patterns to the server, wherein the CS agent is adapted to obfuscate the user's identity, in return for being able to benchmark user's own performance with that of peers or the entire organization as provided by the server;

A pseudo-code for the privacy filter 338, in accordance with an embodiment of the present disclosure, is now described.
if the CS agent 300 is enabled to upload user's effort data to the server, then
   provided CS agent has one or more of the following privacy filter options enabled for the user, then
      if the enabled or selected option is not to send personal time details, then all information in rows marked as Private, other than the Private purpose is blanked;
      if the enabled or selected option is not to send artifact details, then names of artifacts in all rows are blanked;
      if the enabled or selected option is not to send application name details, then application names in all rows are blanked; and
      if the enabled or selected option to block upload of all user data, work
         or personal, then exit (no upload of any user data to the server);
if the CS agent 300 is not enabled to upload user's effort data to the server, thereby enabling the user to operate in ‘self-improvement’ mode, then
   provided CS Agent has one or more of the following privacy filter options enabled for the user, then
      if the user has selected any of the work related data to be voluntarily shared, such as all data, all work data, all work data excluding artifacts, or all work data excluding artifacts and application names, then only the information that is volunteered to be shared by the user, is retained in all the rows, while the remaining information is blanked;
      if user has opted for anonymous sharing, then the server provided user ID to user name mapping is always encrypted in CS Agent and the server databases;
      else (self-improvement mode and user has not opted to share any data voluntarily) Exit (no upload of any user data to the server);

In accordance with an embodiment of the present disclosure, the local user interface 322 receives inputs from the user Work Pattern analyser 332 and the user predictor and instructor module 334. The local user interface 322 performs following functions:
display privately to the user the Work Pattern trends for a predetermined period and the wellness instruction prompts;
indicate the areas of improvements and the goals;
display the progress report based on the goals, the points and badges won; and
review and edit Activity, Purpose, and work unit mappings.

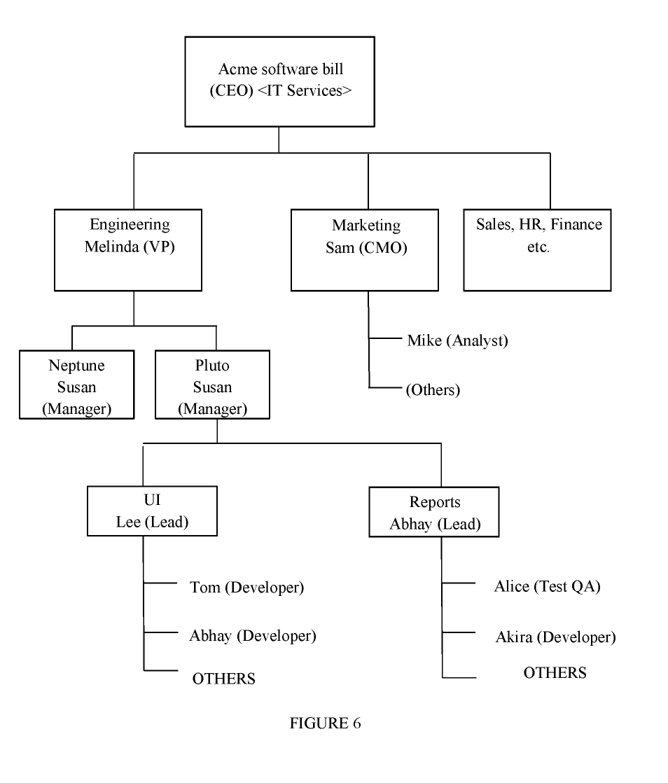

The discussion below provides a detailed description of how mapping rules get progressively more refined and comprehensive based on new information that becomes available at the two engines—server side organization settings and rules engine 416 and the rules and pattern mapping engine 314 on each CS. FIG. 6 illustrates a representative organization (an IT Services company called Acme Software), and indicates its hierarchy consisting of various sub-units and users, along with typical attributes.

The server side organization settings and rules engine 416 configures a master list of Activities and Purposes based on the organization profile. The master list of Activities for Acme Software is selected appropriately based on its primary business attribute of being an IT Services company. If required, the Acme Software administrator can edit or add to this default list:
Online Activities: Planning, Design, Programming, Test/QA, Communication, Documentation, Marketing
Offline Activities: Meetings, Calls, Business Visits

At the server, the organization sync agent 404 automatically obtains the organization hierarchy, user list, and business attributes of organization sub-units and users, from the Human Resources (HR) or Enterprise Resource Planning (ERP) system. The user's Purposes will typically be the project or function or group that they belong to in the organization hierarchy. In the example of FIG. 6, Susan heads two projects called Pluto and Neptune. Tom is a developer in the Pluto UI team, and Alice is a Test and QA engineer in the Pluto Reports team. Abhay is a lead in the Pluto Reports team and also a developer in the Pluto UI team. Akira is a developer in the Pluto Reports team. Mike is an analyst in the Marketing team. The Purposes for them are respectively Pluto and Neptune (Susan), UI (Tom), Reports (Alice) and Marketing (Mike).

Table 9 summarizes Purpose and Activity list for four employees in the organization.

TABLE 9

| Name | Role | Purpose | Activities | Comments |
|---|---|---|---|---|
| Alice | Test and | Acme.Engineering. | Testing, Documentation, | |
| | QA | Pluto.Reports | Communication, | |
| | | | Meetings, Browsing | |
| Abhay | Lead | Acme.Engineering. | Project Management, | Abhay Plays |
| | | Pluto.Reports | Reviews, Documentation, | the role of a |
| | | | Communication, | Lead in this |
| | | | Meetings, Browsing | team |
| | Developer | Acme.Engineering. | Programming, | Abhay is a |
| | | Pluto.UI | Documentation, | Developer in |
| | | | Communication, | this team, and |
| | | | Meetings, | hence |
| | | | Browsing | Activities for |
| | | | | this Purpose are |
| | | | | a bit different |
| Susan | Manager | Acme.Engineering. | Business Planning, Project | Susan is a |
| | | Pluto | Management, | manager in |
| | | | Documentation, Calls, | both groups, |
| | | | Communication, | and hence |
| | | | Meetings, Browsing | Activity list |
| | Manager | Acme.Engineering. | Business Planning, Project | remains the |
| | | Neptune | Management, | same for both |
| | | | Documnetation, Calls, | Purposes |
| | | | Communication, | |
| | | | Meetings, Browsing | |
| Mike | Analyst | Acme.Marketing | Research, Documentation, | |
| | | | Social, Media, Calls, | |
| | | | Work, Travel, | |
| | | | Communication, | |
| | | | Mettings, Browsing | |

At the organization settings and rules engine 416, all work related applications and websites of interest to the organization are mapped to a default Activity and Purpose. Default mappings also apply to offline time captured from calendaring tools on the CS agent 300 such as Microsoft Outlook, Lotus Notes and Google Meeting, and as obtained on the server 400 from PDs and PD servers. Default offline Activity can be meetings, calls, work travel, lab work and so on.

In the example of FIG. 6, online applications such as Outlook and Google Chat are marked to Communication, MS-Office programs such as Word and Excel to Documentation, tools like Visual Studio and Eclipse to Programming, and others like Bugzilla and QTP to Testing. In the case of offline time, the source is important. Hence, user time obtained from calendaring tools will be marked to Meetings, time noted on phone calls as per smartphone or PABX server or IP phone server will be tagged to Calls, and travel time to business destinations as sourced from GPS based smartphone will be inferred as being for Travel. Swipe card entry/exit information can be used to determine and mark user's time in a lab being used by the Pluto team, to ‘Lab Work’ as the specific Activity and ‘Pluto’ as the Purpose.

In embodiments, the mapping rules for the same application, website or offline work, may vary depending on the sub-unit and employee role. In the example of FIG. 6, time spent by QA engineers like Alice on Visual Studio and Eclipse will be marked to Testing instead of the default of Programming for development engineers. Similarly, time spent on social networks such as Facebook and Twitter will be marked to Marketing for Tom. Facebook time will not have any default marking for Susan, Tom and Alice, which means that their time on Facebook will automatically get tagged as being for personal purpose.

In some embodiments, the central mapping rules can be changed by intermediate managers, whereby the revised mapping rule applies to employees and sub-units reporting to that manager.

Each mapping rule assigns a specific Activity, which represents the most common use of the application, to that application. In the case of Purpose, the mapping can be made to a common Purpose such as ‘Corporate’ (representing any common company related work such as filing expense reports and leave applications), or to a generic one referred to as ‘Current Purpose’. The latter assignment ensures that this generic mapping on the organization settings and rules engine 416 defaults to that particular user's currently assigned project or function in the CS agent 300 side rules and pattern mapping engine 314. An employee may be simultaneously assigned to more than one project/function. In such a case too, the system envisaged by the present disclosure allows the user to change the ‘Current Purpose’ at any time via the CS agent local user interface 322, as a result of which the specific mapping from that time onwards automatically gets mapped to the project/function that the user is working on. In the example, if Susan had been working on Pluto for a while and now switches to Neptune, she can change the Current Purpose to be Neptune.

A mapping rule can be marked as being non-editable, in which case it applies uniformly throughout the organization and cannot be changed.

The local user interface 322 on the CS allows the user to review current time utilization and mappings by accessing the effort map database 318. In some embodiments, the rules that are marked as being editable by the user can be modified by an employee, for example in case of non-standard use of an application or different uses of the application based on the artifacts (files, folders and websites) being worked on.

In some embodiments, the user may define mapping rules that are based on the names or partial names of artifacts such as folders, files and web links. In the case of offline time, the patterns may relate to specific people, phone numbers, and locations. The user can map such partial or full artifact names to a default Purpose and Activity. Thereafter, future instances of the artifact are identified by pattern matching, and mapped automatically to the corresponding default Purpose and Activity. For example, Susan may mark time spent on a particular Excel file PlutoPlan.xls as being for Planning, rather than the generic Documentation, and further specify that any file with the text ‘Pluto’ or ‘Neptune’ in it be marked to Planning and respectively Pluto and Neptune as the purpose.

In some embodiments, the organization or intermediate manager can also set mappings based on artifacts such as common folders or phone numbers and locations. For example, if a project team follows a particular nomenclature for naming folders associated with a particular project then, all users in that project inherit the rules that map the named folders to default Activity and Purpose. Similarly, offline work in labs and conference rooms may default to a specific Activity and Purpose.

The user side mapping changes are remembered by the CS agent unless the user explicitly suggests otherwise. In some embodiments, these mapping changes are visible to immediate supervisors, senior supervisors, and executive staff in the organization.

Embodiments of the method provide for an ‘automated’ mode of deployment. Users and managers are not permitted to edit any mapping rule, both for online and offline time slots.

All rules are set as non-editable in the organization settings and rules engine 416. In one variation of the embodiment, users can only create new rules to mark any unmapped applications and websites that they used from the default ‘Private’ to work. They cannot change existing rules regarding online and offline work. In another variation, users can change rules for editable online applications and websites, but not for offline work.

In accordance with the present disclosure, the organization settings and rules engine 416 can specify whether new applications and websites used by an employee that do not have any default mapping, should get marked by the time analyser 308 to Activity as Unaccounted and Purpose as Private or any other Purpose. Mapping unknown applications and time to Private ensures greater protection of the employee's privacy. User time marked to Private is not visible to the organization unless the user explicitly changes the mapping to work. In the example, time spent by Alice on Facebook and Twitter is marked as Private. Mike's time on Facebook the other hand is being shown as Marketing time. He may also change his default for Twitter to Marketing if it is being used for work.

Time on new unmapped applications and websites is communicated by the server interface 326 on each CS agent back to the organization settings and rules engine 416 on the server. This is aggregated across all users and displayed to the Administrator but with user names removed to preserve privacy, thereby allowing more default rules to be created if these are work applications and websites. Thus, more and more work effort can be accurately captured and mapped without requiring any user input.

In some embodiments, the organization settings and rules engine 416 on the server employs team intelligence. For instance, if a user is part of a team, any assignment by a team member becomes a hint or the actual assignment for a new application and artifact combination until and unless the user changes the mapping. Thus, proper mapping by one user in the team reduces time spent on Activity and Purpose mappings by other team members.

In some embodiments, when a new project is started, the mapping of application and artifacts to Activity of a previous project can be taken as a reference for the new project, thus leading to an ever increasing accumulation of intelligence related to mappings.

In some embodiments, especially in large organizations, the Activity List can be multi-level in order to support the diverse nature of work being done in different parts of the enterprise. Each level in the enterprise can mark off the Activities that apply to them, and the next level managers can further short list the applicable Activities. This ensures that at individual employee level, the Activity list is manageable and confirms to the employee's role.

The multi-level Activity list can be further customized for the available roles or sub-units in the organization. In such an embodiment, multiple default mapping rules can be created for the same application, to match its common use in various sub-units or employee roles. At an individual employee level, typically only one applicable rule will exist. If more than one is available due to the employee's varied roles, then the most appropriate one is selected based on the related artifact, user's current purpose or some other criteria like the mapping of other team members.

Some embodiments of the present disclosure include a multi-level Purpose tree for enabling fine-grained effort tracking at project, module, or task level. Individual employees may be assigned to one or more tasks in different modules and even projects, for example. To distinguish work on each task, the employee must update the Current Purpose on the CS whenever there is a switch to a new task. A multi-level Purpose hierarchy enables a business unit head to track effort on projects, while project managers can get effort measurement on various modules, and module leaders can get insights into effort spent on features and tasks.

In some embodiments, the present disclosure provides for additional individual privacy with a user private time selector 330, which optionally enables the user to disable time tracking for a specified duration. The entire time is marked as Unaccounted and Private. The user private time selector 330 may optionally be enabled only outside of regular working hours. The user private time selector 330 enables the user to disable a user's time tracker for specified time ranges. The time ranges includes the time slots. The time slots in the time ranges are marked as unaccounted and private time.

The system envisaged by the present disclosure has a local user interface 322 on each CS that processes the effort map exchange database 318, and presents the results in a meaningful way for the employee on the CS screen. The local user interface adapts the presentation to match the screen viewing capability of the CS, which may range from a large screen available on desktops and laptops, to the small screen area on a tablet and smartphone. The employee can privately view the personal and work related time utilization, mapped to Activity and Purpose.

The local user interface 322 provides a lot of detailed information about high level work trends, with the ability to drill down to minute by minute accounting of time spent on personal and work related activities. This is typically available for the past 7-30 days. Trends displayed on the local user interface 322 include first Activity and last Activity time (online or offline), first online and last online time, total time in between, online and offline time, and breakup on work and personal. Work Time trends and reports across Purposes, Activities, Applications and artifacts are available for each day, or on weekly basis.

The local user interface 322 also infers and reports on Work Patterns of the user such as leaves taken, work done on holidays, shift timings, non-standard and variable work week, gap between time in office and time on work, completed work units and so on. It can infer that the user is a desk worker with mostly online work time on one or more CS, or does supervisory work involving online and offline work, or is a travel oriented worker spending time mostly offline and away from office. It can determine work behaviour that can influence overall productivity such as the average and maximum uninterrupted focus time on important activities, work units, number of distractions, and breaks taken from the CS for desk workers. For supervisory and travel oriented workers, the statistics related to average and maximum time on meetings, business calls, and travel time to a customer site, can be useful.

In some embodiments, the CS agent 300 may store user trends for a much longer period—months and longer. The trends provided on the local user interface 322 are more detailed, available for example on monthly and cumulative basis, and with the ability to compare between different time periods.

Since the local user interface 322 is local on the CS, there is no requirement for the CS agent 300 to be connected to the server 400 when the user wants to review and edit the work effort information. The availability of the local user interface 322 promotes the sense of individual privacy and lets the user to review and update work effort, mapping rules, and switch the current purpose, without requiring server access. While the user gets a detailed view of the work effort on the CS, managers can typically only view the employee's high level work data (without personal time details) on the server 400. In some embodiments, managers do not have visibility into artifacts such as files, folders and websites. In other embodiments, the user's data is available only in terms of daily or weekly or monthly totals on the server. Finally, in one embodiment (anonymous' mode), there is no individual level access for managers.

In some embodiments, the local user interface 322 lets the user edit the mappings, provided the rule is editable at user level. Unmapped applications, websites, and unaccounted offline time, which normally default to ‘Private’ in order to protect the user's privacy, can be changed to reflect the work done. This will ensure that the user's work effort gets recognized in the information that is made available to the organization on the server 400.

As per the recent trends visible in the local user interface 322, if the user finds that the work effort is not sufficient, the employee can start ensuring more time on work. Similarly, the employee can verify that work time is being spent adequately on the core Activities. The work can improve habits by increasing work focus and reducing number of breaks taken, reducing average length of meetings and business calls and so on.

In some embodiments, the user can be guided for improved performance by setting one or more goals regarding minimum work time, online work time, time on specific purpose, activity, application or artifact, and so on. The goals are set from the server 400 for the organization or by a manager, and may change periodically as the work shifts from one phase to another. The local user interface 322 compares user's current performance against goals, and generates an alert if required for the individual. The user can then make the necessary adjustments to meet the desired goals.

In some embodiments, the system provides a gamification module 324 to encourage improved work habits by setting challenges related to work focus and minimizing distractions. For example, productivity is known to increase if an employee spends sustained burst of online work on an important task for at least 20-30 minutes without switching to emails and taking an offline break.

Another area of improvement is work-life balance, wherein the user delivers enough work effort during office hours and limits non-work time. The user can choose a challenge on any of the above aspects, and the gamification module guides the user towards meeting the challenge. Performance points are awarded based on achievement, which lead to a badge when a certain number of points have accumulated. The challenge complexity can be increased progressively. The gamification module 324 interfaces to the employee through the local user interface 322.

The server interface 326 provides for communication between the CS agent 300 and the server 400. The server interface 326 periodically downloads the list of valid Purposes and Activities, default mapping rules, and goals and alerts for the user from the server 400. These are made available to the relevant components in the CS agent 300. Typically, the downloaded information only needs to reflect the changes since the last instance. In a similar manner, any new user mapping rules and unmapped applications and websites are also uploaded to the server through this interface.

The CS effort map unit 312 utilizes the server interface 326 to upload the CS effort map to the server 400. After creating the merged user effort map, the server 400 coordinates with the server interface 326 to download it into the effort map exchange database 318.

In most embodiments, the communication between the server interface 326 and server 400 is every half working day (3-4 hours), since the objective is not to track employees minutely but to determine overall work effort to achieve improvements and efficiency gains. In some embodiments, where it is necessary to track employees in real time, the communication can be every few minutes. The communication is optimized to only transfer the changes since the last exchange, and also transfer lower priority items less frequently.

If the server is inaccessible for any reason, the CS agent 300 continues to function with the existing data, and resumes the exchange of information once server connectivity is restored.

As noted previously, FIG. 2 shows a schematic of the system to measure, aggregate, analyse, predict and improve the exact effort and time productivity of employees at an organization in accordance with the present disclosure, comprising of at least one CS agent cooperating with at least one server.

The system includes at least one CS agent per employee cooperating with at least one server, the CS agent adapted to generate exact effort data for a user. The first aspect of the present disclosure related to the CS agent 300 and its components were discussed above.

According to the second aspect of the present disclosure, it includes at least one server 400 configured to collect effort data from all employees, which is then aggregated and analysed across the enterprise hierarchy, thereby providing a powerful platform for organization wide effort and capacity optimization. Along with employee work effort, the system envisaged by the present disclosure collects the organization hierarchy information and attributes pertaining to sub-units from various existing organization application data stores. It configures a master list of Activities and Purposes, derived from the organization hierarchy (which represents projects and functions) and business attributes (which determine the relevant Activities for a particular type of organization and its sub-units). Default rules for mapping online and offline time slots to Activities and Purposes are also configured, which may be rules adapted for organization sub-units based on their business attributes and further adapted for each user based on his or her position in the sub-unit hierarchy and the user's role therein. The system envisaged by the present disclosure computes the per-employee Daily Average Work Patterns and creates an n-dimensional effort data cube in which effort data of employees is aggregated and rolled up as per the organization hierarchy. It facilitates views at each level of the organization hierarchy across multiple dimensions such as Purpose, Activity, applications, projects and functions, artifacts, and business attributes such as employee levels, roles, skills, locations, verticals, technologies, and cost centers. It becomes possible to selectively filter and drill down to generate discrete effort data at individual and sub-unit level, subject to the user's role in the organization hierarchy and permitted access rights. Administrative controls are provided to the organization to ensure that employee data visibility and granularity can be restricted as per the privacy requirements, legal or cultural.

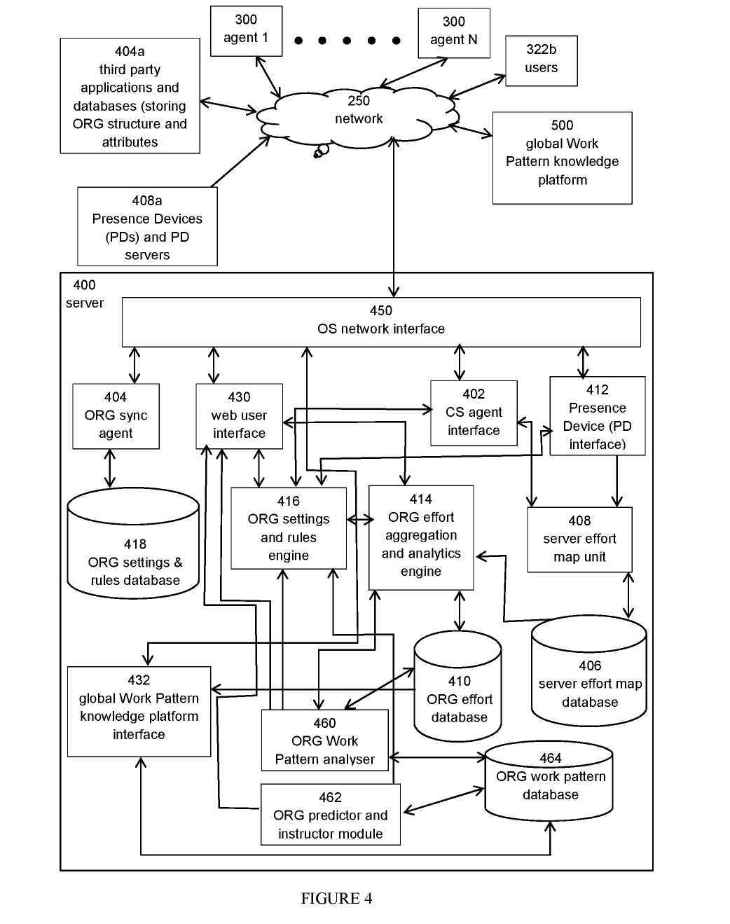

FIG. 4 is a schematic of the server 400 and its components, as described further below:

CS agent interface 402: The CS agent interface 402 handles all the communication with the server interface 326 on each CS. It enables upload of valid Purposes and Activities, default mapping rules, goals and alerts, and user effort map to each individual CS agent 300. The CS effort map, new user mapping rules and unmapped applications and websites are also downloaded to the CS agent 300 through this interface.

organization sync agent 404: The organization sync agent 404 consists of collection logic and a data exchange framework for shared database and programmatic interface with third party applications and database servers 404A. It interfaces to one or more existing organization applications or data stores to periodically collect and update the list of valid users and organization hierarchy that map each user to one or more organization units, wherein users can be grouped along multiple hierarchies, for example corresponding to functions, services lines and locations. It also collects business attributes qualifying each employee and organization sub-unit which may be available from one or more existing organization application data stores. The gathered information about the organization hierarchy, attributes and users is maintained as part of an organization settings and rules database 418. An open data exchange framework is defined that enables the external application data stores (such as HR and ERP applications and databases) to present their organization structure and business attributes data in a format that can be imported readily by the organization sync agent 404. Further, after the first import, the organization sync agent 404 stays consistent with the organization structure and attributes, by regularly importing the latest versions, comparing with its own previous copy, and applying all subsequent changes. The business attributes for the employee are selected from the group consisting of role, skills, salary, position and location. The business attributes for the organization sub unit are selected from the group consisting of domain, vertical, cost and profit center and priority.

A server effort map unit 408: The server effort map unit 408 receives the CS effort map from every CS of each user on regular basis over the CS agent interface 402. It also obtains an offline PD effort map of all the users from the PD interface 412. The server effort map unit 408 merges these multiple effort maps to generate a final user effort map for every user. This aggregate data for all users is stored in a server effort map database 406. The CS agent interface 402 downloads the final user effort map back to each CS for every user.

A PD interface 412: The PD interface 412 determines the offline PD effort map for the user. The PD interface 412 connects to various PDs and PD servers 408A that connect to the server, and obtains information about the user's offline time spent on calls, visits to specific office areas such as labs, work related travel, remote meetings, and so on. It prepares an offline effort map for each user and makes it available to the server effort map unit 408. The PD interface obtains information about offline mapping rules from the organization settings and rules engine 416.

An organization effort aggregation and analytics engine 414: The organization effort aggregation and analytics engine 414 accesses the daily effort of each individual employee from the server effort map database 406, computes a per-employee Daily Average Work Pattern, and performs the aggregation, averaging and analytics of individual effort across the entire organization hierarchy (which may be single level or multiple as in the case of matrix organizations) and business attributes collected at the server, and stores the results in an n-dimensional organization effort database 410. The organization effort aggregation and analytics engine 414 enables generation of trends, reports, goal compliance, alerts and rewards notifications responsive to the exact effort data across Purposes, Activities, applications, artifacts and organization attributes.

An organization settings and rules engine 416: organization settings and rules engine 416 keeps track of the organization structure, users, access rights, privacy filters, various configuration parameters for the organization, master list of Activities and Purposes further adapted for each user, and rules related to mapping of online applications and offline PD data to Activity and Purpose as defined for each user, team and the like. These settings and rules are stored in the organization settings and rules database 418.

A web user interface 430: The web user interface 430 enables employees to view trends, reports, alerts, and administration functions using internet Browser or standalone web applications. This interface is also available to a central administrator and managers for editing the organization structure, Activity and Purpose list, rules and settings.

A global Work Pattern knowledge platform interface 432: The global Work Pattern knowledge platform interface 432 lets a participating organization contribute their high level Work Pattern analytics and trends to a global Work Pattern knowledge platform, along with a high level profile of the organization regarding its size, industry, vertical, and so on. In turn, the organization can obtain reports that rate its performance and standing relative to peer organizations along selected profile criteria.

An OS network interface 450: The OS network interface 450 connects the knowledge platform interface 432, the web user interface 430, the organization sync agent 404, the CS agent interface 402 and the PD Interface 412 to the network 250.

An organization Work Pattern analyser 460: The organization Work Pattern analyser 460 receives the per-employee Daily Average Work Pattern for each sub-unit from the organization effort aggregation and analytics engine. The organization Work Pattern analyser 460 computes a plurality of sub-unit Work Pattern items for each sub-unit, wherein the plurality of sub-unit Work Pattern items are selected from the group consisting of a sub-unit effort, sub-unit habits, a sub-unit work life balance index, a sub-unit work effectiveness index, a sub-unit capacity utilization and a sub-unit effort distribution across Purposes, Activities, applications and work units.

The organization Work Pattern analyser 460 at the server 400 analyses the Work Patterns at every level of the organization hierarchy. The organization hierarchy is typically the operational level structure consisting of teams, projects, groups and business units of an organization. Large organizations may have a matrix reporting structure, in which case they will have parallel reporting structures. The analysis may be useful for other logical grouping of users of interest to the business, for example based on employee skill sets or business models. In every case above, the organization sub-units represent a collection of users at the lowest level, and collection of sub-units at the next and successive levels ending with the overall organization.

In accordance with an embodiment of the present disclosure, the Work Pattern analysis for each sub-unit of the organization for one week is now described. The analysed results are stored in a weekly table of an organization Work Pattern database 464. The weekly table is prepared for each sub-unit of the organization. The same analysis may be used to obtain the analysis of the Work Patterns on monthly, quarterly, annual basis and stored in tables to allow for quick retrieval and trending of longer term trends. After receiving organization sync at the organization sync agent, for each new sub-unit added, the organization Work Pattern analyser creates a Weekly Table for the sub-unit in the organization Work Pattern database 464. The organization Work Pattern analyser 460 computes a plurality of sub-unit Work Pattern items for each sub-unit store them in the weekly table of the organization Work Pattern database 464. The plurality of sub-unit Work Pattern items may be classified into five major groups:

1. high level sub-unit effort;

2. sub-unit effort distribution across purposes, activities, applications, and work units;

3. sub-unit work habits;

4. sub-unit work-life balance index; and

5. sub-unit metrics useful for relative comparisons.

At the start of each week, for each sub-unit, starting with the lowest leaf nodes in the organization structure, and moving upwards [sub-unit=sub-unit whose Work Pattern is being determined; next level sub-units=all sub-units immediately below the upper sub-unit; below the lowest sub-units are users (leaf nodes in the organization structure);], the organization Work Pattern analyser 460 adds a row in the weekly table in the organization Work Pattern database 464 for an upper sub-unit to store the previous week's Work Pattern being computed. Each row of the weekly table consists of the a week number, an upper sub-unit ID, and fields for each of the Work Pattern items to be computed for the upper sub-unit using the row for the previous week in the weekly tables of the next level sub-units.

1. A pseudo-code for computing high level sub-unit effort, in accordance with an embodiment of the present disclosure, is now described. In the following pseudo-code, the work unit tracking is enabled if the organization provides the work unit data at a user level.
I. at a high level, from a work perspective, what matters is whether the team put in reasonable effort, on the right kind of activities, and if the output was reasonable.

workdays of sub-unit=(workdays that week) over all next level sub-units;

daily average work time=(work time)over all next level sub-units)/(workdays of the sub-unit);

daily average online work time=(Σ(online work time)over all the next level sub-units)/(workdays of the sub-unit);

daily average offline work time=(Σ(offline work time)over all the Next level sub-units)/(workdays of the sub-unit);

daily average core Activity time=(Σ(core Activity time)over all the next level sub-units)/(workdays of the sub-unit);

core Activity time=(daily Average core Activity time)/(daily Average work time);

daily Average collaboration work time=(Σ(collaboration work time)over all next level sub-units)/(workdays of the sub-unit);

collaboration work time=(Σ(collaboration work time)over all next level sub-units)/(workdays of the sub-unit);
II. if tracking of work units is enabled for some or all Purposes in the sub-unit, or if the user work output is available from any external application, then compute work output parameters (volume, effort and Schedule Variance) for each applicable Purpose, and in aggregate at sub-unit level. These are important performance benchmarks and correlating them with Work Pattern items can reveal deep insights to the manager about how best to guide the sub-unit towards peak performance.
   if work unit tracking is enabled for any Purpose, then for each such Purpose,

output.volume=(output.volume)over all next level sub-units for the Purpose);

output.schedule variance=var[(output.schedule variance)*(output.volume per next level sub-unit)/(output.volume for this sub-unit)]over all next level sub-units;

output.effort variance=var[output.effort variance)*(output.volume per next level sub-unit)/(output.volume for this sub-unit)]over all next level sub-units;
III. compute output metrics on composite basis for the sub-unit by combining all the Purposes;
   if work unit tracking is enabled for any Purpose, then for all such Purposes combined:

output.volume for sub-unit=(output.volume)over all sub-unit Purposes);

output.schedule variance for sub-unit=var[(output.schedule variance)*(output.volume per Purpose)/(output.volume for all sub-unit Purposes)]over all sub-unit Purposes;

output.effort variance for sub-unit=var[(output.effort variance)*(output.volume per purpose)/(output.volume)]over all sub-unit Purposes;

2. A pseudo-code for computing sub-unit effort distribution across purposes, activities, applications, and work units, in accordance with an embodiment of the present disclosure, is now described. (daily average of time on each Purposes, Activities, application and work unit is computed one at a time)
computing the daily average of time on each Purpose, Activity, application and work unit:—
for each Purpose,

daily Average work time on each Purpose=(work time on the Purpose) over all the next level sub-units)/(workdays of the sub-unit);
for each work unit in the Purpose:—

daily average work time on each work unit=(work time on the work unit) over all next level sub-units)/(workdays of the sub-unit);

work Unit completion status=list of all work units with completion status true over all the next level sub-units;
for each Activity,

daily average work time on each Activity=(work time on the Activity) over all the next level sub-units)/(workdays of the sub-unit);
for each application,

daily average work time on each application=(work time on the application) over all the Next level sub-units)/(workdays of the sub-unit);

3. A pseudo-code for computing sub-unit work habits, in accordance with an embodiment of the present disclosure, is now described.

daily average breaks taken that week=(breaks taken) over all next level sub-units)/(workdays of the sub-unit);

daily average switches to email/chat that week=(Σ(switches to email/chat) for all next level sub-units)/(workdays of the sub-unit);

daily average focus time that week=(Σ(focus time)over all next level sub-units)/(workdays of the sub-unit);

golden hours that week=(Σ(golden hours) over all next level sub-units;

4. A pseudo-code for computing sub-unit work-life balance index, in accordance with an embodiment of the present disclosure, is now described.
I. work-life balance aspects that pertain to workdays and are relevant at sub-unit level:—

holidays of sub-unit=Σ(holidays that week) over all next level sub-units;

staffed days of sub-unit=Σ(staffed days that week) over all next level sub-units;

II. get extent of work from home and if it is equally productive:—

percentage of work from the home days that week=(Σ(workdays marked as work from the home over all next level sub-units))/(workdays of the sub-unit);

work from home effectiveness=(Σ(work from home effectiveness*workdays that week) over all next level sub-units)/(workdays of the sub-unit);
III. check if too much time is being spent on personal work while in office, and extent of time spent that cannot be accounted by any CS or PD

percentage of private time in office=(Σ(percentage of private time in office*workdays that week) over all next level sub-units)/(workdays of the sub-unit);

percentage of unaccounted time in office=(Σ(percentage of unaccounted time in office*workdays that week) over all next level sub-units)/(workdays of the sub-unit);
IV. is a lot of work being done on the holidays and at the home after a regular workday?:—

percentage of work done on holidays that week=(Σ(percentage of work done on holidays*holidays that week) over all next level sub-units)/(holidays of the sub-unit);

percentage of the work done at home on workdays marked as work from office=(Σ(percentage of the work done at the home on workdays marked as work from office*workdays that week) over all next level sub-units)/(workdays of sub-unit);
V smartphone addiction on workdays:—

smartphone time on a workday=(*Σ(smartphone time on a workday*workdays that week) over all next level sub-units)/(workdays of the sub-unit);

daily unlocks on a workday=(Σ(daily unlocks on a workday*workdays that week) over all next level sub-units)/(workdays of the sub-unit);
VI. average commute time and physical time on workdays:—

physical time in office=(Σ(physical time in office on a workday*workdays that week) over all next level sub-units)/(workdays of the sub-unit);

daily average of commute time=(Σ(commute time on a workday*workdays that week) over all next level sub-units)/(workdays of the sub-unit);
5. A pseudo-code for computing sub-unit metrics useful for relative comparisons, in accordance with an embodiment of the present disclosure, is now described.
I. capacity utilization—extent to which sub-unit is busy, and impact of the holidays on available capacity in that week;

delivered capacity as percentage of available capacity=(Σ(delivered capacity as % of available capacity*workdays that week) over all next level sub-units)/(workdays of sub-unit);

available capacity as percentage of staffed capacity=(Σ(available capacity as percentage of staffed capacity*staffed days that week) over all next level sub-units)/(staffed days of sub-unit);
II. comparing top 20%, mid 60% and last 20% of users for any Work Pattern item:—
   for all the next level sub-units and iteratively their next level sub-units till the lowest sub-unit which consist of users:—
      sort the users in the table as per daily average work time;
      total users=total rows in the user table;
      compute daily average distribution between top 20% of users and rest:—

top 20 percentage of daily average work time=(Σ(daily average work time*workdays that week) over first 20 percentage of users in table)/(Σ(workdays that week) over first 20 percentage of users in table);

mid 60 percentage of daily average work time=(Σ(daily average work time*workdays that week) over 20-60 percentage of users in table)/(Σ(workdays that week) over 20-60 percentage of users in table);

last 20 percentage of daily average work time=(Σ(daily average work time*workdays that week) over last 20% of users in table)/(Σ(workdays that week) over last 20% of users in table); (above list of users can also be grouped based on attributes of interest and their Work Patterns compared);
above list of users can also be grouped based on attributes of interest and their Work Patterns compared. The example below is to compare daily average time on Activities based on user roles. It can be extended to any sort of groups and compared on one or more Work Pattern items;
   sort users into groups based on the ‘role’ attribute;
   for each group of users (who all have same role),

for each Activity, daily average work time on each Activity=(Σ(work time on the Activity) over all users in the group)/(Σ(workdays) over all users in the group);
comparing Work Patterns between sub-units, including at user level, based on various attributes of business interest. The sub-units can be a named list, next level sub units, sub units with a specific attributes;
   for sub-units of interest,
      prepare a sub-unit table with a row for each sub-unit;
      fill each row with sub-unit ID and the Work Pattern for the time period of interest;
      rank the sub-units by sorting based on various Work Pattern items;
      working examples:
      delivered capacity as a percentage of available capacity (this identifies the most busy and least busy teams);
      daily average of output.volume per user (rate performance);
      schedule.variance and effort.variance (track slippages and cost overruns);
done;

Table 10 summarizes an example of how to compute the work time for the organization sub-units for one week period.

TABLE 10

| | Org ‘Acme’ | | | | | | | |
|---|---|---|---|---|---|---|---|---|
| Weekly Table related to Work Time for each sub- | BU1 | | | BU2 | | | | Org |
| unit and the entire org for one week | Team 1 | Team 2 | BU1 | Team 3 | Team 4 | Team 5 | BU2 | Acme |
| Team size (at end of week): few users may have joined | 10 | 20 | 30 | 6 | 16 | 22 | 44 | 74 |
| or left midway through the week | | | | | | | | |
| Staffed Work Days this week: usually # week days for | 48 | 100 | 148 | 29 | 80 | 112 | 221 | 369 |
| whole team, except users joining/leaving midweek | | | | | | | | |
| Workdays this week: lower than Staffed due to public | 39 | 84 | 123 | 20 | 78 | 92 | 190 | 313 |
| holidays and vacations | | | | | | | | |
| Holidays this week: consists of weekends, public holidays | 29 | 56 | 85 | 35 | 34 | 68 | 137 | 222 |
| and vacations | | | | | | | | |
| Workday only Total Work Time that week: excludes | 274.5 | 634.2 | 908.7 | 125.3 | 478.3 | 535.1 | 1139 | 2047 |
| work done on holidays, vacations, weekends | | | | | | | | |
| Workday only Average Work Time: average daily | 7.0 | 7.6 | 7.4 | 6.3 | 6.1 | 5.8 | 6.0 | 6.5 |
| work hours on working days only | | | | | | | | |
| 7-Day Total Work Time that week: total of all daily | 292.6 | 634.2 | 926.8 | 132.4 | 499.0 | 535.5 | 1167 | 2094 |
| work hours including on weekends, public holidays, | | | | | | | | |
| vacations | | | | | | | | |
| Daily Average Work Time for the week: average daily | 7.5 | 7.6 | 7.5 | 6.6 | 6.4 | 5.8 | 6.1 | 6.7 |
| work hours after including work time on all 7 days | | | | | | | | |
| % Work done on Holidays: high % means too much | 6.2% | 0.0% | 2.0% | 5.4% | 4.1% | 0.1% | 2.4% | 2.2% |
| work being done on weekends, public holidays, vacations | | | | | | | | |
| Delivered Capacity as % of Available Capacity: | 94% | 94% | 94% | 83% | 80% | 73% | 77% | 84% |
| shows how busy the user is, and if they can achieve more | | | | | | | | |
| Available Capacity as % of Staffed Capacity: shows | 81% | 84% | 83% | 69% | 98% | 82% | 86% | 85% |
| impact of holidays and vacations which is often not | | | | | | | | |
| considered during planning | | | | | | | | |

It can be inferred from the above table that:
BU1 has a higher daily average work time of 7.5 hours compared to BU2 (6.1 hours);
BU2 has a higher need for a headcount, and it may be possible to reassign people from BU2 to BU1;
Teams 1 and 2 in BU1 have a similar daily average work time of 7.5 hours, but Team 2 achieves it on regular work days (work time on weekends and holidays is 0% compared to 6.2% for Team 1). Therefore, Team 2 shows more focused effort and has a better work-life balance index;
Team 5 in BU2 not only has the lowest daily average work time (5.8 hours) but also shows 0% work on weekends and holidays. This clearly shows that the team is underutilized (77%); and
Team 3 in BU2 had a large number of user vacations (69% of staffed capacity was available).

In an embodiment, the daily average work time at sub-unit (team) level is based on the seven-day work time put in by the team divided by their total number of workdays. While their work hours on weekends, public holidays and vacations are included in the total, those days are not counted in the work day count. Therefore, if the team has put in work hours on holidays, they get credit for it with a higher daily average.

An organization predictor and instructor module 462:—The organization predictor and instructor module 462 receives the plurality of sub-unit Work Pattern items. The organization predictor and instructor module uses optimized, automated and adaptive learning. The organization predictor and instructor module 462 selects the appropriate sub-unit Work Pattern items, from the plurality of sub-unit Work Pattern items, for tracking each sub-unit based on the nature of each sub-unit. The organization predictor and instructor module 462 provides a feedback to a manager on highlights and weak areas related to a sub-unit work effort, a sub-unit work output, a sub-unit workload assignment and a sub-unit staff allocation for each sub-unit. The organization predictor and instructor module 462 suggests areas of improvements for each sub-unit and tracks progress of each sub-unit using adaptive learning. Further, the organization predictor and instructor module 462 sets goals for improving a sub-unit work effectiveness index and a sub-unit productivity for each sub-unit. The organization predictor and instructor module 462 suggests recommendations about the best practices for each sub-unit, predicts delays in projects timelines, effort and cost overruns, inability to meet output target, and the impact possible with the improvements. The organization predictor and instructor module 462 predicts the improvements in the sub-unit work effort, the sub-unit work effectiveness index, the sub-unit work output and the sub-unit work life balance index for each sub-unit. The organization predictor and instructor module 462 predicts delays in project timelines, effort and cost overturns, inability to meet output target and, the impact possible with the improvements. The organization predictor and instructor module 462 generates intelligent reports for improving (optimizing workforce and operational efficiency) operational effectiveness and a talent management in each sub-unit.

In accordance with another embodiment of the present invention, the organization predictor and instructor module employs the correlation between the sub-unit Work Pattern items and the sub-unit work output to:
provide feedback to managers about the sub-unit Work Pattern items that impact sub-unit work output; and
make recommendations to improve the sub-units performance.

A pseudo-code for selecting the appropriate sub-unit Work Pattern items, from the plurality of sub-unit Work Pattern items, for tracking each sub-unit based on the nature of each sub-unit, in accordance with an embodiment of the present disclosure, is now described.
after the weekly Work Pattern for the sub-unit becomes available for a week or more, then
   based on the composition and nature of the work of the users in the team, decide the high level work effort parameters that should be tracked for the team:
      a benchmark reference for each role can be set by the organization, or it can be set to the initial Work Pattern of the top 20 percentage in the sub-unit of which the user is a part and/or of users that have the same role attribute;
   if the sub-unit consists of users who are mostly
      office workers required to do most of the work on a CS of type PC, then track the online work time, percentage of core activity time, time on email;
      a field of sales people then track work time, percentage of collaboration work time, and time on work related call and travel activities;
      if it is a mixed sub-unit, then top level analytics should focus on delivered capacity as percentage of available capacity, while team level analytics should be at lower levels of the sub-unit where the user composition is more uniform;
   if the organization provides work unit related information at the user level then, track work output parameters: output.volume, output. schedule variance, output. effort variance

A pseudo-code for providing the feedback to the manager on highlights and weak areas related to the sub-unit work effort, the sub-unit work output, the sub-unit workload assignment and the sub-unit staff allocation for each sub-unit, in accordance with an embodiment of the present disclosure, is now described.
the discussion below assumes that the sub-unit consist mostly of desk workers and team leads and managers who may spend less time on the PC but constitute only 5-10 percentage of the team;
   at the start of each week, month and quarter, review the key Daily Average Work Pattern items to be tracked for the sub-unit;
   in the first week, provide a rating for key parameters as below:—
      online work time—
         too high if >9 hours,
         high if 7-9 hours,
         good if between 5.5 to 7 hours,
         if 4 to 5.5 hours, and
         too low if <4 hours.
      (top 20 percentage to mid 60 percentage of online work time gap)—
         too high if >2 hours,
         high if 1-2 hours,
         good if between 0.5 to 1 hour, and
         very good if <0.5 hour.
      percentage of core activity time—
         too high if >90%,
         high if 70-90%,
         good if 50-70%,
         low if 25-50%, and
         too low if <25%.
      percentage of collaboration work time
         too high if >90%,
         high if 70-90%,
         good if 40-70%,
         low if 25-40%, and
         too low if <25%
   select 2-3 of the most appropriate parameters from the above list, provide a sub-score to each parameter, and add up for an overall sub-unit time effectiveness score on a scale of 0-10. It is easier to track a single score instead of a number of different parameters. The exact scoring system can be adapted to the organization and types of sub-units;
   sub-unit time effectiveness (0-10)=sub-score 1+sub-score 2+sub-score 3, where,
      sub-score 1: 4 points for good rating in online work time (5.5 to 7 hours), reducing proportionately to 0 points from 7 to 9 hours or from 5.5 to 4 hours, and 0 points for >9 hours and <4 hours;
      sub-score 3: 3 points for very good rating in top 20%-mid 60% online work time gap (<0.5 hour), reducing proportionately to 0 points from 0.5 hour to 2 hours, and 0 point for >2 hours;
      sub-score 3: 3 points for good rating in % core activity time (50-70%), reducing proportionately to 0 points from 70% to 90% or from 50% to 25%, and 0 points for >90% and <25%;
   work output parameters (output.volume, output. schedule variance, output. effort variance) if available, are best viewed as independent parameters, which should get better as the sub-unit time effectiveness score improves;

A pseudo-code for suggesting areas of improvements for each sub-unit, tracking progress of each sub-unit and setting goals for improving the sub-unit work effectiveness index and the sub-unit productivity for each sub-unit (goal setting and progress tracking for time effectiveness parameters), in accordance with an embodiment of the present disclosure, is now described. The example is for a sub-unit largely comprising online desk workers;
in the initial weeks,
   if online work time is low, then
      set a goal for the sub-unit for higher online work time;
      if workload is low, then
         suggest to manager these options: advance planned completion dates, assign work backlog items to the team, let them explore new skills and innovative ideas;
         if manager confirms that workload is not going to increase soon, suggest releasing some of the staff to other sub-units with similar work and higher load;
   if (top 20%-mid 60% online work time gap) is high, then
      set a goal for the sub-unit for a lower (top 20%-mid 60% online work time gap;
      suggest review of workload assigned to sub-unit staff;
      assign staff members to take on routine work from the top 20% who have excess workload;
      ensure that your best talent can move to more challenging work, while transferring and helping other staff members to take on some of their routine work;
      publish list of backlog work that staff can volunteer for if they have the time, and recognize their proactive contributions;
      if not anonymous mode, then review why each individual in the last 20% has a low level of work engagement;
   if percentage core activity time is low, then
      check if time on meeting and communication is high, and set goals for lower time on meeting and communication activities;
      arrange for training on efficient email and meeting practices;
   if online work time and percentage of core activity time are both good, then
      if sub-unit is not able to complete work on time or work unit volume data is available and sub-unit's volume is low relative to expectations, then
         recommend the following to the sub-unit manager:—
         training, mentoring, re-assigning work based on capabilities;
         review of expectations regarding deadlines and volume, and to either make them more realistic, or ask for more staff to meet the goals;
         if not anonymous mode, then replace some of the consistently low performers;
      else (if sub-unit is doing well on all work parameters, then manager can take steps to motivate and elevate talent)
         recommend the following to the sub-unit manager:—
         more challenging work for the sub-unit;
         release a few high performing sub-unit members to more challenging assignments in other sub-units and replace with less experienced and lower cost staff as replacement;
         explore opportunities to encourage sub-unit staff to improve their work life balance;
         if unaccounted time in office is >1 hour, then recommend sub-unit users to review their data and reduce time spent in office;
         if work time on holidays is >0.5 hour, then recommend users to complete the work during work days;
         if work done at home on workdays marked as work from home is >0.5 hour, then recommend users to complete the work in office instead;
   sub-unit goals must be set to be incrementally higher than the current trend to ensure that it is achievable with modest effort;
   depending on the organization preference, sub-unit users may be permitted to review and change the goals that have been set by the manager;
   organization may also set a fixed goal for its employees for certain Work Pattern items as a challenge, which the user may accept;
   for each goal that is set, the manager discusses best practices that can help users individually and the sub-unit collectively to meet these goals and improve overall performance (for example, take the practice of focus hour during which the user blocks distractions related to email and phone, avoids breaks and personal browsing. By having the entire sub-unit practice this in the same hour of the day, it benefits everyone since many of the distractions often tend to be from colleagues in the same sub-unit);
   goal setting and feedback is provided to the manager via the gamification module as follows:—
      for each goal that is set, informs the manager about how the sub-unit's current trend compares with that of other sub-units (average and top 20%);
      manager gets a weekly and monthly summary of goals set, current weekly or monthly average of the Work Pattern items, change since last week or month, average and top 20% trends of peer sub-units;
      if not anonymous mode, then manager gets a list of
         top few best performers and few of the lowest performers;
         count of users who have set personal improvement goals and accepted any organization challenge;
         users who won badges won for the organization challenges;
      if sub-unit's work output parameters are available, then the weekly and monthly summary includes output.volume, output.schedule variance, output.effort variance, and comparison with last week and month;
fine tune the goal's based on the sub-unit's progress;
   after a few days and weeks (adapting the goal based on sub-unit's progress),
      if the sub-unit is consistently failing to meet the goal that has been set, the goal can be made simpler or changed to a different goal that is related but easier;
      if the sub-unit consistently achieves the goal for few weeks, it can be changed incrementally to the desired optimal value;
      once the sub-unit achieves and is able to maintain the desired optimal value, a different Work Pattern item can be selected for improvement;
   Use adaptive learning to incorporate or change goals based on their correlation with user's work output:—if work output parameters like output.volume, output.schedule variance, output.effort variance are available, then for each of the key Work Pattern items (online work time, top 20%-mid 60% work time gap, % core activity time, % collaboration work time) correlate the Work Pattern item with each output parameter as below,
      output−effort correlation index=Pearson correlation coefficient, for daily average output parameter and Daily Average Work Pattern item;
      if correlation is positive for a majority of the available work output parameters, then
         if the Work Pattern item is not being used as goal, then consider setting as improvement goal for it;
      else
         If the Work Pattern item is being used as goal, then stop the process;

A pseudo-code for predicting the improvements in the sub-unit work output, the sub-unit work effectiveness index and the sub-unit work life balance index for each sub-unit, in accordance with an embodiment of the present disclosure, is now described.
for each set goal, predict the improved work output (goal may require either an increase or reduction in the current trend value depending on the Work Pattern item, hence the improvement ratio will be different in two cases);
   if goal>sub-unit's current daily average for the Work Pattern item, then improvement target ratio=[goal/(current daily average)];
   else improvement target ratio=[(current daily average)/goal];
   for each output parameter,

predicted output parameter=current output parameter*improvement target ratio*[(output−effort correlation index) for that Work Pattern item and output parameter];
derive the maximum predicted work output if the sub-unit were to achieve the ideal value for the Work Pattern item;

if ideal daily average>sub-unit's current daily average for the Work Pattern item, then improvement target ratio=[ideal/(current daily average)],else improvement target ratio=[(current daily average)/ideal];

for each output parameter, predicted maximum output=current output parameter*improvement target ratio*[(output−effort correlation index) for that Work Pattern item and output parameter];
done;

A pseudo-code for predicting delays in project timelines, effort and cost overturns, inability to meet output target and, the impact possible with the improvements, in accordance with an embodiment of the present disclosure, is now described.
predict if Purpose timelines and output goals will be met, and if not, what are the likely dates and output;
instruct how necessary steps can be taken to meet targets and the impact on cost;
for each purpose,
   if output.schedule variance is available, then

planned duration=Purpose end date−Purpose start date;

percentage of variance=(output.schedule variance)*100/(Purpose end date−today);

projected end date=purpose start date+(planned duration)*(% slippage);(the projected end date may be earlier or later than purpose end date, based on whether the variance is positive or negative);
if output. effort variance is available, then

percentage of variance=(output.effort variance)*100/(planned effort);

projected effort=planned effort+(planned effort)*(percentage of variance);(the projected effort may be higher or lower than the planned effort, based on whether the variance is positive or negative);
if output.volume is available, then

percentage of output completion=(output.volume)*100/(planned output);

days required to reach planned output=(today−purpose start date)(100−percentage of output completion)/(percentage of output completion);

projected end date=today+days required to reach planned output;
the above calculations assume continuity in existing staffing and productivity.
for Purposes projected to get delayed, highlight how improving existing capacity utilization can reverse some or all of the delays;
   if projected end date>planned end date, then
      capacity utilization=delivered capacity as percentage of available capacity;
      assume capacity utilization is presently c1%;
      assume max capacity utilization=c2% (since realistically improvement to 100% may not be possible, c2 may be assumed as 85% as an example);
      if c1%<c2%, then if it improves to c2%, then

gain in days possible=(c2−c1)*(projected end date−today)/c2;

possible new end date=projected end date−gain in days possible;
if possible new end date<planned end date, then improving c1% to a lower c3% will restore the planned end date, where

c3=c1*(projected end date−today)/(planned end date−today);
possible new end date=planned end date;
else (if c1% is already high and more improvement is unlikely, then add more headcount that needs to be added to the Purpose to meet deadline or output. This is computed below, but this can be further enhanced to find out which roles to add headcount too based on role-wise utilization levels)

assume current headcount=x;

additional headcount needed=x*(projected end date−planned end date)/(planned end date−today);

average daily cost per employee=(Σ(salary per day) over all users in the purpose)/(total number of users in the purpose);

cost increase=(additional headcount needed)*(planned end date−today)*(average daily cost per employee);
for Purposes that are ahead of schedule, there can be cost savings either by early completion, or it may be possible to reassign some headcount to other Purposes that need more people as computed below. This can be further enhanced to find out the roles where transfers are possible based on role-wise utilization levels;
   md if projected end date<planned end date, then

assume current headcount=x;

headcount that can be transferred=x*(planned end date−projected end date)/(planned end date−today);

average daily cost per employee=(Σ(salary per day) over all users in the purpose)/(total number of users in the purpose);

cost reduction=(headcount that can be transferred)*(planned end date−today)*(average daily cost per employee);

average daily cost per employee=(Σ(salary per day) over all users in the purpose)/(total number of users in the purpose);
done.

A pseudo-code for generating intelligent reports for improving (optimizing workforce and operational efficiency) operational effectiveness and a talent management in each sub-unit, in accordance with an embodiment of the present disclosure, is now described.
The organization predictor and instructor module adaptively learns each user's Work Patterns throughout the day; generates long term trends over weeks and months; aggregates and analyses the users in any grouping of sub-units and organization levels. This data and analysed information creates the foundation for intelligent reports that can forecast and guide major areas of operational, people and even strategic aspects of the business.
I. new position and attrition backfill approval and internal options:
   on weekly basis, or as requested,
      for every position to be filled either as a new request or replacement for an exit in a sub-unit;
         verify delivered capacity as % of available capacity over past 3 months for all users in that sub-unit and with any available user attributes (example, role, location, skills) that match the job profile;
         if delivered capacity<75% of available capacity for the user group, then do not approve hiring request;
         else
         for every other sub-unit, or from a list of eligible sub-units provided, compute the delivered capacity as % of available capacity over past 3 months for the sub-unit's user group that match the job profile's user attributes;
         if <75%, then add the users to the list of internal eligible candidates;
         from the probable list, pick top few candidates based on the best fit with transfer criteria defined by the organization, such as a) candidates who have requested for a transfer and been in their current sub-unit for at least two years, b) newly hired in past 3 months, and c) those named in the flight risk report;
         if no users are found, then approve the request;

average daily cost per employee=(Σ(salary per day) over all users in the sub-unit)/(total number of users in the sub-unit);

cost reduction for the sub-unit by not hiring=(hiring requests denied or fulfilled internally)*(average daily cost per employee);
done;
II. hiring Plan—identify which sub-units, roles, skills and locations required more staffing
   on quarterly basis, or as requested,
      set threshold of delivered capacity as percentage of available capacity to T % (T % is based on what the organization considers to be the optimal capacity utilization, the guideline being that at least 20% of the organization (users or sub-units at a particular level) should have capacity utilization above T %);
      for each relevant parameter type,
         create a separate list by type (e.g. sub-units, user roles, locations), each row of the list consisting of instance name and hiring count, and as many rows as the named instances;
         for each parameter type and named instance in that type
         if delivered capacity is >T % of available capacity over past 3 months for the users in the type and instance, then

hiring count for the instance=(delivered capacity %−T %)*(count of qualifying users in the instance);
add the instance and hiring count to the parameter type list;
hiring count for the parameter type=Σ(hiring count for the instance) over all named instances in the list;

The organizations may also hire based on an annual target, which may be for new campus recruits or hires in specific roles in high demand. They want to know which sub-units at a certain level (such as division, project, team), either all or a named list, to best fit with them.
list eligible sub-units
   for each role amongst the new hires;
      let new hire count in that role=R;
      for each sub-unit, determine the delivered capacity as % of available capacity for past 3 months for the role in each sub-unit

allocation weight for sub-unit=(delivered capacity as % of available capacity)*(user count in that role);
total allocation weight=Σ(allocation weight for sub-unit) over all sub-units;
for each sub-unit,

new hire headcount in that role to be assigned to the sub-unit=(allocation weight for sub-unit)*R/(total allocation weight);
III. sub-unit and shift optimization—move employees between related sub-units or between shifts based on relative workload;
   on quarterly basis, or as requested,
      review delivered capacity as % of available capacity for sub-units or as per shift timings for past 3 months;
      redistribute staff from consistently low workload sub-units or shifts to high workload ones;
      redistribution is possible provided the sub-units and shifts have similar staff in terms of roles and skills;
      candidates can be selected for transfer based on organization criteria such as a) candidates who have requested for a change and been in the current sub-unit for some time, b) those who have recently joined, and c) those named in the flight risk report;
      consider a sub-unit 1 or shift 1 with low capacity utilization (delivered capacity as % of available capacity) and/or where significant reduction in workload is expected. The feasible reduction in the user count to ensure better utilization and lower cost, is estimated as follows:
         capacity utilization=(delivered capacity as % of available capacity);
         assume capacity utilization is C1%;
         present user count is N1;
         desired new capacity utilization is C1_new %;

estimated count of users to be transferred=X=(N1−N1*C1/C2);
the actual impact on utilization may depend on the capacity utilization levels of the users selected for transfer. Moving highly utilized users out will result in a lower increase in the sub-unit or shift's utilization, or even reduce it, unless other users pick up the work being done by the transferred users;
hence X is a guideline. It is better to move fewer users, have a mix of users having different utilization levels, and proper transfer of their work to others.
consider a sub-unit 2 or shift 2 with high capacity utilization and/or where significant workload increase is expected. If Y users are to be added from other sub-units or shifts, or as new hires, the impact on capacity utilization is as follows:
   assume capacity utilization is C2%;
   present user count is N2;
   new users added are Y;

in theory, the new utilization may reduce to C2_new=C2*N2/(N2+Y);
in practice, the actual reduction in utilization will be higher initially, until the new users start contributing effectively and workload increases;
hence Y is a guideline, and new users should be added carefully to avoid a cost increase without the revenue impact from greater output;
done.
IV. talent efficiency map—compare output or manager rankings with effort to get insights into your talent base;
   on quarterly basis, or as requested,
      create an X-Y graph with X-axis as daily average work time for required time range;
      split the graph into 9 parts as follows:
         X-axis is partitioned at 5 hours and 7 hours;
         if output.volume is available at user level, then
         Y axis is the daily average output.volume;
         Y axis is partitioned at 40% and 70% of the mean of the top 5% output.volume values;
         else
         Y axis is the manager ranking of users;
         Y axis is partitioned at average and below, and very good and above rankings;
      users are mapped onto the graph based on their daily average values or manager rankings;
      the 9 areas in the graph provide the following insights regarding the users:
      high effort and volume or ranking—engaged high performers;
      modest effort and high volume or ranking—potential stars capable of meeting bigger challenges;
      low effort and high volume or ranking—potentially valuable employees but over skilled and at the risk of attrition, or in the case of ranking may represent an anomaly;
      high effort, modest volume or ranking—engaged employees but results are modest—they may be new to the job or can benefit from some coaching;
      modest effort, modest volume or ranking—employees who perform only adequately, and are either senior or less motivated or not very job oriented. can benefit from more attention and motivating them with work they prefer;
      low effort and modest volume or ranking—employees who can contribute better but may not have been given enough work, or need to understand reasons for disengagement;
      high effort, low volume or ranking: bad job fit or new employee, and potential anomaly in case of ranking;
      modest effort, low volume or ranking—coachable employee who will improve with help from supervisors;
      low effort, low volume or ranking—employees need to be put on a performance plan;
      done.
V. flight risk—employees whose Work Patterns show possible attrition risk; (by analysing the user's Work Patterns over last few weeks, it is possible to infer whether the employee is getting disengaged at work. For example, if the user's daily average work time may be steadily reducing relative to that of the team, and there are other signs such as more vacations and work from home days. Users in this list have a greater probability of eventually resigning, though some of them may have other reasons such as family issues or emergency of some kind which usually the manager will be aware of);
   on monthly basis, or as requested,
   estimate average attrition in the past 6 months by counting the users who are no longer part of the organization;
   let the past user attrition count=N;
   set engagement reduction=R=60 minutes;
   repeat the flight risk analysis until DONE;
      for each user in lowest level sub-units;
      check if (weekly average of work time of user−weekly average of work time of sub-unit) shows a steady decrease for past 12 weeks;
      if there is no pattern of reasonably steady decrease, then exit to next user;
      if the total reduction over past 12 weeks is <R, then exit to next user;
      if yes, then
         if (count of vacations and work from home days) in past 12 weeks is 20% higher than in previous 12 weeks, then
         add to the list of users in the flight risk table
         else exit to next user;
      if count of employees in the flight risk table is >4*N, then increase R by 10 minutes;
      if count of employees in the flight risk table is <1.5*N, then reduce R by 10 minutes;
      if count of employees is between 1.5*n to 4*n, then mark flight risk analysis as ‘done’;
   provide the flight risk table;
   done.
VI. overtime—payment only if work during regular hours was adequate;
   on monthly basis, or as requested,
      the following definitions can be provided at the server:
         expected physical time in office=expected_office_time;
         minimum expected work time in regular office hours=min_work_time;
      for each user eligible for overtime,
         for each workday in the required time range,
         if (work time<min_work_time) or (physical time in office<expected_office_time), then
         no overtime that day;
         else
         eligible overtime that workday=(physical time in office−expected_office_time);
         add workday and eligible overtime in user_overtime_table−publish user_overtime_table for all users;
   done;
VII. optimizing cost of software assets by knowing exact usage of software licenses:—The organizations invest significantly in software license fees, as a recurring cost of subscription or annual maintenance fees. They are usually able to keep track of licenses purchased and deployed, but often cannot verify the actual usage. The users may stop using particular software for various reasons, including because they left the company, they may uninstall without informing the administrator, and PC's where the software is installed may be re-formatted. This report fills that gap and enables the organization to know the exact usage of licenses, and thereby reduce costs by only renewing the required number of licenses each year.
   on quarterly basis, or as requested,
      at organization level,
         for each user for past three months;
         get all application names (pc and web) being used and usage times;
         analyse the above and generate a table consisting of one row per application name;
         for each application name,
         determine total count of users and total time usage;
         compare total count of users against the paid licenses;
         if (paid licenses>count of users) then
         reduce the licenses renewed;
         else
         increase the number of licenses;
         done.

In accordance with an embodiment of the present disclosure, a recognition and rewards module assigns performance points to users and sub-units based on the individual and aggregate effort and completed work units.

In accordance with an embodiment of the present disclosure, a web user interface 430 is configured to facilitate views at each level of the organization hierarchy across Work pattern items. The web user interface 430 is further configured to selectively filter and drill down to generate and compare discrete effort data for any Work Pattern item across any business attribute. The Work Pattern items are selected from the group consisting of effort, habits, effort distribution across Purposes, Activities, applications and work units, work life balance index, capacity utilization, and work effectiveness index. The business attributes are selected from the group consisting of role, skills, salary, position, and location for the user, and from the group consisting of domain, vertical, cost and profit center, and priority for the organization sub-unit.

In accordance with the present disclosure, the server effort map unit 408 is the module in which the various effort maps of each user, such as from one or more CS belonging to the user, servers shared by multiple users, and the offline PD effort map, are merged to generate a final user effort map for every user. Effort maps of all users are stored in the server effort map database 406.

In most embodiments, the PD interface 412 periodically obtains or receives information about the user's offline time from various PDs and PD servers. For example, business calls made from user extensions can be sourced from EPABX and VOIP server logs, and directly from user mobile phones. Time spent in specific office areas based on swipe and biometric devices at office entry/exit points, labs, conference rooms, can indicate the work timings and nature of work. Location detectors, GPS and smartphones can be used to identify work related travel and time spent in remote meetings at customer and vendor offices. The PD interface 412 prepares an offline effort map for each user and makes it available to the server effort map unit 408. The offline time is mapped to default Activity and Purpose as per the offline mapping rules obtained from the organization settings and rules engine 416.

In some embodiments, the PD interface 412 may also obtain calendaring information for all the users by connecting directly with the organization's calendar server, in addition to or instead of calendar inputs from each user CS agent 300 as discussed earlier.

In some embodiments, the PD and the CS agent 300 may be the same device. For example, the user's smartphone or tablets track online activity as well as calls made, travel and remote visits.

The present disclosure provides for exact effort and time productivity measurement at enterprise level by way of an organization sync agent 404 to collect the list of valid users and organization hierarchy that map each user to one or more organization units, wherein users can be grouped along multiple hierarchies, for example corresponding to functions, services lines and locations. For this purpose, the organization sync agent 404 interfaces to an appropriate organization application server or data store to periodically collect and update the list of valid users and organization hierarchy. This information is stored in the organization settings and rules database 418.

In a few embodiments, typically in small organizations, the information related to users and hierarchy may be available on an Excel or similar file and can be directly imported. In other embodiments, the organization sync agent 404 has to be configured and adapted to source the information automatically from the ERP application or database, and subsequently to maintain its consistency by updating as per the changes made in the ERP.

In some embodiments, the organization sync agent 404 also collects business attributes qualifying each employee and organization sub-unit (such as roles, skills, compensation for employees, and verticals, technologies, cost and profit centers for sub-units), that may be available from one or more existing organization application data stores (such as HR and ERP applications and databases). This information too is maintained in the organization settings and rules database 418.

In accordance with the present disclosure, the organization settings and rules engine 416, along with the organization settings and rules database 418, maintains a list of allowed privileges and access rights that regulate the ability of each user and manager to access the effort data based on their position and role. An organization specific list of Activities and Purposes can be derived from the organization hierarchy (which represents projects and functions) and business attributes (which determine the relevant Activities for a particular type of organization and its sub-units). This can be a single or multi-level Activity and Purpose master list (not shown in figures) from which a subset of Activities and Purposes are assigned at various organization levels, which can be further edited by the respective managers subject to access and permission rights. The organization settings and rules engine 416 defines the rules for mapping of time on various online applications and offline work such as meetings, business calls, lab work, travel, to the default Activity and Purpose, which can be further modified at manager level and ultimately by each user down the organization hierarchy. This has been described in detail while covering the functionality of the rules and pattern mapping engine 314 on the CS agent 300. Further, the organization settings and rules database 418 stores various configuration parameters for the organization such as locations, public holidays, work week, roles and their privilege levels and view access rights, data privacy requirements regarding individual data visibility, options to enable anonymous and self-improvement modes, blocking of file and URL information, frequency of user effort map data update, and so on.

The organization effort aggregation and analytics engine 414 accesses the per-user effort maps from the server effort map database 406, and performs aggregation, averaging and analytics of individual effort across the entire organization hierarchy (which may be single level or multiple as in the case of matrix organizations) available from the organization settings and rules database 418. It produces trends, reports, goal compliance, alerts and rewards notifications responsive to the exact effort data across Purposes, Activities, applications, artifacts and business attributes. The analysis results are stored in the n-dimensional organization effort database 410. The analytics engine is also available to users for defining and generating custom reports.

In accordance with the present disclosure, the server includes a blocker (not shown in figures). The blocker is cooperating with the CS agent. The blocker is adapted to control third party access to individual level data by restricting the access to the individual level data based on the organization hierarchy and as per assigned access rights. The blocker is further adapted to block individual data visibility of certain users based on their role or seniority in the organization. The blocker is still further configured to block individual data visibility entirely. The blocker is still further configured to block organization sub-unit visibility if a user count computed for the organization sub-unit is below a predetermined user count.

The systems and methods of present disclosure support extensive analytics. The organization effort aggregation and analytics engine 414 derives a per-employee daily average of Work Pattern. This is a powerful metric that facilitates meaningful and direct comparisons between any two or more organization sub-units of any type, including individual employees. Various trends and reports are available to compare the average daily productive time across various Purposes, Activities, applications, artifacts, online and offline time distribution, work focus, breaks taken, capacity utilization and so on. The reports and trends are available on daily, weekly, monthly or cumulative basis over a specified time range, or during the project or organization lifecycle phases. The differences in the trends between the Top 20%, Middle 60% and Last 20% of organization sub-units can also be viewed, thereby encouraging others to emulate the performance of the Top 20%.

In accordance with the present disclosure, the per-employee daily average of Work Pattern is computed for a requested organization sub-unit for the specified time range, by aggregating the Work Pattern of each employee in the sub-unit for every calendar day in the duration of interest, and dividing this by the sum of actual working days for each employee in the duration. Determining exact working days requires inferring and accounting for the various complexities such as whether each employee joined or left the sub-unit during the applicable period, any work was done for some time for other sub-units, holidays and vacations taken, if any work was done when on holiday or vacation, public holidays at each user's location, and employee role—whether desk job or travel oriented work, changing shift timings, fixed or variable work week, and so on.

In most embodiments, the underlying analytics engine is also made available to user for definition and generation of custom reports by selecting the parameters to be viewed and compared against, filters for selecting a subset from a range of the parameters, in which the parameter refers to any data item that is automatically tracked (for example online and offline time, applications, files, folders, websites, business calls, travel), mapped (such as Activities, Purposes), and collected from existing organization application data stores (such as users, organization sub-units, projects and functions, and business attributes such as employee levels, roles, skills, locations, verticals, technologies, cost centers), along with the ability for statistical analysis based on totals, averages, maximum and minimum values, standard deviations and others. The analytics engine operates on the information stored in the n-dimensional organization effort database 410.

In some embodiments, the open data exchange framework in the organization sync agent 404 can be extended for sharing data with third party applications for project management, performance tracking, HR systems for appraisals and vacation reports, engineering software for quality, finance for costing and budgeting, hardware and software resource management and the like. Such information sharing from/to the third party applications leads to more accurate and insightful reporting on performance, quality, people capability, project costing and resource usage.

The system envisaged by the present disclosure provides for a web user interface 430 that is accessed using any standard internet browser or standalone web applications. It enables users to view trends, reports, set goals, alerts, goal compliance, and performs administrative functions. Depending on the employee's role and position in the organization hierarchy, and as per permitted access rights, the user can view data at a certain level, and then selectively filter and drill down to generate and review discrete effort data at the level of sub-unit and individual employees.

The reports generated by the system of the present disclosure give employees the ability to improve their work-life balance, focus on key activities, avoid distractions, and overall deliver the expected work effort. Managers can reduce micro-management and spend more time on planning and strategy, since team effort can now be readily tracked. They can verify that Daily Average work time is reasonable, and that the team is sufficiently engaged in the core activities required in that period. They can assess how the middle 60% and Last 20% are faring relative to the Top 20%. They can analyse historical data for root cause analysis of delays and quality issues, and improve future delivery by identifying the current gaps and proactively suggesting required improvements.

Senior executive management can get precise insights into effort spent on revenue earning work versus other tasks. Capacity utilization reports can be used to optimize staffing. Stress and burnout can be reduced by identifying teams and projects where there is sustained over-utilization. Teams displaying low capacity utilization can increase their effort, leading to better quality results and on-time delivery. Profitability can increase in teams that are performing well but have excess capacity, since some of the employees can be re-assigned to new projects. Embodiments of the disclosure also provide detailed capacity breakup by verticals, technologies, projects, functions, initiatives, locations, employee levels, and roles. The present disclosure therefore provides a powerful tool that can boost overall revenue and profitability by plugging wasteful effort and reducing under-utilization of capacity in every dimension of the business.

The present disclosure motivates employees and managers to try and achieve higher productivity, increased output, and improved capacity utilization, by setting improvement goals. Towards this end, some embodiments provide an alert, goals and rewards module in the web user interface 430. A manager can define one or more goals related to Work Patterns for an organization sub-unit or specific individuals, resulting in an alert for the concerned individual or manager or both in case the goals are not met. As an option, the alert can be used to grant reward points if the effort is a positive effort. For instance, if the productive hours for a user are less than expected hours for several days, then an alert can be raised to the individual and the manager. Further, if the productive hours have been high, the employee can be granted reward points. Similarly, if the user is not delivering required effort as agreed, such as on a specific Activity, or if the user is offline for more than required number of hours per day, week or month, then an alert is raised to the employee, and optionally for the manager.

In some embodiments, a goal compliance report can be generated indicating the number of team members who met goals and indicating any deviations from the goals. Thus, the manager need not explicitly view effort related trends and reports, or even be present in the office premises, to track progress and work engagement levels of the staff. The goal compliance report readily provides the required summary.

In some embodiments, a recognition-and-rewards system and a social platform is provided to motivate individuals and organization sub-units towards higher performance based on performance points earned on goals achieved, ascending to higher level of performance, badges based on points earned at various performance levels, regularly showcase the best Work Patterns, top performers, and award winners at individual and organization sub-unit level, and allow users to socialize personal and team achievements.

In some embodiments, the individual can set self-improvement goals that can then be tracked on regular basis.

In some embodiments, unusual Work Patterns and any recent significant positive and negative deviations for any organization sub-unit are deduced by comparing with expected trends and by comparing recent and past behaviour. An exception report is generated with guidance on specific actions that can be taken to make corrections and drive improvements.

The web user interface 430 has an administration module that lets authorized administrators and managers to edit some of the information stored in the organization settings and rules engine 416, such as various organization parameters (locations, work week, public holidays at each location), the multi-level Purpose and Activity hierarchy, defining web applications using partial URLs that identify them, mapping of applications and PD offline to default Activity and Purpose, defining default alerts and goals, and specifying standard report templates. The administration module also lets the organization set its privacy policy regarding individual data, such as whether details or at least total time spent by users on personal work should be visible, parameters for the data filter such as whether user work related files and URLs should be visible, granularity of user data (real-time, daily, weekly, or monthly), whether access to individual time data should be blocked for selected managers, and enablement of anonymous or self-improvement modes.

In certain embodiments, where the organization structure and attributes may not be available elsewhere, an administrator can also directly add, edit and manage the list of users and the reporting hierarchy.

In some embodiments, the authorized managers have access to the administration module to re-structure their teams, select from the multi-level Activity and Purpose lists, add and edit mapping rules, and define custom reports.

According to a third aspect of the disclosure, administrative controls are provided that allow each organization to strike the desired balance between work effort visibility and respect for individual privacy. This is required since organizations have different work cultures and information security requirements, and must also comply with privacy laws in each of the countries that they operate in. The three main control parameters include marking user's private time, limiting the details of work time that are available to the organization, and restricting the ability to view individual work data.

In an embodiment, notably in industries where information security at work is paramount, the details of all the time during office hours and on office equipment is made available to the organization.

In most other embodiments though, visibility into users' personal time details is not available to the organization. It is further possible to exclude total time spent on personal activities during office hours, though the details are never available as noted earlier. Some embodiments provide the user with a user private time selector with which the employee's time tracking is temporarily but completely disabled for specified duration, and the entire time is marked as Unaccounted and Private. In embodiments, wherein all work is done within the office and in fixed office hours, the time selector can permit the user's time utilization to be tracked only within the office.

In some embodiments, the details of work time visible to the organization may also be restricted. The organization has the option to block access to certain work related information, such as applications and artifacts (files, folders and websites). In a few embodiments, instead of the accurate minute by minute time utilization, the organization can reduce the resolution of the user's work data that is available at the server from real-time to just daily, weekly, or monthly averages.

The present disclosure includes and hierarchical effort control module, wherein visibility of individual work data is as per the reporting hierarchy and according to the user's access rights. In some embodiments, only select managers are permitted to view the individual work data for their team members. In embodiments, visibility of individual effort data for senior staff (for example, directors, vice presidents, CXOs and board members) is blocked and not available to anyone in the organization.

In one embodiment, in order to comply with privacy laws of the organization or specific countries where they operate, the option of an ‘anonymous’ mode is provided. In this mode, the individual data visibility is completely blocked for the entire organization or for sub-units in certain geographies. It is possible to drill down only to team level trends provided the team has a certain minimum number of employees (so that an individual's Work Pattern cannot be guessed at).

In another embodiment, organizations can opt for complete individual privacy through a ‘self-improvement’ mode in which no user data is uploaded to the server 400. The organization can only define the hierarchy and attributes, mapping rules, and set goals for desired Work Patterns. Productivity improvements are achieved purely through self-awareness, wherein employees track their own Work Patterns as provided on the local CS. In a further variation, an employee may voluntarily allow aspects of the Work Pattern to be uploaded to the server anonymously, in return for being able to view the comparative trends across everyone who shared their data, and view their own relative performance. The voluntary Work Pattern sharing may be accompanied by identifying the user's profile, such as role, seniority, location, skills and so on, so that comparisons can be made with peers with a similar profile.

Typically, the employee always has full visibility to their own work and personal data on the local user interface 322 on their local CS. However, a few embodiments may not provide any local user interface capability to employees, and all time capture and mappings are entirely automated. Select administrators and managers can view trends on the server at team level, and optionally at individual level.

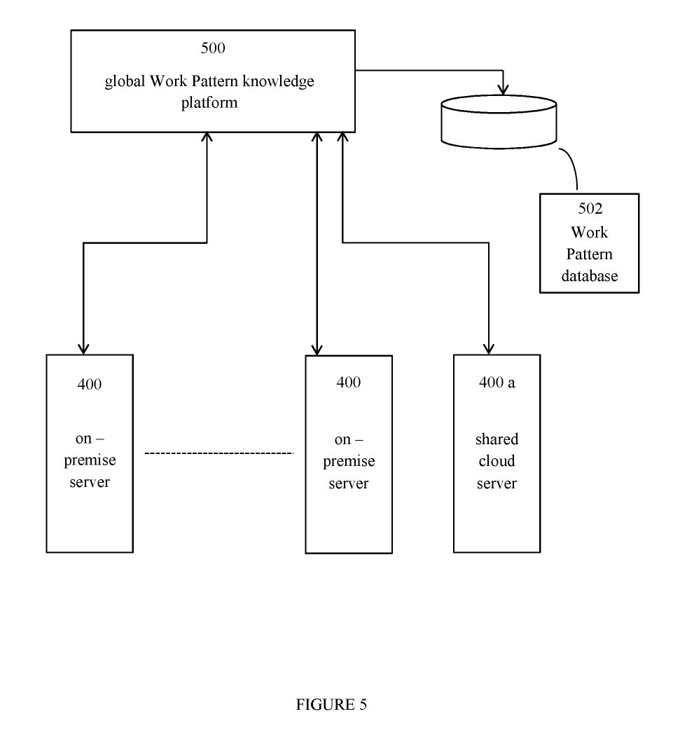

In the fourth aspect of the disclosure, as illustrated in FIG. 5 below, the disclosure specifies a global Work Pattern knowledge platform 500 in which organizations across various industries, verticals, countries, and scale, can participate by contributing their Work Pattern trends and analytics at a high level while retaining anonymity, and in return get feedback on how they rank relative to peer organizations selected based on criteria of interest. The global Work Pattern knowledge platform 500 may be on a separate server machine, or can be an extension to the cloud based server 400a which hosts all organizations that did not opt for an on-premise server.

A global Work Pattern knowledge platform Interface 432 is available on each server 400, catering to a distinct organization. The Web user interface 430 on the server permits an authorized administrator to sign up to the global Work Pattern knowledge platform 500 as a participating organization. A high level profile of the organization regarding its size, industry, vertical, and so on, is defined and uploaded to the global Work Pattern knowledge platform 500. The knowledge platform interface 432 on each server 400 communicates the organization's high level Work Pattern analytics and trends based on employee and sub-org categories. In turn, the organization can obtain reports that rate its performance and standing relative to peer organizations along selected profile criteria. All comparisons involve anonymity for the participating organizations. The individual Work Pattern information along with profiles for various contributing organizations is stored in a global Work Pattern database 502.

As described, the system envisaged by the present disclosure measures, analyses and improves the effort and time productivity of white collar staff. The key elements of the system envisaged by the present disclosure are as follows:

The system of the present disclosure captures all the work effort which in today's environment which may be at any time during the day (24 hours) and week (7 days). These include office workers spending most of their work time on computers, and marketing and sales staff making extensive business calls and travelling to customer locations. Systems and methods have been described to track the daily time spent by employees, irrespective of whether the time is spent on one or more computing devices, or away from any computing system while in meetings, discussions, calls, lab work, travel, and remote visits.

The captured individual work effort is mapped to the organization's hierarchy and business attributes. This organization data does not have to be manually defined or configured, but is also automatically collected from existing organization application data stores. As a result, it becomes possible to identify the Work Patterns and trends within each sub-unit and operational dimension of the business, and hence providing a powerful platform for enterprise wide effort and capacity optimization.

The requirements of employee privacy, organization culture, and the different privacy laws of countries where the organization may operate, are taken care of through a variety of methods and systems to prevent any access to individual personal time details, and provide individual work data visibility only to the extent appropriate, including the option of voluntary sharing of work trends by employees.

Finally, the present disclosure provides a global Work Pattern knowledge platform, wherein organizations across various industries, verticals, countries, and size, can participate by contributing their high level Work Pattern trends and analytics, and in return get feedback on their rating relative to peer organizations, with anonymity assured for all participants.

### Technical Advantages

The technical advantages of the present disclosure include the realization of the following:
providing an intelligent and highly automated system to measure, record, analyse, report and improve the work effort put into various Activities and Purposes for an organization by individuals, teams and organization sub-units assessed as per the organization hierarchy and related business attributes;
providing a system that automatically determines each employee's effort throughout the day (24 hours) and week (7 days), whether performed online on one or more Computing Systems (CS), and offline such as for meetings, lab work, calls, outside travel, and remote visits. This effort is mapped to Activities and Purposes relevant for the organization;
providing a system that automatically tracks the exact time spent by the employee on one or more personal CS, any CS shared with other users through a common login, and remote servers (even if the servers do not belong to the organization), by determining the user's time on the currently active application and associated artifacts such as files, folders, websites and other artifacts related to the applications;
providing a system that automatically detects whenever the user is away from any CS, and mark this time as offline time on the CS;
providing a system that merges the user's online and offline time information sourced separately from one or more CS, and PDs and PD servers, for a consolidated view of the user's time utilization on applications and related artifacts and offline on meetings, calls, lab work, travel, remote visits and so on;
providing a system that intelligently deduces and maps each online and offline time slot to the most appropriate Activity and Purpose from a hierarchy of possible Activities and Purposes assigned to the employee from a master list for the organization, based on applications and artifacts in case of online time slots, and for offline slots from information obtained from calendaring systems and various PDs (Presence Devices) and PD servers that indicate if the user was busy in meetings, calls, lab work, travel, remote visits, and so on;
providing a system that derives analysis of the user's work day pattern up to the present time;
providing a system that infers the Work Patterns of the user such as leaves taken, work done on holidays, desk job done mostly online on one or more CS, supervisory work involving online and offline work, travel oriented work mostly offline and away from office, shift timings, variable work week, uninterrupted work focus on important activities, number of distractions per work day and so on;
making available a system that provides the user with a local user interface on the employee's CS, which is intended for private display of user's time utilization, both personal and work related;
making available a system that provides for user side gamification and encourages improved work habits by setting challenges related to work focus and minimizing distractions, awarding performance points, badges for consistent performance, and progressive performance levels;
making available a system that provides for exact effort and time productivity measurement at organization level without any manual definition or configuration of employee groups or attributes;
making available a system that automatically collects and maintain the list of current valid users and organization hierarchy that maps each user to one or more organization units, and can be further configured to collect and maintain the business attributes (role, skills, salary, position, location) qualifying each user, and organization sub-unit (domain, vertical, cost and profit center, priority) from the organization's existing application data stores;
making available a system that configures a master list of Activities and Purposes, derived from the organization hierarchy (which represents projects and functions) and business attributes (which determine the relevant Activities for a particular type of organization and its sub-units), and the master list may be multi-level and adapted for each organization sub-unit and user;
making available a system that configures default rules for mapping online and offline time slots to Activities and Purposes, the rules adapted for organization sub-units based on their business attributes and further adapted for each user based on his or her position in the sub-unit hierarchy and the user's role therein;
providing a system that performs predictions for improving a work effectiveness and work life balance aspect for the organization sub-unit;
providing a system which automatically generates instructions for improving productivity of organization sub-units and individual employees;
providing a system that optimizes the workload allocation, refines staffing assignments, and reduces attrition by predicting employees at risk and hiring requirements;
extending the data exchange framework for shared database and programmatic interface with third party applications for project management, performance tracking, HR systems, quality, project accounting, resource management and the like;
providing a system that collects the daily effort of each individual employee, consolidates and rolls it up as per the organization hierarchy defined at the server, and provides analytics, reports, goal compliance, alerts and rewards notifications responsive to the exact effort data across Purposes, Activities, applications, artifacts, organization hierarchy and attributes;
providing a system that derives a per-employee Daily Average of Work Pattern, as part of the built-in analytics, specifically to allow for meaningful comparison between two or more organization sub-units, irrespective of the nature of business and role;
providing a system that computes the per-employee Daily Average of Work Pattern for a requested organization sub-unit for the specified time range;
providing a system that creates an n-dimensional effort data cube and includes an analytics engine to provide for generation of custom reports by defining the parameters to be viewed and compared against, filters for selecting a subset, in which the parameters comprise any and every data item sourced, including online and offline time, applications, Activities, Purposes, artifacts, organization sub-units, organization attributes, along with ability for statistical analysis based on totals, averages, maximum and minimum values, standard deviations and others;
providing a system that enables higher productivity, increased output, and improved capacity utilization, by setting goals for greater yet reasonable effort, and more focused time on key Activities and Purposes, by highlighting the gap between current and desired performance, as well as the performance of the Top 20% at the level of organization sub-units and individual employees;
providing a system that determines under and over utilization of effort capacity at any level of the organization hierarchy or along business attributes, and thereby optimizes staffing for maximum organization efficiency and employee work-life balance;
providing a system that deduces recent positive and negative deviations in Work Patterns, and generates an exception report with suggested actions that can be taken to drive improvement; and
providing a system that protects the user privacy by not allowing any visibility into user's personal time details, optionally providing the user with a user private time selector to disable employee's time tracking for specified duration, optionally blocking access to work related details such as applications and artifacts, and optionally reducing the resolution of user's work data to daily, weekly, or monthly averages instead of real-time information to make it seem less intrusive.
providing administrative capabilities to the organization to limit individual level work data visibility only to a few select senior managers, and disabling individual work data view for senior staff (above a certain designation).
providing a system that complies with privacy laws of the organization or specific countries where they operate in by providing an ‘anonymous’ mode in which individual data visibility is completely blocked, and only team level trends and reports are possible.
providing a system that includes a ‘self-improvement’ mode in which no user data is uploaded to the server and productivity improvements are achieved at employee level through personal goal setting and self-awareness based on the Work patterns provided on the local CS.
making available a system that provides each user with a web user interface, in addition to the local user interface, to enable access over any internet browser to long term work related trends, reports, alerts, goals, and administrative functions on the server, for the individual's own data as well as for the teams and organization units reporting to the user.
providing a social platform that showcases the top performers and award winners at individual and organization sub-unit level, motivates gains through a recognition-and-rewards system based on goals achieved, performance points, badges, levels, and allows users to socialize personal and team achievements.
creating a global Work Pattern knowledge platform in which organizations across various industries, verticals, countries, and scale, can participate by contributing their high level Work Pattern trends and analytics with assured anonymity, and in return get feedback on how they rate relative to peer organizations selected based on the criteria of interest.

1. A computer implemented system for automatically measuring, aggregating, analysing and predicting exact effort and time productivity, of at least one user having access to at least one Computing System (CS) agent, within an organization and thereafter providing instructions for improving productivity and workload allocation, and optimizing workforce and operational efficiency, the system comprising:
at least one server;
said at least one CS agent associated with said at least one user accessing the server, said CS agent adapted to automatically measure and generate consolidated and exact online and offline effort data throughout the day (24 hours), for all days, wherein said CS agent is selected from the group consisting of a computer desktop, laptop, electronic notebook, personal digital assistant, tablet, and smartphone, and wherein the CS agent has access to:
a master list for the user containing his or her Purposes and Activities, role and business attributes, and an optional assignment of work units for one or more Purposes, the master list automatically preconfigured at an organization level server based on the user's role and other work related attributes, and
a rules and pattern mapping engine containing organization mapping rules and current user specific mapping rules for mapping online applications and offline slots to a default Purpose and Activity;
a user identifier adapted to identify the user by his or her unique login ID available with the CS agent, said user identifier further configured to prompt the user for an ID in case a neutral login ID is being used by more than one user;
a time tracker having access to said CS agent and adapted to track the user's online time on a currently active user application and associated artifact from a multiplicity of open applications on said CS agent, and record the name of the active application and artifact name(s) and duration of usage, said time tracker further adapted to mark the user's offline time slots by determining each period of inactivity time during which no movement of physical input device(s) of said CS agent is detected for more than a predetermined period of time, wherein:
said associated artifact is selected from the group consisting of a file, a folder, and a website, and
said physical input device(s) are selected from the group consisting of keyboards, keypads, touchpads, and mouse;
a comparator adapted to compare scheduled engagements, meetings, calls, lab work, travel time and remote visits of the user as obtained from the user's calendar on said CS agent and from local Presence Devices (PDs), with the duration of said offline time slots for determining the user's offline time utilization, wherein the local Presence Devices include smartphones with GPS that are connectable to or part of the CS agent;
a logger adapted to maintain a consolidated and sequential log of the user's online and offline time slots;
a time analyser adapted to map said log of the slots to an appropriate Activity, Purpose, and optionally a work unit based on the mapping rules, and further adapted to generate and upload an effort map of the user on the server, wherein:
said Purpose is selected from the group consisting of assigned projects and functions,
said appropriate Activity, for the selected Purpose, is selected from the group consisting of design, programming, testing, documentation, communication, browsing, meetings, calls, lab work, travel, and visits, and
said work unit, for the selected Purpose, is selected from the group consisting of assigned transactions, tasks and deliverables;
a CS agent interface, resident in said server, configured to collect effort data from every CS agent for the user, wherein the effort data is in the form of an CS effort map, said CS effort map configured to list in a chronological order, the online and offline time for the user;
a PD interface, resident in said server, configured to determine the offline PD effort map for the user by obtaining information about user's time on business calls, meetings, visits to labs and other intra-office locations, business travels, and time spent at customer/vendor locations, by interfacing with all remote Presence Devices and PD servers;
a server effort map unit, resident in said server, configured to merge said CS effort map and said offline PD effort map for every user, and generate a chronologically accurate and complete final user effort map, said final user effort map uploaded back to every user's CS agent;
a user Work Pattern analyser adapted to periodically receive said final user effort map, said user Work Pattern analyser further adapted to:
compute a plurality of Work Pattern items, using said final user effort map, wherein said plurality of Work Pattern items are selected from the group consisting of a work time, an online work time, an offline work time, time spent on each Purpose, Activity, application and work unit for the user, a core activity time, a collaboration work time, work habits, a total travel time, a fitness time, a CS usage time, a smart-phone addiction, a physical time in a workplace, a private time in a workplace, a work time at home, a work effectiveness index, and a work life balance index,
generate wellness instruction prompts for the user,
automatically tag each day, in said final user effort map, as a workday, a weekend day, a public holiday or a vacation,
automatically detect the user's location as home, office and other, and
automatically tag each day, in the final user effort map, as a work from office day, a work from home day or a work from other location day;
a user predictor and instructor module adapted to periodically receive the plurality of Work Pattern items, the user predictor and instructor module further adapted to:
select appropriate Work Pattern items, from said plurality of Work Pattern items, for tracking the user's performance based on the user's role in an organization hierarchy,
provide a feedback to the user on highlights related to work effort, work output and the work life balance index,
suggest areas of improvements for the user,
set goals for the user based on said plurality of Work Pattern items,
provide encouragement for the user with points and badges,
generate a progress report based on the goals, the points and the badges won, and
predict the improvements in the work effort, the work output, the work effectiveness index and the work life balance index for the user;
a local user interface adapted to receive inputs from said user Work Pattern analyser and said user predictor and instructor module, said local user interface further adapted to:
display privately and exclusively to the user, the Work Pattern trends for a predetermined period, and the wellness instruction prompts,
indicate the areas of improvements and the goals,
display the progress report based on the goals, the points and the badges won, and
review and edit Activity, Purpose, and work unit mappings;
a user private time selector adapted to disable a user's time tracker for specified time ranges, wherein said time ranges includes the time slots, said time slots in the time ranges are marked as unaccounted and private time;
a privacy filter, resident in said CS agent, said privacy filter cooperating with the rules and pattern mapping engine and adapted to:
mark all effort that is not identified as being on work related activities by the server and the user's mapping rules as personal time,
enable the user to explicitly change any time that was marked as personal to work,
enable the user to explicitly change any time that was marked as work by the server or the user's mapping rules to personal,
enable the user to select, or enable the CS agent to set directly, from one or more of the following privacy filter settings, when the CS agent is enabled to upload the user's effort data:
deactivate uploading of user's personal time details to said server,
deactivate uploading of some aspects of the user's work related information including applications and associated artifacts, to said server, and
reduce the granularity of the user's work related information that is uploaded to the server to a daily, weekly, or monthly average of the Work Patterns, and
deactivate uploading of all the user's information to the server, when said CS agent is not enabled to upload the user's effort, both work and personal, to the server, thereby enabling the CS agent to function in a self-improvement mode for the user and further enable the CS agent to select from one of the following data sharing options:
allow the user to voluntarily disclose identity and some or all aspects of the user's Work Patterns to the server in return for being able to collaborate with peers or the entire organization for benchmarking and cross-learning from each other, and
allow the user to voluntarily disclose some or all aspects of the user's Work Patterns to the server, wherein said CS agent is adapted to obfuscate the user's identity, in return for being able to benchmark user's own performance with that of the peers or the entire organization as provided by the server;
and
said at least one server comprises:
an organization sync agent configured to collect and maintain the list of current valid users and the organization hierarchy that maps each user to one or more organization sub-units, the organization sync agent further configured to collect and maintain the business attributes qualifying each user and organization sub-unit from organization application data stores, wherein:
said business attributes for the user are selected from the group consisting of role, skills, salary, position, and location, and
said business attributes for the organization sub-unit are selected from the group consisting of domain, vertical, cost and profit center, and priority;
an organization settings and rules engine adapted to configure a master list of Purposes and Activities, derived from the organization hierarchy, wherein said organization hierarchy represents projects and functions, and said master list may be multi-level and adapted for each organization sub-unit and user, said organization settings and rules engine further adapted to configure default rules for mapping online and offline time slots to Purposes and Activities, said organization settings and rules engine further configured to adapt the mapping rules for organization sub-units based on their business attributes and further adapted for each user based on his or her position in the sub-unit hierarchy and the user's business attributes,
an organization effort aggregation and analytics engine configured to consolidate and roll up individual online and offline effort data as per the organization hierarchy, said organization effort aggregation and analytics engine further configured to compute a per-employee Daily Average Work Pattern for each sub-unit, said organization effort aggregation and analytics engine still further configured to generate an n-dimensional effort data cube mapping individual and collective efforts of respective users as per the organization hierarchy,
an organization Work Pattern analyser configured to periodically receive the per-employee Daily Average Work Pattern for each sub-unit, said organization Work Pattern analyser further configured to:
compute a plurality of sub-unit Work Pattern items for each sub-unit, wherein said plurality of sub-unit Work Pattern items are selected from the group consisting of a sub-unit effort, sub-unit habits, a sub-unit effort distribution across Purposes, Activities, applications and work units, a sub-unit work life balance index, a sub-unit capacity utilization, and a sub-unit work effectiveness index,
an organization predictor and instructor module configured to receive said plurality of sub-unit Work Pattern items, the organization predictor and instructor module further configured to:
select appropriate sub-unit Work Pattern items, from said plurality of sub-unit Work Pattern items, for tracking each sub-unit's performance based on the nature of each of the sub-unit,
provide a feedback to a manager on highlights related to a sub-unit work effort, a sub-unit work output, a sub-unit workload assignment and a sub-unit staff allocation for each of the sub-unit,
suggest areas of improvements for each of the sub-unit;
track progress of each of the sub-unit,
set goals for improving the sub-unit work effectiveness index and sub-unit productivity for each of the sub-unit;
suggest recommendations about the best practices for each of the sub-unit,
predict the improvements in said sub-unit work effort, said sub-unit work output, said sub-unit work effectiveness index and said sub-unit work life balance index for each of the sub-unit,
predict delays in project timelines, effort and cost overruns, inability to meet an output target, and an impact possible with improvements, and
generate intelligent reports for improving operational effectiveness and workforce optimization in each of the sub-unit;
a recognition and rewards module configured to assign performance points to users and sub-units based on individual and aggregate effort and completed work units, and
a web user interface configured to facilitate views at each level of the organization hierarchy across Work pattern items, said web user interface further configured to selectively filter and drill down to generate and compare discrete effort data for any Work Pattern item across any business attribute, wherein:
said Work Pattern items are selected from the group consisting of effort, habits, effort distribution across Purposes, Activities, applications and work units, work life balance index, capacity utilization, and work effectiveness index, and
said business attributes are selected from the group consisting of role, skills, salary, position, and location for the user, and from the group consisting of domain, vertical, cost and profit center, and priority for the organization sub-unit;
and
a blocker, resident in said server, said blocker cooperating with said CS agent and adapted to:
control third party access to individual level data by restricting access to said individual level data based on the organization hierarchy and as per assigned access rights,
block individual data visibility of certain users based on their role or seniority in the organization,
block individual data visibility entirely, and
block organization sub-unit visibility if a user count computed for the organization sub-unit is below a predetermined user count.

2. The system as claimed in claim 1, wherein the web user interface is configured to:
communicate with an internet browser and display through said internet browser the organization trends, reports, alerts, goals and administrative functions depending upon the user's position and role in the organization hierarchy; and
provide access to the organization effort aggregation and analytics engine for generation of user defined custom reports from the n-dimensional effort data cube.

3. The system as claimed in claim 1, wherein said organization effort aggregation and analytics engine is further configured to deduce a best working pattern and top performers at individual and organization sub-unit level, said organization effort aggregation and analytics engine further configured to determine unusual Work Patterns and the recent positive and negative deviations in Work Patterns for an organization sub-unit, said organization effort aggregation and analytics engine still further configured to generate a report including specific actions that can be undertaken to improve the efforts of the users.

4. The system as claimed in claim 1, wherein the rules and pattern mapping engine is adapted to generate the default mapping rules for mapping the online and offline time slots to Purposes and Activities, including pattern matching to deduce best fit rules, the rules and pattern mapping engine further configured to adapt the rules for users in organization sub-units based on the business attributes and further adapted based on each user's position in the sub-unit hierarchy and the user's role therein.

5. The system as claimed in claim 1, wherein said CS agent includes a user interface local to the Computing System agent, and configured to provide the respective users with private access to their corresponding entire work related and personal online and offline effort data.

6. The system as claimed in claim 1, wherein said blocker is further configured to actuate an ‘anonymous mode’ wherein the visibility of individual effort data is completely blocked for the entire organization or for sub-units in certain geographies, and trends and reports are available only up to team level provided a team has a certain minimum number of employees.

7. The system as claimed in claim 1, wherein said privacy filter is further configured to actuate a ‘self-improvement mode’ wherein:
no effort data is uploaded by default to the server;
productivity improvements are achieved through employee self-awareness by tracking user's own Work Patterns as provided on the local Computing System agent and by comparing against the goals set by the managers and the organization;
Work Patterns are uploaded anonymously to the server, in return for being able to view the comparative trends across the users who voluntarily shared their respective effort data, and thereby rate one's own relative performance; and
user's profile is defined and comparisons are made with peers having a similar profile and who voluntarily but anonymously shared their respective effort data, wherein the user's profile is selected from the group consisting of role, seniority, location and skills.

8. The system as claimed in claim 1, wherein the system further includes:
a global pattern knowledge platform configured to enable the participating organizations to share their high-level Work Pattern analytics and trends based on employee and sub-organization categories;
a profile definition module configured to enable the participating organizations to define profiles corresponding to at least their respective sizes, industry and vertical; and
a report generation module configured to prepare reports rating the organization's performance and standing relative to peer organizations in accordance with the selected profile criteria.

9. The system as claimed in claim 1, wherein said time tracker is further configured to ignore any simulated input device or spurious movement through robotic control of the physical devices.

10. The system as claimed in claim 1, wherein said user Work Pattern analyser employs an automated and adaptive learning for:
deciding improvement goals for the user, and
determining the user's work effectiveness index and work life balance index;

11. The system as claimed in claim 1, wherein the user Work Pattern analyser employs a fuzzy logic to determine user vacations, weekends and holidays, shift timings, work from home and office and other locations, and unaccounted time in office.

12. The system as claimed in claim 1, wherein said user predictor and instructor module uses correlation between the Work Pattern items and the work output to:
provide feedback to the user about the Work Pattern items that impact work output; and
make recommendations to improve performance.

13. The system as claimed in claim 1, wherein said organization predictor and instructor module employs an automated and adaptive learning for:
deciding improvement goals for each sub-unit; and
determining said sub-unit's work effectiveness index and said sub-unit's work life balance index.

14. The system as claimed in claim 1, wherein said organization predictor and instructor module employs correlation between said sub-unit Work Pattern items and said sub-unit work output to:
provide feedback to managers about the sub-unit Work Pattern items that impact sub-unit work output; and
make recommendations to improve the sub-units performance.

15. A computer-implemented method for automatically measuring, aggregating, analysing and predicting exact effort and time productivity of at least one user associated with at least one Computing System (CS) agent accessing at least one server, within an organization and thereafter providing instructions for improving productivity and workload allocation, and optimizing workforce and operational efficiency, the method comprising the following steps:
creating a master list for every user, wherein said master list includes the user's Purposes and Activities and configuring the master list to reflect the user's role and other work related attributes;
storing organization settings and mapping rules, said mapping rules being configured as per the position of the user in the organization hierarchy and role;
mapping online applications and offline slots in accordance with the stored organization settings and rules;
identifying the user by his or her unique login ID;
tracking the user's online time on a currently active user application and associated artifact from a multiplicity of applications opened by the user, and recording the name of the active application and artifact name(s) and duration of usage, wherein the associated artifact is selected from the group consisting of a file, a folder and a web site;
marking the user's offline time slots by determining each period of inactivity time during which no movement of physical input devices is detected for more than a predetermined period of time, wherein the physical input devices are selected from the group consisting of keyboards, keypads, touchpads and mouse;
comparing scheduled engagements, meetings, calls, lab work, travel time and remote visits of the user as obtained from a calendar of the user on the CS agent and from local Presence Devices (PDs), wherein the local Presence Devices includes smartphone with GPS, that are connectable to or a part of the Computing System agent, with the duration of the offline time slots for determining the user's offline time utilization;
maintaining, using a logger, a consolidated and sequential log of user's online and offline time slots;
applying the mapping rules to the online application and offline slots and deducing best fit rules to map all slots to an appropriate Activity, Purpose and optionally a work unit automatically based on the mapping rules, wherein:
said Purpose is selected from the group consisting of assigned projects and functions,
said appropriate Activity, for the selected Purpose, is selected from the group consisting of design, programming, testing, documentation, communication, browsing, meetings, calls, lab work, travel and visits, and
said work unit, for the selected Purpose, is selected from the group of assigned transactions, tasks and deliverables;
generating the user's online and offline time utilization log mapped to the Activities, Purposes and work units constituting the user's effort map for the CS agent;
collecting effort data, at said server, from every Computing System agent of every user, wherein the effort data is in the form of a CS effort map, the CS effort map listing in a chronological order, the online and offline time for each user;
obtaining, at the server, offline PD effort maps for each user having information about the user's time on business calls, meetings, visits to labs and other intra-office locations, business travels and time spent at customer/vendor locations, by interfacing all remote Presence Devices (PDs) and PD servers;
merging, at said server, the CS effort map and the offline PD effort map and generating a chronologically accurate and complete final user effort map, and uploading the final user effort map to every user's CS agent;
downloading the final user effort map back onto each of the CS agents of the user;
periodically receiving said final user effort map at a user Work Pattern analyser of the CS agent and performing the analysis of the Work Patterns of the user, wherein the step of performing the analysis of the Work Patterns of the user includes following sub-steps:
computing a plurality of Work Pattern items, using the final user effort map, wherein the plurality of Work Pattern items are selected from the group consisting of a work time, an online work time, an offline work time, a time spent on each Purpose, Activity, application and work unit for the user, a core activity time, a collaboration work time, work habits, a total travel time, a fitness time, a PD usage time, a smartphone addiction, a physical time in a workplace, a private time in a workplace, a work time at home, a work effectiveness index and a work life balance index,
generating wellness instruction prompts for the user,
tagging each day, in the final user effort map, as a workday, a weekend day, a public holiday or a vacation,
automatically detecting the user's location as home, office and other, and
tagging each day, in the final user effort map, as a work from office day, a work from home day or a work from other location day;
periodically receiving said plurality of Work Pattern items at a user predictor and instructor module of the CS agent and performing predictions and instructions for the user, wherein step of performing predictions and instructions for the user includes following sub steps:
selecting appropriate Work Pattern items, from said plurality of Work Pattern items, for tracking the user's performance based on the user's role in an organization hierarchy,
providing a feedback to the user on highlights related to work effort, work output, and the work life balance index,
suggesting areas of improvements,
setting goals for the user based on said plurality of Work Pattern items;
providing encouragement for the user with points and badges,
generating a progress report based on the goals, the points and badges won, and
predicting the improvements in said work effort, said work output, said work effectiveness index and said work life balance index;
receiving, at a local user interface, the Work Patterns, the wellness instruction prompts, the suggested areas of improvement, goals, and the progress report based on the goals, the points and the badges won;
displaying privately and exclusively to the user the Work Pattern trends, instructions and the progress report for a predetermined period;
disabling the user's time tracker for specified time ranges, wherein the time ranges includes the time slots, said time slots in the time ranges are marked as unaccounted and private time;
marking all effort that is not identified as being on work related activities by the server and the user's mapping rules as personal time;
enabling the user to explicitly change any time that was marked as personal to work;
enabling the user to explicitly change any time that was marked as work by the server or the user's mapping rules to personal;
enabling the user to select, or enabling the CS agent to set directly, from one or more of the following privacy filter settings, when said CS agent is enabled to upload the user's effort data:
i. deactivating uploading of user's personal time details to the server,
ii. deactivating uploading of some aspects of the user's work related information including applications and associated artifacts to the server, and
iii. reducing the granularity of the user's work related information that is uploaded to the server to a daily, weekly, or monthly average of the Work Patterns;
deactivating upload of all the user's information to the server, when said CS agent is not enabled to upload the user's effort, both work and personal, to the server, thereby enabling the CS agent to function in self-improvement mode for the user and further enable the CS agent to select from one of the following data sharing options:
i. allowing the user to voluntarily disclose identity and some or all aspects of the user's Work Patterns to the server in return for being able to collaborate with peers or the entire organization for benchmarking and cross-learning from each other, and
ii. allowing the user to voluntarily disclose some or all aspects of the user's Work Patterns to the server, wherein said CS agent is adapted to obfuscate the user's identity, in return for being able to benchmark user's own performance with that of the peers or the entire organization as provided by the server;
collecting and maintaining, at the server, a list of current valid users and the organization hierarchy that maps every user to one or more organization sub-units, and collecting and maintaining the business attributes qualifying each user and organization sub-unit, wherein:
said business attributes for the user are selected from the group consisting of employee levels, roles, skills, locations, verticals, technologies and cost centers, and
said business attributes for the organization sub-unit are selected from the group consisting of domain, vertical, cost, profit center, and priority;
consolidating and rolling up, at said server, individual online and offline effort data as per the organization hierarchy, and computing a per-employee Daily Average Work Pattern for every sub-unit;
generating, at said server, an n-dimensional effort data cube mapping individual and collective efforts of respective users as per the organization hierarchy;
periodically receiving said per-employee Daily Average Work Pattern for each sub-unit at an organization Work Pattern analyser of the server and performing the analysis of said per-employee Daily Average Work Pattern for each sub-unit, wherein the step of performing the analysis of said per-employee Daily Average Work Pattern for each sub-unit includes following sub-step:
i. computing a plurality of sub-unit Work Pattern items for each sub-unit, wherein said plurality of sub-unit Work Pattern items are selected from the group consisting of a sub-unit effort, sub-unit habits, a sub-unit effort distribution across Purposes, Activities, applications and work units, a sub-unit work life balance index, a sub-unit work effectiveness index, and a sub-unit capacity utilization;
periodically receiving said plurality of sub-unit Work Pattern items at an organization predictor and instructor module of the server and performing predictions and instructions for each sub-unit, wherein step of performing predictions and instructions for each sub-unit includes following sub steps:
i. selecting appropriate sub-unit Work Pattern items, from said plurality of sub-unit Work Pattern items, for tracking each sub-unit's performance based on the nature of each sub-unit,
ii. providing a feedback to a manager on highlights related to a sub-unit work effort, a sub-unit work output, a sub-unit workload assignment and a sub-unit staff allocation for each sub-unit,
iii. suggesting areas of improvements,
iv. tracking progress,
v. setting goals for improving said sub-unit work effectiveness index and sub-unit productivity for each of the sub-unit,
vi. suggesting recommendations about the best practices,
vii. predicting the improvements in said sub-unit work effort, said sub-unit work output, said sub-unit work effectiveness index and said sub-unit work life balance index,
viii. predicting delays in project timelines, effort and cost overruns, inability to meet an output target, and the impact possible with improvements, and
ix. generating intelligent reports for improving operational effectiveness and a talent management;
assigning, at said server, performance points to users and sub-units based on the individual and aggregate effort, and completed work units;
facilitating, over a web user interface, the display of trends related to work effort, Work Patterns, predictions and instructions relating to sub-units at each level of the organization hierarchy subject to the view access rights of the user and a blocker;
enabling the user, over the web user interface, to selectively filter and drill down, at the server, for generating and comparing discrete effort data for any Work Pattern item across any business attribute, wherein:
said Work Pattern items are selected from the group consisting of effort, habits, effort distribution across Purposes, Activities, applications and work units, work life balance index, capacity utilization, and work effectiveness index, and
i. said business attributes are selected from the group consisting of role, skills, salary, position, and location for the user, and from the group consisting of domain, vertical, cost and profit center, and priority for the organization sub-unit;
and
displaying the entire work related and personal online and offline effort data on a user interface local to the Computing System agent of the user.

16. The method as claimed in claim 15, wherein the method further includes the following steps:
displaying the organization trends, reports, alerts, goals and administrative functions depending upon user's position and role in the organization hierarchy; and
generating user-defined custom reports from the n-dimensional effort data cube.

17. The method as claimed in 15, wherein the step of consolidating and rolling up individual online and offline effort data further includes the following steps:
deducing a best working pattern, top performers at individual and organization sub-unit level;
determining unusual Work Patterns and the recent positive and negative deviations in Work Patterns for an organization sub-unit; and
generating a report including specific actions that can be undertaken to improve the efforts of the users.

18. The method as claimed in claim 15, wherein the method further includes the step of actuating an ‘anonymous mode’ wherein the visibility of individual effort data is completely blocked for the entire organization or for sub-units in certain geographies, and trends and reports are available only up to team level, provided the team has a certain minimum number of employees.

19. The method as claimed in claim 15, wherein the method further includes the step of actuating a ‘self-improvement mode’ wherein no user effort data is uploaded to the server.

20. The method as claimed in claim 15, wherein the method further includes the following steps:
providing a global knowledge platform and enabling participating organizations to share their high-level Work Pattern analytics and trends based on employee and sub-organization categories;
enabling the participating organizations to define profiles corresponding to their respective sizes, industry and vertical; and
preparing reports rating the organization's performance and standing, relative to peer organizations in accordance with the selected profile criteria.
